(19) United States
(12) Patent Application Publication
(10) Pub. No.: US 2021/0081048 A1
(43) Pub. Date: Mar. 18, 2021

(54) ARTIFICIAL REALITY DEVICES, INCLUDING HAPTIC DEVICES AND COUPLING SENSORS

(71) Applicant: FACEBOOK TECHNOLOGIES, LLC, Menlo Park, CA (US)

(72) Inventors: Audrey Ann Sedal, Redmond, WA (US); Nicholas Roy Corson, Woodinville, WA (US); Jose Antonio Barreiros Flores, Redmond, WA (US); Katherine Healy, Redmond, WA (US); Amirhossein Hajiagha Memar, Redmond, WA (US); Andrew Doxon, Redmond, WA (US); Nicholas Colonnese, Kirkland, WA (US); Shawn Reese, Renton, WA (US); Adam Ahne, Snohomish, WA (US); Yigit Menguc, Kirkland, WA (US); Talha Agcayazi, Raleigh, NC (US)

(21) Appl. No.: 17/019,057

(22) Filed: Sep. 11, 2020

Related U.S. Application Data
(60) Provisional application No. 62/899,112, filed on Sep. 11, 2019.
(60) Provisional application No. 62/930,500, filed on Nov. 4, 2019.
(60) Provisional application No. 62/938,127, filed on Nov. 20, 2019.
(60) Provisional application No. 62/941,511, filed on Nov. 27, 2019.

(51) Int. Cl. G06F 3/01; G02B 27/01; G06T 19/00

(52) U.S. Cl. CPC G06F 3/016; G06T 19/006; G06F 3/014; G02B 27/0172

(57) ABSTRACT

An apparatus for creating haptic stimulations is provided. The apparatus includes an inflatable bladder and a support structure attached to a portion of the inflatable bladder. The inflatable bladder is fluidically coupled to a pressure-changing device that is configured to control a fluid pressure of the inflatable bladder. The support structure includes a predefined pattern of cuts, and is configured to expand (or otherwise deform) in one or more directions according to a design of the predefined pattern of cuts and in relation with a fluid pressure inside the inflatable bladder. When the inflatable bladder receives the fluid from the source, the inflatable bladder expands, which causes the support structure to expand in the one or more directions and also to reinforce the inflatable bladder in the one or more directions. A wearable device and a system for creating haptic simulations are also disclosed.

### RELATED APPLICATIONS

This application claims priority to U.S. Provisional Application No. 62/899,112, filed Sep. 11, 2019, entitled “Planar-to-3D Structures for Patterning Reinforcements on Arbitrarily Shaped Fluidic Actuators,” U.S. Provisional Application No. 62/930,500, filed Nov. 4, 2019, entitled “Wearable Devices with Magneto-Fluid Actuators for Creating Haptic Feedback,” U.S. Provisional Application No. 62/938,127, filed Nov. 20, 2019, entitled “Haptic Devices with Integrated Grounding and Haptic-Feedback Mechanisms,” and U.S. Provisional Application No. 62/941,511, filed Nov. 27, 2019, entitled “Coupling Quality Sensor for Human Coupled Devices,” each of which is incorporated by reference herein in its entirety.

### TECHNICAL FIELD

This application relates generally to haptic stimulation, including creating haptic stimulations on users of virtual and/or augmented reality devices, and measuring the quality of human coupled devices.

### BACKGROUND

Virtual and augmented reality devices have wide applications in various fields, including engineering design, medical surgery practice, military simulated practice, and video gaming. Haptic or kinesthetic stimulations recreate the sense of touch by applying forces, vibrations, and/or motions to a user, and are frequently implemented with virtual and augmented reality devices. In certain applications, haptic stimulations are desired at locations where dexterity and motion of the user cannot be constrained. Conventional haptic creating devices, however, are cumbersome and therefore detract from the user experience.

Artificial-reality devices have wide applications in various fields, including engineering design, medical surgery practice, military simulated practice, and video gaming. Haptic or kinesthetic stimulations (i.e., haptic feedback) recreate the sense of touch by applying forces, vibrations, and/or motions to a user, and are frequently implemented with artificial-reality devices (e.g., virtual-reality devices, augmented-reality devices, etc.). In certain applications, haptic stimulations are desired at locations where dexterity and motion of the user cannot be constrained. Conventional haptic-feedback creating devices, however, are cumbersome and therefore detract from the user experience.

Moreover, in the real world, when a person contacts a physical object (e.g., grasps a glass of water), vertical and shearing stresses are perceived by the person due to the physical object's inertia and weight. Additionally, upon making contact with a physical object, a person's skin may also be locally deformed by the physical object's ridges and textures. Such a stimulation is known as skin shear, and the ability of a haptic-feedback creating device to recreate such skin shear is essential for the believability of artificial-reality scenes that involve grasping (or other similar interactions) with virtual objects.

Artificial-reality devices (e.g., virtual-reality devices, augmented-reality devices, etc.) have wide applications in various fields, including engineering design, medical surgery practice, military simulated practice, and video gaming. Haptic or kinesthetic stimulations recreate the sense of touch by applying forces, vibrations, and/or motions to a user, and are frequently implemented with artificial-reality devices in the form of a wearable device. Performance of these wearable devices with haptic-creating mechanisms is closely related to how well these mechanisms are attached to a user's body during operation, and how reliably they transfer forces to the user's body. “Grounding” refers to the part of wearable devices responsible for transferring the forces from a haptic-creating mechanism to the user's body. Careful grounding design is critical for a wearable device's performance and, in turn, a user's experience with the artificial-reality device as a whole. Furthermore, at present, skin shear haptic displays are bulky and represent undue encumbrance on a user's body, such as the fingertip.

Virtual reality (VR) and/or augmented reality (AR) technologies allow users to interact with technologies in different ways, e.g., VR and/or AR allows a user to tactilely interact with the digital world. Wearable devices for VR and/or AR may allow users to interact with the digital world through a medium distinct from an electronic device's screen. For example, a wearable device, such as a glove, is fitted to a user to provide haptic feedback on the user's hand to provide an immersive VR and/or AR interaction. However, determining whether the wearable device is in proper contact with the user (e.g., so that the wearable device can provide adequate and consistent haptic feedback to the user) presents a challenge.

### SUMMARY

The present application consolidates the disclosures of the four provisional applications to which it claims priority.

Accordingly, there is a need for devices and systems that can create haptic stimulations on a user without constraining dexterity and motion of the user. One solution is a wearable device that includes novel haptic mechanisms, referred to herein as “haptic assemblies.” The haptic assemblies include a bladder that is made from flexible and durable materials that do not encumber the user but are still able to create adequate haptic stimulations. Further, the bladders are airtight such that a pressure inside the bladders can be varied to create various haptic stimulations. By changing the pressure, a respective bladder can go from being flexible to having some degree of rigidity (and vice versa), and it is this transition that creates the haptic stimulations felt by the user. The haptic assemblies also include a support structure that is coupled to the bladder. The support structure is made from a material that is stronger and less elastic than the materials of the bladder. However, the support structure includes a predefined pattern of cuts that allows the support structure to have anisotropic properties (e.g., the support structure is rigid or semi-rigid in one or more first directions and elastic or semi-elastic in one or more second directions). In view of the above, the support structure may be able to expand or otherwise elastically deform in one or more directions due to the predefined pattern of cuts so that the support structure can conform to a shape or expansion of a bladder while reinforcing a shape, strength, and/or durability of the bladder due to the anisotropic properties of the support structure.

(A1) In accordance with some embodiments, the solution explained above can be implemented on an apparatus that includes an inflatable bladder and a support structure that is attached to the inflatable bladder. The inflatable bladder is fluidically coupled (e.g., pneumatically, electrically, hydraulically, etc.) to a pressure-changing device (e.g., a pneumatic device, a hydraulic device, etc.) that is configured to control a fluid pressure (e.g., pressurized state) of the inflatable bladder. The support structure includes a predefined pattern of cuts, and is configured to deform (e.g., elastically deform, expand, lengthen, or otherwise shift) in one or more directions according to a design of the predefined pattern of cuts and in relation to (e.g. based on) a fluid pressure inside the inflatable bladder. When the inflatable bladder receives the fluid from the source, the inflatable bladder expands, which causes the support structure to expand in the one or more directions and also to reinforce the inflatable bladder in the one or more directions. In some embodiments, as the support structure expands or otherwise deforms, it strains and exerts a force against the portion of the inflatable bladder, thereby constricting expansion of the inflatable bladder in the one or more directions. In some embodiments, the support structure is strain hardened when expanded in the one or more directions. In some embodiments, the support structure is elastic. In some embodiments, the inflatable bladder is configured to receive a fluid from the pressure-changing device.

In some embodiments, the support structure is configured to have a variable shape according to a design of the predefined pattern of cuts and in relation with (e.g., based on) the fluid pressure inside the inflatable bladder. The support structure is configured to impart an amount of force that is related to the fluid pressure inside the inflatable bladder.

(A2) In accordance with some embodiments, the solution explained above can be implemented on a wearable device that includes a garment configured to be worn on a portion of a wearer's body, and a haptic assembly coupled to the garment. The haptic assembly has the structure of the apparatus of A1.

(A3) In accordance with some embodiments, the solution explained above can be implemented by a system that includes a computing device, a pressure-changing device in communication with the computing device, and a haptic assembly that may or may not be in communication with the computing device. The haptic assembly has the structure of the apparatus of A1. Furthermore, the computing device is configured to control a pressurized state of the haptic assembly by controlling the pressure-changing device.

The wearable devices discussed above, in some instances, are worn on the user's body (e.g., a hand, an arm, a wrist, or an ankle) and can be used to stimulate areas of the body. Moreover, the wearable device can be in communication with a remote device (e.g., a virtual reality device and/or an augmented reality device, among others), and the wearable device can stimulate the body based on an instruction from the remote device. As an example, the remote device may display media content to a user (e.g., via a head-mounted display), and the remote device may also instruct the wearable device to create haptic stimulations that correspond to the media content displayed to the user and/or other information collected by the wearable device.

Thus, the devices and systems described herein provide benefits including but not limited to: (i) stimulating areas of the body that correspond to media content and sensor data, (ii) the wearable device does not encumber free movement of a user's body until desired, and (iii) multiple wearable devices can be used simultaneously.

In accordance with some embodiments, a computer system includes one or more processors/cores and memory storing one or more programs configured to be executed by the one or more processors/cores. The one or more programs include instructions for performing the operations of any of the methods described herein. In accordance with some embodiments, a non-transitory computer-readable storage medium has stored therein instructions that, when executed by one or more processors/cores of a computer system, cause the computer system to perform the operations of any of the methods described herein. In accordance with some embodiments, a system includes a wearable device, a head-mounted display (HMD), an external device (e.g., pressure-changing device 210, FIG. 2) and a computer system to provide video/audio feed to the HMD and instructions to the wearable device, the HMD, and/or the external device.

Accordingly, there is a need for devices and systems that can apply haptic stimulations to users of artificial-reality devices without constraining dexterity and motion of the users. Furthermore, there is also a need for devices and systems that can render believable skin shear stimulations. To illustrate skin shear, in a simple artificial-reality scene, a user's avatar may (i) grab a glass of water from a table, (ii) hold and raise the glass, and (iii) then empty the glass by rotating/tipping the glass. Thus, to render this haptic interaction, the devices and systems need to allow for control of stretch direction and intensity. One solution is a haptic device that includes a novel arrangement of magnets that are configured to interact with each other to render various haptic stimulations on a user, including skin shear stimulations. This haptic device also uses fluid pressure to move the magnets, and, thus, the haptic device may be referred to herein as a magneto-fluid actuator.

(C1) In some embodiments, the solution explained above can be implemented on a haptic device that includes: (A) a housing that (i) supports a flexible membrane and (ii) defines a plurality of channels configured to receive a fluid from a source, (B) an end-effector magnet, coupled to the flexible membrane, configured to impart (i.e., deliver, apply) one or more haptic stimulations to a portion of a user's body (e.g., a skin shear stimulation), and (C) a plurality of secondary magnets, housed by the housing, configured to move (e.g., repel) the end-effector magnet through magnetic force. Moreover, a distance separating the end-effector magnet from the plurality of secondary magnets is varied according to a fluid pressure in one or more of the plurality of channels.

(C2) In some embodiments of C1, each respective secondary magnet is: (i) aligned with a corresponding channel of the plurality of channels (i.e., a distinct one of the plurality of channels), and (ii) configured to elevate from a default position toward the end-effector magnet and move the end-effector magnet through the magnetic force, in response to the source increasing the fluid pressure in the corresponding channel, of the plurality of channels, that is aligned with the respective secondary magnet.

(C3) In some embodiments of C2, the haptic device further includes one or more bladders, each being positioned between a respective secondary magnet of the plurality of secondary magnets and the corresponding channel of the plurality of channels. Furthermore, each respective bladder of the one or more bladders is configured to expand and elevate the respective secondary magnet toward the end-effector magnet, in response to the source increasing the fluid pressure in the corresponding channel. Note that, in some embodiments, a respective bladder and a respective secondary magnet collectively form a pocket/bubble actuator.

(C4) In some embodiments of any of C2-C3, the flexible membrane is configured to stretch in response to the respective secondary magnet moving the end-effector magnet through the magnetic force.

(C5) In some embodiments of any of C2-C4, movement of the end-effector magnet by the respective secondary magnet causes the portion of the user's body to experience a haptic stimulation (e.g., when the respective secondary magnet is elevated from the default position toward the end-effector magnet).

(C6) In some embodiments of any of C1-C5, the end-effector magnet is configured to impart a first haptic stimulation (e.g., a skin shear stimulation) to the portion of the user's body when the fluid pressure in one or more (less than all) of the plurality of channels is increased from a default pressure level, said fluid pressure increase causing one or more (less than all) of the plurality of secondary magnets to elevate toward and move the end-effector magnet through the magnetic force. Furthermore, the end-effector magnet is configured to impart a second haptic stimulation (e.g., a pure pressure stimulation), different from the first haptic stimulation, to the portion of the user's body when the fluid pressure in each of the plurality of channels is increased from the default pressure level (e.g., to the same pressure level), said fluid pressure increase causing each of the plurality of secondary magnets to elevate toward and move the end-effector magnet through the magnetic force. Note that the fluid pressure in each channel can be increased at the same rate, or different rates. In other words, each secondary magnet may be elevated to the same height or one or more different heights. In some instances, increasing at different rates can cause the user to experience a range of shear-type stimulations.

(C7) In some embodiments of any of C1-C6, the end-effector magnet is configured to impart different shear stimulations to the portion of the user's body depending on (i) which of the plurality of channels experiences a fluid pressure increase, and (ii) a magnitude of the fluid pressure increase.

(C8) In some embodiments of any of C1-C7, each respective channel includes: (i) an inlet that is to receive the fluid from the source, and (ii) an outlet that is aligned with a respective secondary magnet of the plurality of secondary magnets, whereby the fluid received from the source fills the respective channel and applies a force to the respective secondary magnet via the outlet (e.g., a respective bladder 309).

(C9) In some embodiments of any of C1-C8, when the fluid pressure in each of the plurality of channels is at a default pressure level, the end-effector magnet is positioned in a default position. In contrast, when the fluid pressure in at least one of the plurality of channels is increased above the default pressure level, the end-effector magnet is magnetically repelled by the at least one of the plurality of secondary magnets.

(C10) In some embodiments of any of C1-C9, the haptic device also includes a substrate. In such embodiments, the plurality of secondary magnets is coupled to the substrate, the flexible membrane is positioned on a first plane, and the substrate is positioned on a second plane that is parallel to and offset from the first plane. For example, the substrate is beneath the flexible membrane.

(C11) In some embodiments of any of C1-C10, each of the plurality of channels is individually serviced by the source.

(C12) In some embodiments of C11, the haptic device also includes one or more processors in communication with a computer device. In such embodiments, the one or more processors are configured to receive an instruction from the computer device and control operation of the source based on the instruction. Alternatively, in some embodiments, the source is controlled by a computing device (e.g., operates based on instructions directly from the computing device).

(C13) In some embodiments of any of C11-C12, the source is a pneumatic device, and the fluid is air.

(C14) In some embodiments of any of C1-C13, the end-effector magnet is aligned with a primary axis, and each of the plurality of magnets is aligned with a distinct secondary axis that (i) parallels the primary axis and (ii) is offset from the primary axis in a unique direction.

(C15) In some embodiments of any of C1-C14, when in a first state, the end-effector magnet is not magnetically influenced by any of the plurality of secondary magnets and, when in a second state, the end-effector magnet is magnetically influenced by one or more secondary magnets, less than all, of the plurality of secondary magnets (may or may not be equal influence). Furthermore, when in a third state, the end-effector magnet is magnetically influenced (e.g., may or may not be equal influence) by each secondary magnet of the plurality of secondary magnets.

(C16) In another yet aspect, a haptic device is provided that includes the means for performing the functions of any of C1-C15. For example, the haptic device may include means for supporting a membrane, a first magnetic means for imparting one or more haptic stimulations to a portion of a user's body, a second magnetic means for moving the first magnetic means through magnetic force (and so on).

(D1) In another yet aspect, a wearable device is provided that includes a wearable structure to be worn on a portion of a user's body. The wearable device also includes one or more haptic assemblies, whereby each haptic assembly is coupled to the wearable structure. Furthermore, each haptic assembly includes the structure of the haptic device of C1 (and also, in some embodiments, the structure of C2-C15).

(D2) In some embodiments of D1, the wearable structure is a glove, and the one or more haptic assemblies are distributed along digits of the glove.

(E1) In another aspect, a system is provided that includes a computing device and a fluid source in communication with the computing device. The system also includes a wearable device that includes at least one haptic assembly that has the structure of the haptic device of A1 (and also, in some embodiments, the structure of C2-C15).

(E2) In some embodiments of E1, the fluid source is configured to inject fluid into one or more target channels of the plurality of channels at a desired pressure in response to receiving an instruction from the computing device. In addition, the instruction specifies the desired pressure and the one or more target channel.

Existing wearable devices do not implement adequate grounding mechanisms. Most designers have focused their efforts on basic passive grounding techniques, such as a Velcro strap that is used to secure the haptic-creating mechanisms (and the wearable device generally) to the user's hand. This approach results in a cumbersome grounding solution where each strap requires large pretension to adequately secure a haptic-creating mechanisms to the user's body. Due to the design and nature of the straps, this approach also restricts blood flow, making these devices uncomfortable. Furthermore, donning and doffing a wearable device with these types of straps is a labor intensive task, as each strap has to be physically undone and reattached between uses, which makes the entire artificial-reality experience sub-optimal.

Accordingly, there is a need for devices and systems that can be used to ground wearable devices (and their associated components, such as haptic-creating mechanisms) to a user's body. There is also a need for devices and systems that can create adequate skin shear while fitting into a glove (or similar article of clothing) form factor (i.e., the devices are not bulky and cumbersome). Embodiments herein cover a wearable device that implements active grounding techniques. Active grounding refers to a grounding assembly that actuates some mechanism or device to effectuate grounding. One example of active grounding involves bladders, which can be inflated or deflated to attach or detach a wearable device to a user's body Active grounding devices can be computer controlled, meaning that said devices can be controlled to provide optimal grounding forces and fit to a particular user (e.g., body size will change from user to user). Thus, active grounding provides a much more ergonomic and optimal user experience. Furthermore, active grounding can reduce the donning and doffing time of the wearable device considerably as the inflatable bladders can be deflated quickly, meaning that the wearable device can be attached and detached to the user's body with ease.

Moreover, the wearable device also includes the ability to create a wide range of haptic stimulations, in addition to providing optimal grounding forces. In particular, a soft robotic approach is used to generate shear (tangential) and compression (normal) forces to the user's body simultaneously (or separately). For the case of one degree-of-freedom shear, a single belt is attached to two rotary actuators (the “belt-rotatory actuator assembly”), whereby the belt wraps around a portion of the user's body, such as his or her fingertip. When one of the actuators is pressurized, the belt is pulled in one direction and generates shear force. When both actuators are pressurized, the belt is pulled from both ends and generates compression force on the user's fingertip. Notably, to obtain an efficient actuation, the two rotary actuators have a novel folded design that can generate high force and displacement simultaneously. Note that the wearable device can achieved two degrees-of-freedom shear (or more) by including multiple instances of the belt-rotatory actuator assembly (as shown in FIGS. 28A and 28B).

(F1) In some embodiments, a haptic device is provided that includes a housing having a first structure configured to be positioned on a distal phalange of a user's finger, and a second structure configured to be positioned at a joint connecting the distal phalange and an intermediate phalange of the user's finger. The haptic device also includes a first bladder that is (i) positioned on an inner surface of the first structure and (ii) fluidically coupled to a fluid source. The haptic device also includes a second bladder that is (i) positioned on an inner surface of the second structure and (ii) fluidically coupled to the fluid source.

(F2) In some embodiments of F1, the inner surface of the first structure defines a first channel, and the first bladder is positioned in the first channel.

(F3) In some embodiments of F2, the inner surface of the second structure defines a second channel, and the second bladder is positioned in the second channel.

(F4) In some embodiments of any of F1-F3, the housing also includes (i) a first port shaped to receive a first conduit that is coupled with the fluid source, whereby the first port extends through the housing to the inner surface of the first structure, and (ii) a second port shaped to receive a second conduit that is coupled with the fluid source, whereby the second port extends through the housing to the inner surface of the second structure.

(F5) In some embodiments of F4, fluid from the fluid source travels through the first conduit to the first port and inflates the first bladder. Likewise, fluid from the fluid source travels through the second conduit to the second port and inflates the second bladder.

(F6) In some embodiments of any of F1-F5, the first bladder is configured to (i) inflate in response to receiving a fluid from the fluid source and (ii) tighten around the distal phalange of the user's finger when inflated to a desired pressure. Also, the second bladder is configured to (i) inflate in response to receiving the fluid from the source and (ii) tighten around the joint connecting the distal phalange and the intermediate phalange of the user's finger when inflated to a desired pressure.

(F7) In some embodiments of F6, the haptic device also includes a sensor configured to measure a size the user's finger. In such embodiments, the desired pressures for the first and second bladders are set based on the size of the user's finger measured by the sensor. In some embodiments, the sensor is configured to measure a grounding force applied to the user and said measurements are used to adaptively adjust the desire pressures for the first and second bladders to obtain a desired comfortable grounding force.

(F8) In some embodiments of F7, the fluid source is in communication with the sensor, and the fluid source is configured to change the pressure in the first and second bladders in response to receiving one or more signals from the sensor.

(F9) In some embodiments of any of F1-F8, the fluid source is in communication with a computing device, and the fluid source is configured to change the pressure in the first and second bladders in response to receiving one or more signals from the computing device.

(F10) In some embodiments of F9, the computing device is in communication with a head-mounted display that presents content to the user, the head-mounted display including an electronic display. In such embodiments, the one or more signals correspond to content displayed on the electronic display.

(F11) In some embodiments of F9, the computing device receives measurements gathered by the sensor, and generates the one or more signals based on the measurements gathered by the sensor.

(F12) In some embodiments of any of F1-F11, when in an inactive state, the first and second bladders are unpressurized. When in an active state, the first and second bladders are pressurized to the desired pressures.

(F13) In some embodiments of any of F1-F12, when the user's finger has a first size, the desired pressures for the first and second bladders are set to first pressure levels. When the user's finger has a second size greater than the first size, the desired pressures for the first and second bladders are set to second pressure levels that are less than the first pressure levels.

(F14) In some embodiments of any of F1-F13, the first and second bladders are set to (i.e., inflated to) distinct pressure levels.

(F15) In some embodiments of any of F1-F14, the housing defines an open space that separates the first and second structures. Moreover, the haptic device also includes an actuator coupled to the housing and positioned in the open space defined by the housing, whereby the actuator is configured to apply haptic stimulations to the user (e.g., shear-based haptic ques and/or compression-based haptic ques).

(F16) In some embodiments of F15, the actuator includes (i) a belt configured to wrap, at least partially, around the user's finger, and (ii) a first inflatable pocket coupled to a first end portion of the belt, and (iii) a second inflatable pocket coupled to a second end portion of the belt.

(F17) In some embodiments of F16, the first inflatable pocket is fluidically coupled to the fluid source, and when the first inflatable pocket receives a fluid from the fluid source, the first inflatable pocket is configured to pull the belt in a first direction. Also, the second inflatable pocket is fluidically coupled to the fluid source, and when the second inflatable pocket receives a fluid from the fluid source, the second inflatable pocket is configured to pull the belt in a second direction, which is opposite the first direction.

(F18) In some embodiments of any of F16-F17, when the first and second inflatable pockets each receives the fluid from the fluid source, the first and second inflatable pockets are configured to pull the belt in the first and second directions simultaneously.

(F19) In some embodiments of any of F16-F18, the actuator further includes third and fourth pockets coupled to distinct portions of the belt. In such embodiments, when inflated by the fluid source, the third and fourth pockets are configured to pull the belt in distinct third and fourth directions that are different from the first and second directions.

(F21) In another aspect, an artificial-reality device is provided that includes a computer, a fluid/pressure source in communication with the computer, and a haptic device in communication with the computer. The haptic device has the structure of the device of F1-F19.

(F22) In another aspect, a wearable device is provided that includes a gourmet and at least one haptic device coupled to the gourmet. The at least one haptic device has the structure of the device of F1-F19.

(G1) In yet another aspect, a haptic device is provided that includes a housing having a first structure configured to be positioned on a first portion of a user, and a second structure configured to be positioned on a second portion of the user. The haptic device also includes an actuator coupled to the housing and positioned in an open space defined by the housing between the first and second structures, whereby the actuator is configured to apply a haptic stimulation to the user in response to receiving a fluid from a fluid source.

(G2) In some embodiments of G1, the haptic device also includes a first bladder (i) positioned on an inner surface of the first structure and (ii) configured to expand in response to receiving a fluid from the fluid source. The haptic device may also include a second bladder (i) positioned on an inner surface of the second structure and (ii) configured to expand in response to receiving a fluid from the fluid source.

(G3) In some embodiments of any of G1-G2, the haptic device has the structure of the device of any of F1-F19.

Accordingly, there is a need for methods, devices, and systems for determining whether a wearable device is in proper contact with a user's skin or clothing, in order to provide a consistent fit and haptic feedback. Embodiments herein are directed toward a sensor system that employs transmit and receive electrodes to determine whether contact (and, in some cases, the quality of the contact) is made between the wearable device and the user.

In some embodiments, a wearable device is provided that includes a plurality of sensors (e.g., electrodes). The wearable device in some instances is worn on the user's wrist (or various other body parts) and is used to send and receive signals identifying whether one or more sensors are in direct contact with the user. In some embodiments, the wearable device adjusts a fit of itself, or a separate wearable structure, to provide a custom fit for the user (i.e., the fit is dynamically changed based on the present circumstances). Moreover, the wearable device can be in communication with a host system (e.g., a virtual reality device and/or an augmented reality device, among others), and the wearable device can adjust a fit of itself, or the separate wearable structure, based on instructions from the host system. As an example, the host system may present media to a user (e.g., may instruct a head-mounted display to display images of the user holding a cup), and the host system may also instruct the wearable device to adjust a fit of the wearable device so that haptic feedback generated by the wearable device (or, a particular structure of the wearable device) is properly applied to the user (e.g., adjust the fit so that an actuator (or some other component) of the wearable device is placed in proper contact with the user's skin).

The devices, systems, and methods described herein provide benefits including but not limited to: (i) generating coupling information between a sensor and a user, (ii) determining a contact pressure and/or a proximity between the sensor and the user, (iii) reporting the coupling information, and (iv) dynamically adjusting a fit of the wearable structure according to the coupling information (if needed). Also, the sensor system described herein that is used to detect coupling with the user has a streamlined, simplified design that reduces manufacturing costs, and an overall encumbrance of the wearable device.

(H1) In accordance with some embodiments, a method is performed at a wearable device that is detachably coupled to an appendage of a user. The wearable device includes a transmit and a receive electrode. The method includes instructing the transmit electrode to transmit a set of signals to be received by the receive electrode. The set of signals transmitted by the transmit electrode creates a signal pathway between the transmit and receive electrodes and at least some signals in the set of signals are received by the receive electrode. The method further includes receiving, from the receive electrode, coupling information indicating a proximity of the receive electrode to the user's appendage. In some embodiments, the coupling information is generated based on, at least in part, the signals in the set of signals are received by the receive electrode. In accordance with a determination that the coupling information does not satisfy a coupling criterion, reporting a coupling deficiency between the receive electrode and the user's appendage. The coupling deficiency can be used to determine that the wearable device (or some structure of the wearable device) is not properly positioned on the user's body.

(H2) In some embodiments of the method of H1, the transmit electrode is located on the user's appendage at a first location and the receive electrode is located on the user's appendage at a second location distinct from the first location of the transmit electrode.

(H3) In some embodiments of the method of any of H1-H2, the receive electrode includes an electrode and a dielectric composite textile fabric in contact with the user's appendage.

(H4) In some embodiments of the method of H3, the receive electrode further includes a shield layer and a silicone layer.

(H5) In some embodiments of the method of any of H1-H4, the transmit electrode includes a shield layer, an electrode, a silicone layer, and a dielectric composite textile fabric in contact with the user's appendage.

(H6) In some embodiments of the method of any of H1-H5, further including (i) a wearable structure configured to be worn on the user's appendage and (ii) an actuator configured to adjust a fit of the wearable structure. The method further includes adjusting, via the actuator, a fit of the wearable structure worn on the user's appendage based at least in part on the coupling information. For example, the coupling information (and, in turn, the coupling deficiency) may indicate that the wearable structure is positioned too far away from the user's skin, such that a fit of the wearable structure is suboptimal. In such a circumstance, the actuator can be used to adjust the fit of the wearable structure according to the coupling information so that the wearable structure has a better fit.

(H7) In some embodiments of the method of H6, adjusting the fit of the wearable structure causes a position of the receive electrode to change.

(H8) In some embodiments of the method of any of H6-H7, adjusting the fit of the wearable structure causes a position of the transmit electrode to change.

(H9) In some embodiments of the method of any of H1-H8, the transmit electrode includes an electrode and skin of the user's appendage. The electrode is physically coupled to the skin of the user's appendage. In some embodiments, a textile material is coupled to the skin and the electrode is physically coupled to the textile material.

(H10) In some embodiments of the method of any of H1-H9, the coupling information includes information indicating a change in capacitance.

(H11) In some embodiments of the method of any of H1-H10, the coupling information indicates the existence of an air gap between the receive electrode and the user's appendage. In some embodiments, the coupling information indicates a contact pressure between the electrode and the user's appendage.

(H12) In some embodiments of the method of any of H1-H11, the coupling information is compared against baseline coupling information to determine whether the coupling information satisfies the coupling criterion. The baseline coupling information may include a measured capacitance of direct contact between the user's appendage and the receive electrode (i.e., a perfect fit).

(H13) In another aspect, a system is provided that includes a wearable device, a wearable structure, and a computer system, and the system is configured to perform the method steps described above in any of H1-H12.

(H14) In yet another aspect, one or more wearable devices are provided and the one or more wearable devices include means for performing the method described in any one of H1-H12.

(H15) In still another aspect, a non-transitory computer-readable storage medium is provided (e.g., as a memory device, such as external or internal storage, that is in communication with a wearable device). The non-transitory computer-readable storage medium stores executable instructions that, when executed by a wearable device with one or more processors/cores, cause the wearable device to perform the method described in any one of H1-H12.

In accordance with some embodiments, a plurality of wearable device each includes one or more processors/cores and memory storing one or more programs configured to be executed by the one or more processors/cores. The one or more programs in each wearable devices includes instructions for performing one or more of the operations of the method described above. In accordance with some embodiments, a non-transitory computer-readable storage medium has stored therein instructions that, when executed by one or more processors/cores of a wearable device, cause the wearable device to perform some of the operations of the method described above (e.g., operations of the receive or transmit electrodes). In accordance with some embodiments, a system includes a wearable device (or multiple wearable devices), a head-mounted display (HMD), and a computer system to provide video/audio feed to the HMD and instructions to the wearable device.

### BRIEF DESCRIPTION OF THE DRAWINGS

For a better understanding of the various described embodiments, reference should be made to the Description of Embodiments below, in conjunction with the following drawings in which like reference numerals refer to corresponding parts throughout the figures and specification.

FIG. 1 is a block diagram illustrating an exemplary haptics system, in accordance with various embodiments.

FIG. 2 is a schematic of an exemplary haptics system in accordance with some embodiments.

FIGS. 3A-3B show various views of a simplified haptic assembly in accordance with some embodiments.

FIG. 3C shows a portion of a representative wearable device that includes multiple haptic assemblies in accordance with some embodiments.

FIG. 3D shows a plurality of support structures in accordance with some embodiments.

FIGS. 4A-4B show side views of a simplified haptic assembly in accordance with some embodiments.

FIGS. 4C-4D show support structures that are shaped in a predefined manner in accordance with some embodiments.

FIG. 5 shows an exemplary wearable device in accordance with some embodiments.

FIG. 6 is a flow diagram illustrating a method of managing creation of haptic stimulations in accordance with some embodiments.

FIG. 7 shows an embodiment of an artificial-reality device.

FIG. 8 shows an embodiment of an augmented-reality headset and a corresponding neckband.

FIG. 9 shows an embodiment of a virtual-reality headset.

FIG. 10 is a block diagram illustrating an example haptics system, in accordance with various embodiments.

FIG. 11 is a schematic of an example haptics system in accordance with some embodiments.

FIGS. 12A to 12C show various views of a representative haptic assembly in accordance with some embodiments.

FIG. 13 shows an oblique view of a representative haptic assembly in accordance with some embodiments.

FIGS. 14A-14C show cross-sectional views of a representative haptic assembly in accordance with some embodiments.

FIG. 15 shows a user's finger in contact with a representative haptic assembly.

FIGS. 16A and 16B show two simplified illustrations are different haptic creating devices.

FIG. 17 is a flow diagram illustrating a method of creating haptic stimulations in accordance with some embodiments.

FIG. 18 illustrates an embodiment of an artificial-reality device.

FIG. 19 illustrates an embodiment of an augmented-reality headset and a corresponding neckband.

FIG. 20 illustrates an embodiment of a virtual-reality headset.

FIG. 21 is a block diagram illustrating an example system, in accordance with various embodiments.

FIG. 22 is a schematic of an example system in accordance with some embodiments.

FIG. 23 shows a representative haptic-feedback mechanism attached to a user's index finger in accordance with some embodiments.

FIGS. 24A and 24B show a representative haptic-feedback mechanism in different pressure states in accordance with some embodiments.

FIG. 24C shows additional components of the representative haptic-feedback mechanism from FIGS. 24A and 24B.

FIGS. 25A and 25B show an example actuator to be included with a representative haptic-feedback mechanism in accordance with some embodiments.

FIGS. 26A through 26C show varies views of a representative haptic-feedback mechanism in accordance with some embodiments.

FIG. 27 shows an example actuator to be included with a representative haptic-feedback mechanism in accordance with some embodiments.

FIGS. 28A and 28B show varies views of a representative haptic-feedback mechanism in accordance with some embodiments.

FIG. 29 is a flowchart for a method of controlling a haptic device in accordance with some embodiments.

FIG. 30 shows an embodiment of an artificial-reality device.

FIG. 31 shows an embodiment of an augmented-reality headset and a corresponding neckband.

FIG. 32 shows an embodiment of a virtual-reality headset.

FIG. 33A is a block diagram illustrating an example system, in accordance with various embodiments.

FIG. 33B is a block diagram illustrating an example system, in accordance with various embodiments.

FIG. 34 is a block diagram illustrating an example wearable device in accordance with some embodiments.

FIG. 35 is an example view of a wearable device on a user's wrist, in accordance with some embodiments.

FIG. 36 is an example cross-sectional view of an electrode of a wearable device, in accordance with some embodiments.

FIG. 37 is an example view of a wearable device on a user's finger in accordance with some embodiments.

FIG. 38 shows sensor response diagrams in accordance with some embodiments.

FIG. 39A shows example signal pathways between wearable devices in accordance with some embodiments.

FIGS. 39B and 39C show an example wearable device that includes a plurality of actuators in accordance with some embodiments.

FIG. 40 is a flow diagram illustrating a method of determining coupling quality in accordance with some embodiments.

FIG. 41 illustrates an embodiment of an artificial reality device.

FIG. 42 illustrates an embodiment of an augmented reality headset and a corresponding neckband.

FIG. 43 illustrates an embodiment of a virtual reality headset.

### DESCRIPTION OF EMBODIMENTS

Reference will now be made to embodiments, examples of which are illustrated in the accompanying drawings. In the following description, numerous specific details are set forth in order to provide an understanding of the various described embodiments. However, it will be apparent to one of ordinary skill in the art that the various described embodiments may be practiced without these specific details. In other instances, well-known methods, procedures, components, circuits, and networks have not been described in detail so as not to unnecessarily obscure aspects of the embodiments.

The terminology used in the description of the various described embodiments herein is for the purpose of describing particular embodiments only and is not intended to be limiting. As used in the description of the various described embodiments and the appended claims, the singular forms “a,” “an,” and “the” are intended to include the plural forms as well, unless the context clearly indicates otherwise. It will also be understood that the term “and/or” as used herein refers to and encompasses any and all possible combinations of one or more of the associated listed items. It will be further understood that the terms “includes,” “including,” “comprises,” and/or “comprising,” when used in this specification, specify the presence of stated features, integers, steps, operations, elements, and/or components, but do not preclude the presence or addition of one or more other features, integers, steps, operations, elements, components, and/or groups thereof.

As used herein, the term “if” is, optionally, construed to mean “when” or “upon” or “in response to determining” or “in response to detecting” or “in accordance with a determination that,” depending on the context. Similarly, the phrase “if it is determined” or “if [a stated condition or event] is detected” is, optionally, construed to mean “upon determining” or “in response to determining” or “upon detecting [the stated condition or event]” or “in response to detecting [the stated condition or event]” or “in accordance with a determination that [a stated condition or event] is detected,” depending on the context.

As used herein, the term “exemplary” is used in the sense of “serving as an example, instance, or illustration” and not in the sense of “representing the best of its kind.”

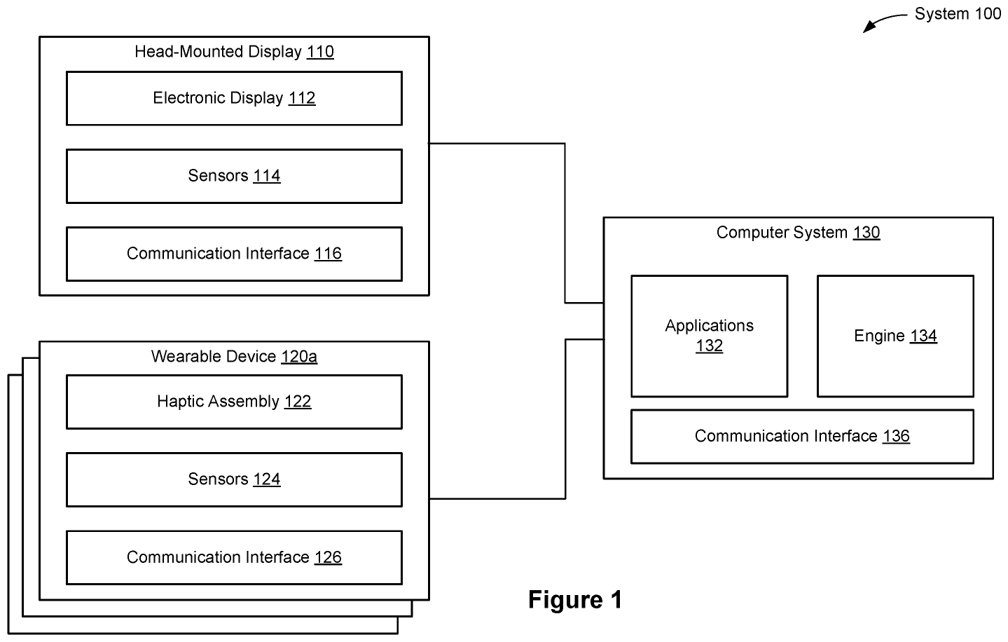

FIG. 1 is a block diagram illustrating an artificial-reality system 100 in accordance with various embodiments. While some example features are illustrated, various other features have not been illustrated for the sake of brevity and so as not to obscure pertinent aspects of the example embodiments disclosed herein. To that end, as a non-limiting example, the system 100 includes one or more wearable devices 120 (sometimes referred to as “wearable apparatuses,” or simply “apparatuses”), which are used in conjunction with a computer system 130 (sometimes referred to a “remote computer system”) and a head-mounted display 110. In some embodiments, the system 100 provides the functionality of an artificial-reality device with haptics feedback, an augmented reality device with haptics feedback, or a combination thereof.

The head-mounted display 110 presents media to a user. Examples of media presented by the head-mounted display 110 include images, video, audio, or some combination thereof. In some embodiments, audio is presented via an external device (e.g., speakers and/or headphones) that receives audio information from the head-mounted display 110, the computer system 130, or both, and presents audio data based on the audio information.

The head-mounted display 110 includes an electronic display 112, sensors 114, and a communication interface 116. The electronic display 112 displays images to the user in accordance with data received from the computer system 130. In various embodiments, the electronic display 112 may comprise a single electronic display 112 or multiple electronic displays 112 (e.g., one display for each eye of a user).

The sensors 114 include one or more hardware devices that detect spatial and motion information about the head-mounted display 110. Spatial and motion information can include information about the position, orientation, velocity, rotation, and acceleration of the head-mounted display 110. For example, the sensors 114 may include one or more inertial measurement units (IMUs) that detects rotation of the user's head while the user is wearing the head-mounted display 110. This rotation information can then be used (e.g., by the engine 134) to adjust the images displayed on the electronic display 112. In some embodiments, each IMU includes one or more gyroscopes, accelerometers, and/or magnetometers to collect the spatial and motion information. In some embodiments, the sensors 114 include one or more cameras positioned on the head-mounted display 110.

The communication interface 116 enables input and output to the computer system 130. In some embodiments, the communication interface 116 is a single communication channel, such as HDMI USB, VGA, DVI, or DisplayPort. In other embodiments, the communication interface 116 includes several distinct communication channels operating together or independently. In some embodiments, the communication interface 116 includes hardware capable of data communications using any of a variety of custom or standard wireless protocols (e.g., IEEE 802.15.4, Wi-Fi, ZigBee, 6LoWPAN, Thread, Z-Wave, Bluetooth Smart, ISA100.11a, WirelessHART, or MiWi) and/or any other suitable communication protocol. The wireless and/or wired connections may be used for sending data collected by the sensors 114 from the head-mounted display to the computer system 130. In such embodiments, the communication interface 116 may also receive audio/visual data to be rendered on the electronic display 112.

The wearable device 120 includes a garment worn by the user (e.g., a glove, a shirt, or pants). In some embodiments, the wearable device 120 collects information about a portion of the user's body (e.g., the user's hand) that can be used as input for artificial-reality applications 132 executing on the computer system 130. In the illustrated embodiment, the wearable device 120 includes a haptic assembly 122, sensors 124, and a communication interface 126. The wearable device 120 may include additional components that are not shown in FIG. 1, such as a power source (e.g., an integrated battery, a connection to an external power source, a container containing compressed air, or some combination thereof), one or more processors, and memory.

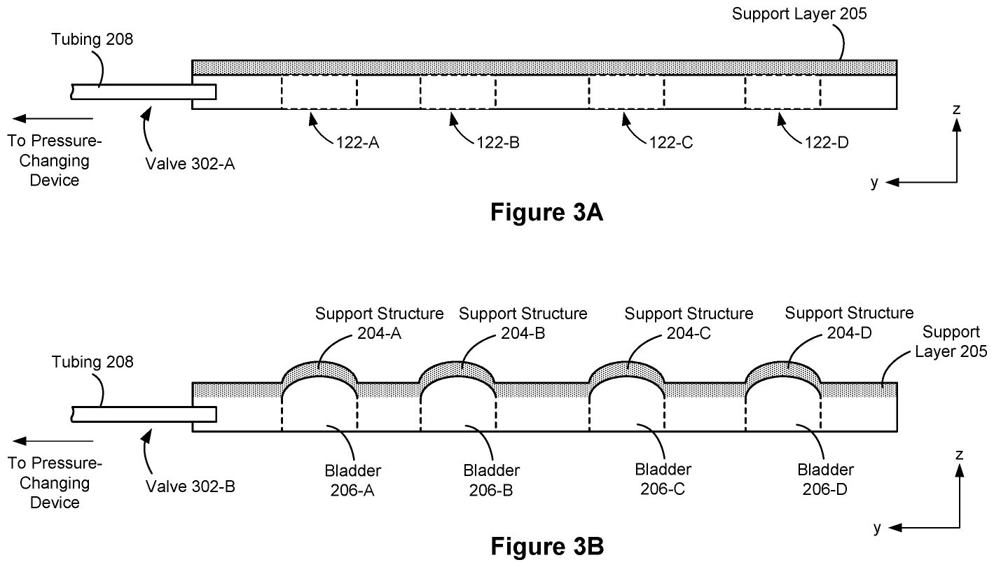

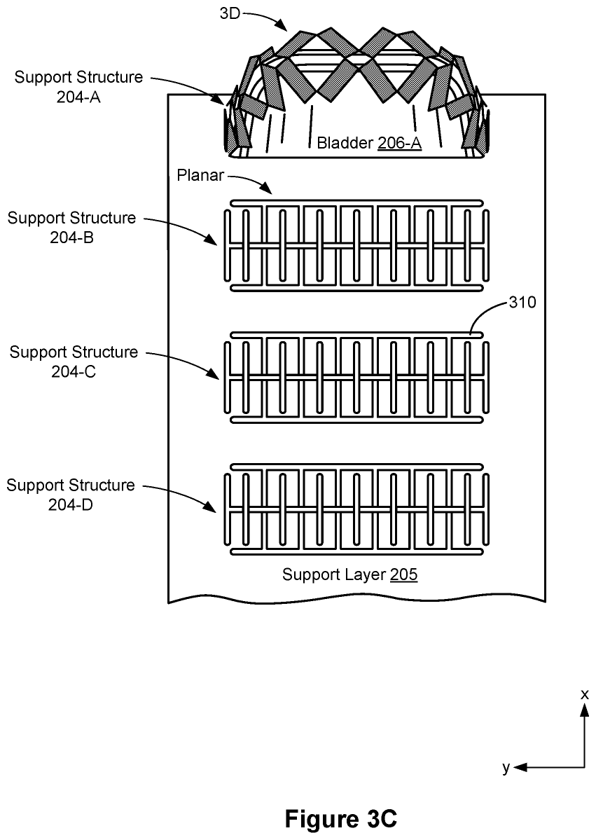

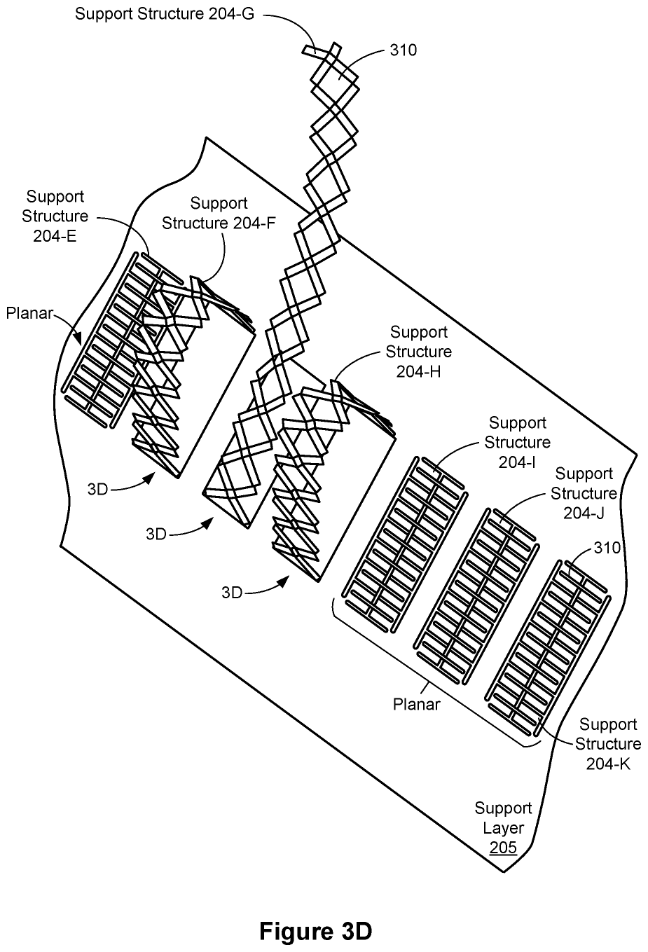

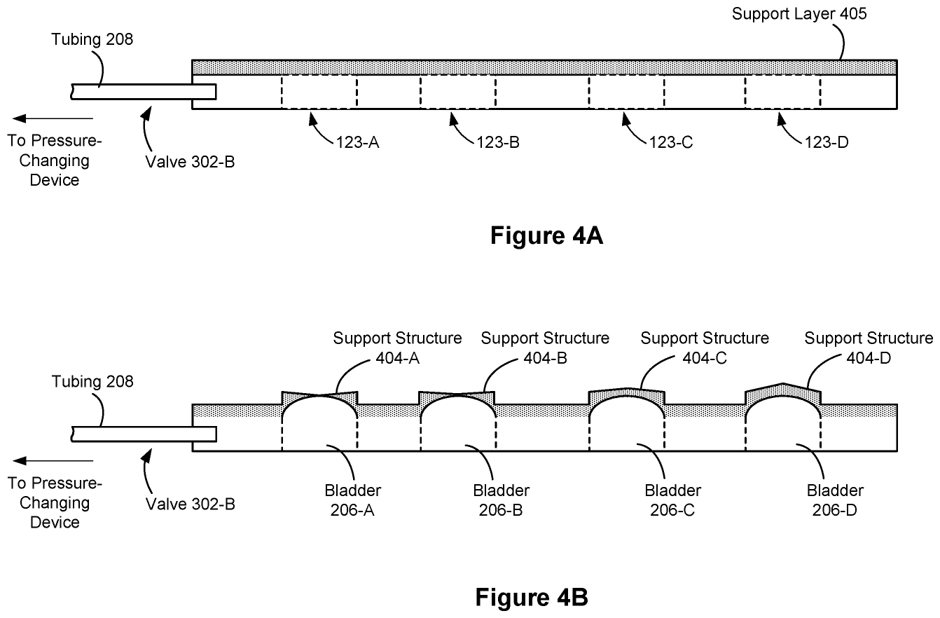

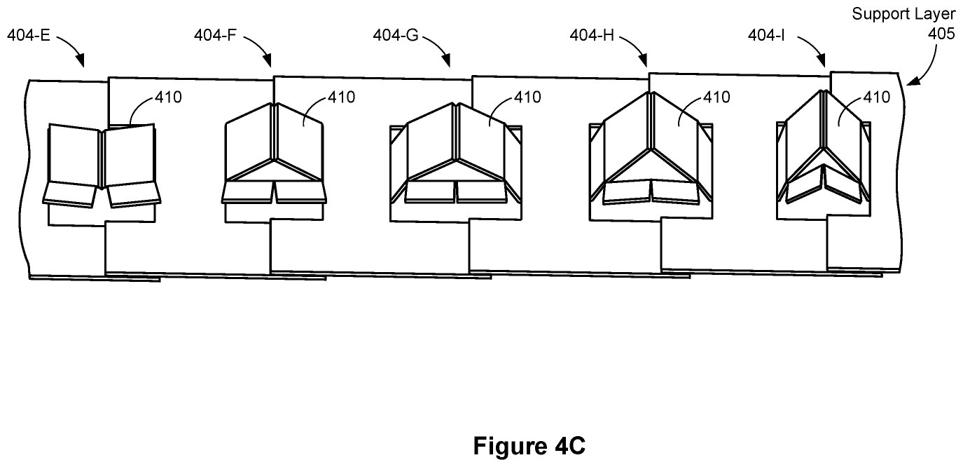

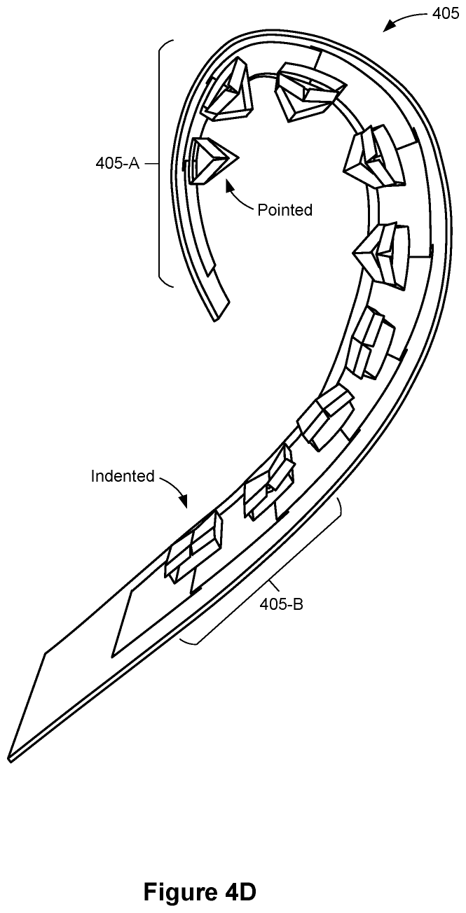

The haptic assembly 122 (sometimes referred to as a “haptic feedback mechanism”) provides haptic feedback (i.e., haptic stimulations) to the user by forcing a portion of the user's body (e.g., hand) to move in certain ways and/or preventing the portion of the user's body from moving in certain ways. To accomplish this, the haptic assembly 122 is configured to apply a force that counteracts movements of the user's body detected by the sensors 114, increasing the rigidity of certain portions of the wearable device 120, or some combination thereof. Various embodiments of the haptic assembly 122 are described with reference to FIGS. 3A-4D. The wearable device 120 may include one or more haptic assemblies 122, as shown in FIGS. 3A-3B and 4A-4B.

The sensors 124 include one or more hardware devices that detect spatial and motion information about the wearable device 120. Spatial and motion information can include information about the position, orientation, velocity, rotation, and acceleration of the wearable device 120 or any subdivisions of the wearable device 120, such as fingers, fingertips, knuckles, the palm, or the wrist when the wearable device 120 is a glove. The sensors 124 may be IMUs, as discussed above with reference to the sensors 114.

The communication interface 126 enables input and output to the computer system 130. In some embodiments, the communication interface 126 is a single communication channel, such as USB. In other embodiments, the communication interface 126 includes several distinct communication channels operating together or independently. For example, the communication interface 126 may include separate communication channels for receiving control signals for the haptic assembly 122 and sending data from the sensors 124 to the computer system 130. The one or more communication channels of the communication interface 126 can be implemented as wired or wireless connections. In some embodiments, the communication interface 126 includes hardware capable of data communications using any of a variety of custom or standard wireless protocols (e.g., IEEE 802.15.4, Wi-Fi, ZigBee, 6LoWPAN, Thread, Z-Wave, Bluetooth Smart, ISA100.11a, WirelessHART, or MiWi), custom or standard wired protocols (e.g., Ethernet, HomePlug, etc.), and/or any other suitable communication protocol, including communication protocols not yet developed as of the filing date of this document.

The computer system 130 includes a communication interface 136 that enables input and output to other devices in the system 100. The communication interface 136 is similar to the communication interface 116 and the communication interface 126.

The computer system 130 is a computing device that executes artificial-reality applications 132 (e.g., virtual-reality applications, augmented-reality applications, or the like) to process input data from the sensors 114 on the head-mounted display 110 and the sensors 124 on the wearable device 120. The computer system 130 provides output data for (i) the electronic display 112 on the head-mounted display 110 and (ii) the haptic assembly 122 on the wearable device 120.

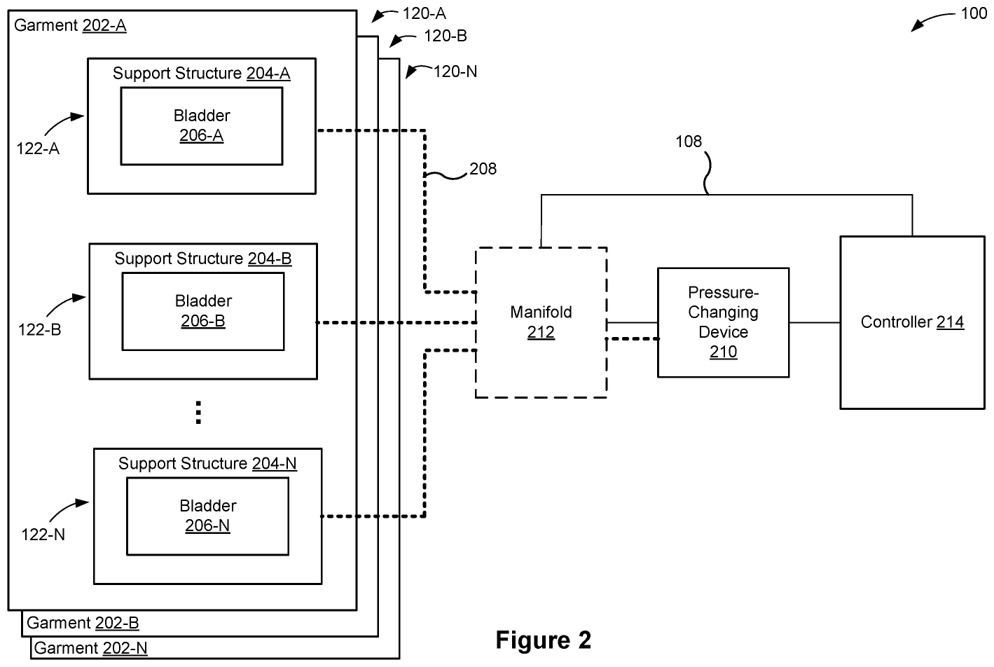

In some embodiments, the computer system 130 sends instructions (e.g., the output data) to the wearable device 120. In response to receiving the instructions, the wearable device 120 creates one or more haptic stimulations (e.g., activates one or more of the haptic assemblies 122). Alternatively, in some embodiments, the computer system 130 sends instructions to an external device, such as a pressure-changing device (see pressure-changing device 210, FIG. 2), and in response to receiving the instructions, the external device creates one or more haptic stimulations (e.g., the output data bypasses the wearable device 120). Alternatively, in some embodiments, the computer system 130 sends instructions to the wearable device 120, which in turn sends the instructions to the external device. The external device then creates of one or more haptic stimulations. Although not shown, in the embodiments that include a distinct external device, the external device may be connected to the head-mounted display 110, the wearable device 120, and/or the computer system 130 via a wired or wireless connection. The external device may be a pressure-changing device, such as a pneumatic device, a hydraulic device, some combination thereof, or any other device capable of adjusting pressure (e.g., fluid pressure).

The computer system 130 can be implemented as any kind of computing device, such as an integrated system-on-a-chip, a microcontroller, a desktop or laptop computer, a server computer, a tablet, a smart phone or other mobile device. Thus, the computer system 130 includes components common to typical computing devices, such as a processor, random access memory, a storage device, a network interface, an I/O interface, and the like. The processor may be or include one or more microprocessors or application specific integrated circuits (ASICs). The memory may be or include RAM, ROM, DRAM, SRAM and MRAM, and may include firmware, such as static data or fixed instructions, BIOS, system functions, configuration data, and other routines used during the operation of the computing device and the processor. The memory also provides a storage area for data and instructions associated with applications and data handled by the processor.

The storage device provides non-volatile, bulk, or long term storage of data or instructions in the computing device. The storage device may take the form of a magnetic or solid state disk, tape, CD, DVD, or other reasonably high capacity addressable or serial storage medium. Multiple storage devices may be provided or available to the computing device. Some of these storage devices may be external to the computing device, such as network storage or cloud-based storage. The network interface includes an interface to a network and can be implemented as either wired or wireless interface. The I/O interface interfaces the processor to peripherals (not shown) such as, for example and depending upon the computing device, sensors, displays, cameras, color sensors, microphones, keyboards, and USB devices.

In the example shown in FIG. 1, the computer system 130 further includes artificial-reality applications 132 and an artificial-reality engine 134. In some embodiments, the artificial-reality applications 132 and the artificial-reality engine 134 are implemented as software modules that are stored on the storage device and executed by the processor. Some embodiments of the computer system 130 include additional or different components than those described in conjunction with FIG. 1. Similarly, the functions further described below may be distributed among components of the computer system 130 in a different manner than is described here.

Each artificial-reality application 132 is a group of instructions that, when executed by a processor, generates artificial-reality content for presentation to the user. An artificial-reality application 132 may generate artificial-reality content in response to inputs received from the user via movement of the head-mounted display 110 or the wearable device 120. Examples of artificial-reality applications 132 include gaming applications, conferencing applications, and video-playback applications.

The artificial-reality engine 134 is a software module that allows artificial-reality applications 132 to operate in conjunction with the head-mounted display 110 and the wearable device 120. In some embodiments, the artificial-reality engine 134 receives information from the sensors 114 on the head-mounted display 110 and provides the information to an artificial-reality application 132. Based on the received information, the artificial-reality engine 134 determines media content to provide to the head-mounted display 110 for presentation to the user via the electronic display 112 and/or a type of haptic feedback to be created by the haptic assembly 122 of the wearable device 120. For example, if the artificial-reality engine 134 receives information from the sensors 114 on the head-mounted display 110 indicating that the user has looked to the left, the artificial-reality engine 134 generates content for the head-mounted display 110 that mirrors the user's movement in an artificial environment.

Similarly, in some embodiments, the artificial-reality engine 134 receives information from the sensors 124 on the wearable device 120 and provides the information to an artificial-reality application 132. The application 132 can use the information to perform an action within the artificial world of the application 132. For example, if the artificial-reality engine 134 receives information from the sensors 124 that the user has closed his fingers around a position corresponding to a coffee mug in the artificial environment and raised his hand, a simulated hand in the artificial-reality application 132 picks up the artificial coffee mug and lifts it to a corresponding height. As noted above, the information received by the artificial-reality engine 134 can also include information from the head-mounted display 110. For example, cameras on the head-mounted display 110 may capture movements of the wearable device 120, and the application 132 can use this additional information to perform the action within the artificial world of the application 132.

The artificial-reality engine 134 may also provide feedback to the user that the action was performed. The provided feedback may be visual via the electronic display 112 in the head-mounted display 110 (e.g., displaying the simulated hand as it picks up and lifts the virtual coffee mug) and/or haptic feedback via the haptic assembly 122 in the wearable device 120. For example, the haptic feedback may prevent (or, at a minimum, hinder/resist movement of) one or more of the user's fingers from curling past a certain point to simulate the sensation of touching a solid coffee mug. To do this, the wearable device 120 changes (either directly or indirectly) a pressurized state of one or more of the haptic assemblies 122. Each of the haptic assemblies 122 includes a mechanism that, at a minimum, provides resistance when the respective haptic assembly 122 is transitioned from a first pressurized state (e.g., atmospheric pressure or deflated) to a second pressurized state (e.g., inflated to a threshold pressure). Structures of haptic assemblies 122 are discussed in further detail below with reference to FIGS. 3A-3B and 4A-4B.

As noted above, the haptic assemblies 122 described herein are configured to transition between a first pressurized state and a second pressurized state to provide haptic feedback to the user. Due to the ever-changing nature of artificial reality, the haptic assemblies 122 may be required to transition between the two states hundreds, or perhaps thousands of times, during a single use. Thus, the haptic assemblies 122 described herein are durable and designed to quickly transition from state to state. To provide some context, in the first pressurized state, the haptic assemblies 122 do not impede free movement of a portion of the wearer's body. For example, one or more haptic assemblies 122 incorporated into a glove are made from flexible materials that do not impede free movement of the wearer's hand and fingers (e.g., the bladder 206, shown in FIGS. 3A-3B and 4A-4B, is made from a flexible polymer). The haptic assemblies 122 are configured to conform to a shape of the portion of the wearer's body when in the first pressurized state. However, once in the second pressurized state, the haptic assemblies 122 are configured to impede free movement of the portion of the wearer's body. For example, the respective haptic assembly 122 (or multiple respective haptic assemblies) can restrict movement of a wearer's finger (e.g., prevent the finger from curling or extending) when the haptic assembly 122 is in the second pressurized state. Moreover, once in the second pressurized state, the haptic assemblies 122 may take different shapes, with some haptic assemblies 122 configured to take a planar, rigid shape (e.g., flat and rigid), while some other haptic assemblies 122 are configured to curve or bend, at least partially.

FIG. 2 is a schematic of the system 100 in accordance with some embodiments. The components in FIG. 2 are illustrated in a particular arrangement for ease of illustration and one skilled in the art will appreciate that other arrangements are possible. Moreover, while some example features are illustrated, various other features have not been illustrated for the sake of brevity and so as not to obscure pertinent aspects of the example implementations disclosed herein.

As a non-limiting example, the system 100 includes a plurality of wearable devices 120-A, 120-B, . . . 120-N, each of which includes a garment 202 and one or more haptic assemblies 122 (e.g., haptic assemblies 122-A, 122-B, . . . 122-N). As explained above, the haptic assemblies 122 are configured to provide haptic stimulations to a wearer of the wearable device 120. The garment 202 of each wearable device 120 can be various articles of clothing (e.g., gloves, socks, shirts, or pants), and thus, the user may wear multiple wearable devices 120 that provide haptic stimulations to different parts of the body. Each haptic assembly 122 is coupled to (e.g., embedded in or attached to) the garment 202. Further, each haptic assembly 122 includes a support structure 204 and at least one bladder 206. The bladder 206 (e.g., a membrane) is a sealed, inflatable pocket made from a durable and puncture-resistance material, such as thermoplastic polyurethane (TPU), a flexible polymer, or the like. The bladder 206 contains a medium (e.g., a fluid such as air, inert gas, or even a liquid) that can be added to or removed from the bladder 206 to change a pressure (e.g., fluid pressure) inside the bladder 206. The support structure 204 is made from a material that is stronger and stiffer than the material of the bladder 206. A respective support structure 204 coupled to a respective bladder 206 is configured to reinforce the respective bladder 206 as the respective bladder changes shape and size due to changes in pressure (e.g., fluid pressure) inside the bladder.

The system 100 also includes a controller 214 and a pressure-changing device 210. In some embodiments, the controller 214 is part of the computer system 130 (e.g., the processor of the computer system 130). The controller 214 is configured to control operation of the pressure-changing device 210, and in turn operation of the wearable devices 120. For example, the controller 214 sends one or more signals to the pressure-changing device 210 to activate the pressure-changing device 210 (e.g., turn it on and off). The one or more signals may specify a desired pressure (e.g., pounds-per-square inch) to be output by the pressure-changing device 210. Generation of the one or more signals, and in turn the pressure output by the pressure-changing device 210, may be based on information collected by the sensors 114 and/or the sensors 124 (FIG. 1). For example, the one or more signals may cause the pressure-changing device 210 to increase the pressure (e.g., fluid pressure) inside a first haptic assembly 122 at a first time, based on the information collected by the sensors 114 and/or the sensors 124 (e.g., the user makes contact with the artificial coffee mug). Then, the controller may send one or more additional signals to the pressure-changing device 210 that cause the pressure-changing device 210 to further increase the pressure inside the first haptic assembly 122 at a second time after the first time, based on additional information collected by the sensors 114 and/or sensors 124 (e.g., the user grasps and lifts the artificial coffee mug). Further, the one or more signals may cause the pressure-changing device 210 to inflate one or more bladders 206 in a first wearable device 120-A, while one or more bladders 206 in a second wearable device 120-B remain unchanged. Additionally, the one or more signals may cause the pressure-changing device 210 to inflate one or more bladders 206 in a first wearable device 120-A to a first pressure and inflate one or more other bladders 206 in the first wearable device 120-A to a second pressure different from the first pressure. Depending on the number of wearable devices 120 serviced by the pressure-changing device 210, and the number of bladders therein, many different inflation configurations can be achieved through the one or more signals, and the examples above are not meant to be limiting.

The system 100 may include an optional manifold 212 between the pressure-changing device 210 and the wearable devices 120. The manifold 212 may include one or more valves (not shown) that pneumatically couple each of the haptic assemblies 122 with the pressure-changing device 210 via tubing 208. In some embodiments, the manifold 212 is in communication with the controller 214, and the controller 214 controls the one or more valves of the manifold 212 (e.g., the controller generates one or more control signals). The manifold 212 is configured to switchably couple the pressure-changing device 210 with one or more haptic assemblies 122 of the same or different wearable devices 120 based on one or more control signals from the controller 214. In some embodiments, instead of using the manifold 212 to pneumatically couple the pressure-changing device 210 with the haptic assemblies 122, the system 100 may include multiple pressure-changing devices 210, where each pressure-changing device 210 is pneumatically coupled directly with a single (or multiple) haptic assembly 122. In some embodiments, the pressure-changing device 210 and the optional manifold 212 can be configured as part of one or more of the wearable devices 120 (not illustrated) while, in other embodiments, the pressure-changing device 210 and the optional manifold 212 can be configured as external to the wearable device 120. A single pressure-changing device 210 may be shared by multiple wearable devices 120.

In some embodiments, the pressure-changing device 210 is a pneumatic device, hydraulic device, a pneudraulic device, or some other device capable of adding and removing a medium (e.g., fluid, liquid, gas) from the one or more haptic assemblies 122.

The devices shown in FIG. 2 may be coupled via a wired connection (e.g., via busing 108). Alternatively, one or more of the devices shown in FIG. 2 may be wirelessly connected (e.g., via short-range communication signals).

FIGS. 3A-3B show various views of a simplified haptic assembly in accordance with some embodiments. In particular, FIG. 3A-3B are side views showing a plurality of haptic assemblies 122 (e.g., haptic assemblies 122-A, 122-B, 122-C, and 122-D) on a garment. For example, haptic assemblies 122-A to 122-D may be haptic assemblies 122 that are disposed along a finger of a glove. As shown, a respective haptic assembly 122 includes (i) a bladder 206, and (ii) a support structure 204 that is coupled to at least a portion of the bladder 206. In some cases, as shown, a respective support structure 204 is coupled to a top surface of respective bladder 206. In some embodiments, a respective support structure 204 is coupled to a respective bladder 206 via a support layer 205 that includes a plurality of support structures 204. For example, as shown in FIGS. 3A-3B, support layer 205 includes four support structures 204-A to 204-D. FIGS. 3C and 3D as well as FIGS. 4A-4D also show examples of a support layer 205 that includes a plurality of support structures 204. Alternatively, in some other embodiments, the support layer 205 is not included and the support structures 204 alone are coupled to the bladders 206.

FIG. 3A is a side view of haptic assemblies 122-A, 122-B, 122-C, and 122-D when the haptic assemblies 122 have a first pressure (e.g., are in a first pressurized state) that is below a threshold pressure (e.g., threshold fluid pressure). In this case, the support layer 205 and the corresponding support structures 204-A, 204-B, 204-C, and 204-D are configured to be planar (e.g., two-dimensional, flat). In some embodiments, a respective haptic assembly 122 has the first pressure when a respective bladder 206 is in a non-pressurized state (e.g., deflated or at atmospheric pressure).

FIG. 3B shows a side view of haptic assemblies 122-A, 122-B, 122-C, and 122-D when the haptic assemblies have a second pressure (e.g., are in a second pressurized state) that is at or above the threshold pressure (e.g., threshold fluid pressure). In this case, the support layer 205 and the corresponding support structures 204-A, 204-B, 204-C, and 204-D are configured to form a three-dimensional shape. When a respective bladder 206 has a pressure that is above the threshold pressure, the respective bladder 206 expands, causing a respective support structure 204 to also expand (e.g., elastically deform, lengthen) in one or more directions and to reinforce the respective bladder 206 in the one or more directions. In some embodiments, the one or more directions includes at least one out-of-plane direction. For example, as shown in FIGS. 3A-3B, the support structures 204 lie flat in the x-y plane when the bladders 206 have a fluid pressure that is below the threshold pressure, and the bladders 206 and the support structures 204 extend in the z-direction when the bladders 206 have a fluid pressure that is at or above the threshold fluid pressure. Additional details regarding support structures 204 are provided below with respect to FIGS. 3C-3D and 4A-4D.

Although FIGS. 3A and 3B show all of the haptic assemblies 122 having a similar pressure (e.g., all of the haptic assemblies 122 in FIG. 3A are not pressurized and all of the haptic assemblies 122 in FIG. 3B are pressurized beyond the threshold pressure), the haptic assemblies 122 may each have different pressures. For example, haptic assembly 122-A may have the first pressure, as shown in FIG. 3A, concurrently with haptic assembly 122-B having the second pressure, as shown in FIG. 3B.

Various haptic assembly 122 configurations may be used, and each of the haptic assemblies 122 is configured to create one or more haptic stimulations when the bladder 206 is pressurized. Additionally, the various bladders 206 may be designed to create haptic stimulations by way of positive pressure and/or negative pressure. “Haptic stimulations” (e.g., tactile feedback and/or haptic feedback) include but are not limited to a touch stimulation, a swipe stimulation, a pull stimulation, a push stimulation, a rotation stimulation, a heat stimulation, a pulsating stimulation, a vibration stimulation, and/or a pain stimulation.

In some embodiments, the bladder 206 includes an opening that is sized to accommodate a valve 302-A that is configured to deliver a medium (e.g., fluid, liquid, gas) to the bladder 206. The valve 302-A is fitted into the opening so that the bladder 206 remains sealed (i.e., airtight). The valve 302-A also includes an opening that is sized to receive an end of the tubing 208. Alternatively, in some embodiments, the bladder 206 includes an opening, which is illustrated as the valve 302-B. The valve 302-B is also sized to receive an end of the tubing 208. In either case, an adhesive may be deposited around a perimeter of the opening defined by the bladder 206 to ensure that the bladder 206 remains sealed.

FIG. 3C shows a portion of a representative wearable device that includes multiple haptic assemblies 122 in accordance with some embodiments. In particular, FIG. 3C shows a top view of a plurality of haptic assemblies 122 that are located on a wearable device 120 or garment 202. In this example, four haptic assemblies 122 are shown. Each haptic assembly 122 includes a respective support structure 204 that is coupled to a respective bladder 206 and all four of the support structures 204 are part of a support layer 205. In this example, the bladder 206-A is shown to have a fluid pressure that is at or above the threshold fluid pressure (e.g., the bladder 206-A is inflated) and the bladders 206-B, 206-C, and 206-D which are coupled, respectively, to the support structures 204-B, 204-C, and 204-D, are not visible as they each have a fluid pressure that is below the threshold fluid pressure (e.g., the bladders 206-B to 206-D are not inflated). As shown, support structures 204-B to 204-D have a planar shape (e.g., have a flat or two-dimensional shape, and lie in the x-y plane) since their respective bladders 206-B to 206-D are not inflated.

As also shown, each support structure 204 includes a predefined pattern of cuts 310 that allows the support structure 204 to expand (deform, lengthen) when a corresponding bladder 206 that is coupled to a support structure 204 is inflated, as shown by support structure 204-A. Each support structure 204 is configured to expand/deform into a three-dimensional shape (e.g., extends out of the x-y plane) when the corresponding bladder 206 has a fluid pressure that is at or above the threshold fluid pressure (e.g., bladder 206-A is inflated and support structure 204-A has a three-dimensional shape). In the illustrated embodiment, support structures 204-A to 204-D have the same predefined pattern of cuts 310. In other embodiments, at least one of the supports structures 204 has a predefined pattern of cuts 310 that differs from the predefined pattern of cuts 310 of the other support structures 204. The predefined pattern of cuts 310 allows a respective support structure 204 to form a three-dimensional shape when a respective bladder 206 that is coupled to the respective support structure 204 is inflated. The respective support structure 204 is configured to have a first strain in the one or more directions when the respective bladder 206 has the first fluid pressure that is below the threshold fluid pressure (e.g., when the respective bladder 206 is not inflated), and to have a second strain that is greater than the first strain in the one or more directions when the respective bladder 206 has the second fluid pressure that is at or above the threshold fluid pressure and greater in magnitude than the first fluid pressure (e.g., when the respective bladder 206 is inflated). In some embodiments, the predefined pattern of cuts 310 imparts anisotropic properties onto the support structure 204. For example, the support structure 204 may have first strengths (or stiffnesses, or some other properties) in a first direction (e.g., longitudinally) and have second strengths (or stiffnesses, or some other properties) in a second direction (e.g., laterally), or vice versa. The key here is that the anisotropic properties can be encoded into the support structure 204 by the predefined pattern of cuts 310. Consequently, and because various patterns of cuts are possible, any number of anisotropic property encodings are also possible. Put another way, the anisotropic properties of the support structure 204 can be easily tailored to a specific application and bladder design.

Also, the support structure 204, when having a three-dimensional shape, may have a flexibility that is different from (e.g., greater than) an elasticity of the material of the support structure 204 and/or a flexibility of the support structure 204 when it has the planar shape. Again, the predefined pattern of cuts 310 can be used to tailor a flexibility of the support structure 204 from state to state (e.g., encode a first degree of flexibility when the support structure 204 has the planar shape and a second degree of flexibility, different from the first degree of flexibility, when the support structure 204 has the three-dimensional shape).

Additionally, the respective support structure 204 is configured to impart an amount of force onto the respective bladder 206, which is related to the fluid pressure inside the respective bladder 206. For example, when a respective bladder 206 has a fluid pressure that is at or above a threshold fluid pressure, a respective structure 204 may be configured to impart an amount of force, in the one or more directions, that increases linearly or exponentially with an increase in the fluid pressure inside the respective bladder 206. In some embodiments, the respective structure 204 may be configured to exert no force, a small amount, or a negligible amount of force onto the respective bladder 206 when the respective bladder 206 has a fluid pressure that is below the threshold fluid pressure. In some embodiments, the amount of force exerted onto the respective bladder 206 by the respective support structure 204 is proportional to the fluid pressure in the respective bladder 206.

FIG. 3D shows a plurality of support structures 204 in accordance with some embodiments. As shown, each support structure 204 includes a predefined pattern of cuts 310 that are formed in a material (e.g., cuts in a material form the predetermined pattern of cuts 310). In some embodiments, the predefined pattern of cuts 310 may include any of orthogonal cuts and/or triangular cuts. In some embodiments, cuts of the predefined pattern of cuts 310 are no greater than 5 millimeters in size. In some embodiments, the predefined pattern of cuts 310 may include multiple layers of cuts. For instance, an example predefined pattern of cuts 310 may include a first layer having a plurality of cuts forming a first predefined sub-pattern and a second layer having a plurality of cuts forming a second predefined sub-pattern. Thus, the combined first predefined sub-pattern and second predefined sub-pattern form a predefined pattern of cuts 310.

In some embodiments, the material of the support structure 204 has a stronger tensile strength, is stiffer, and/or stronger than a material of a bladder 206. For example, a support structure 204 may include a material such as a thin film or polyester film (e.g., biaxially-oriented polyethylene terephthalate (BoPET)). Also, the support layer 205 may be a thin film (e.g., a planar, two-dimensional material) that includes a plurality of the predefined pattern of cuts 310, forming the plurality of support structures 204-E to 204-K. FIG. 3D shows the support structures 204-E, 204-I, 204-J, and 204-K having a planar shape and the support structures 204-F and 204-H having a three-dimensional shape (corresponding bladders are not shown for ease of illustration). As shown, the predefined pattern of cuts 310 determines the shape of the support structures 204 when they have the three-dimensional shape. In some embodiments, a support structure 204 is attached to support layer 205 such that the support layer 205 may be easily overlaid or coupled to a garment 202 or wearable device 120 that includes a bladder 206. The support structure(s) 204 on the support layer 205 are positioned corresponding to the position of bladder(s) 206 on the garment 202 or wearable device 120. Thus, a respective support structure 204 on the support layer 205 can be easily coupled to a respective bladder 206 on the garment 202 or wearable device 120. Support structures 204-E, 2014-F, and 204-H to 204-K show examples of support structures 204 that are attached to support layer 205. After the respective support structures 204 on the support layer 205 are coupled to respective bladders 206, the remaining portions of support layer 205 (e.g., portions that do not include the coupled support structures 204) may be left on (in some cases, glued or attached to) the garment 202 or wearable device 120 or may be removed such that only the support structures 204 remain coupled to the bladder 206 of the garment 202 or wearable device 120.

Alternatively, a support structure 204 may be formed by creating the predefined pattern of cuts 310 on a material and detaching the predefined pattern of cuts 310 from the rest of the material that does not include the predefined pattern of cuts 310. The support structure 204-G illustrates an example of a support structure 204 that is formed on support layer 205 and is semi-detached (one side is detached and the other side is still attached) from support layer 205. In such cases, the support structure 204-G can be completely detached from support layer 205 and individually coupled to a respective bladder 206.

FIGS. 4A-4B show side views of a simplified haptic assembly in accordance with some embodiments. Haptic assemblies 123 are examples of haptic assemblies 122 but, for ease of discussion, include support structures 404 instead of support structures 204. As will be shown below, support structures 404 have a predefined pattern of cuts 410 (shown in FIG. 4C) that is different from the predefined pattern of cuts 310 of support structures 204. Aside from the description of support structure 404, the details regarding haptic assembly 122 also apply to haptic assembly 123. Thus, details regarding support structure 404 and support layer 405, which were previously discussed with respect to support structures 204 and support layer 205, are not repeated here for the sake of brevity.

The haptic assembly 123 includes (i) a bladder 206 and (ii) a support structure 404 that is attached to at least a portion of the bladder 206. Note that the haptic assembly may include a single bladder 206 as shown in FIG. 4A or multiple individual addressable bladders 206. In some cases, as shown, a respective support structure 404 is attached to a top surface of respective bladder 206. In some embodiments, a respective support structure 404 is attached to a respective bladder 206 via a support layer 405 that includes a plurality of support structures 404.

FIG. 4A shows a side view of haptic assemblies 123-A, 123-B, 123-C, and 123-D when the bladder (or bladders) 206 is (are) unpressurized. In this case, the support layer 405 and the corresponding support structures 404-A, 404-B, 404-C, and 404-D are configured to be planar (e.g., two-dimensional, flat). In some embodiments, a respective haptic assembly 123 has the first pressure when a respective bladder 206 is in a non-pressurized state (e.g., the bladder 206 is at ambient pressure).

FIG. 4B shows a side view of haptic assemblies 123-A, 123-B, 123-C, and 123-D when the bladder (or bladders) 206 is (are) pressurized (e.g., at or above a threshold fluid pressure). In this case, the support layer 405 and the corresponding support structures 404-A, 404-B, 404-C, and 404-D are configured to form a three-dimensional shape. When a respective bladder 206 has a pressure that is at or above the threshold pressure, the respective bladder 206 expands, causing a respective support structure 404 to expand (e.g., elastically deform, lengthen, or otherwise shift) in one or more directions and to reinforce the respective bladder 206 in the one or more directions. In some embodiments, the one or more directions include at least one out-of-plane direction.

Similar to support structure 204, support structure 404 also includes a predefined pattern of cuts 410 (shown in FIG. 4C) that determines the shape of the support structure 404 when it has a three-dimensional shape. However, the pattern of cuts 410 of the support structure 404 allows support structure 404 to be configurable to have a variety of three-dimensional shapes. As shown in FIG. 4B, support structure 404-A has a first three-dimensional shape (e.g., indented shape) and support structure 404-D has a second three-dimensional shape (e.g., pointed shape) that is distinct from the first three-dimensional shape. Each of the support structures 404-B and 404-C may also have three-dimensional shapes (e.g., slightly indented, slightly pointed) that are different from the three-dimensional shape of the other support structures 404 of the support layer 405. Details regarding the different three-dimensional shapes are described below with respect to FIGS. 4C and 4D.

At a high level, support structures with an indented or otherwise flat shape inhibit bending of the haptic assembly 123 while support structures with a pointed shape allow the haptic assembly 123 to bend unencumbered to a point (as shown in FIG. 4D).

FIGS. 4C-4D show support structures 404 that are shaped in a predefined manner in accordance with some embodiments. Five support structures 404 are shown in FIG. 4C. When part of a haptic assembly 123, each support structure 404 is coupled to a respective bladder 206, not shown for ease of illustration, and each of the support structures 404 has a similar (but necessarily the same) predefined pattern of cuts 410. However, each of the support structures 404 shown in FIG. 4C also has a predetermined three-dimensional shape (e.g., extends out of the x-y plane) that is different from a predetermined three-dimensional shape of another support structure 404, and all of the predetermined three-dimensional shapes are determined by the predefined pattern of cuts 410. For example, as shown in FIG. 4C, support structure 404-E has an indented shape, while support structures 404-F to 404-I each have pointed shape with varying degrees of “pointedness” or protrusion in the one or more directions. It is noted that in some other embodiments, at least one of the support structures 404-E to 404-I may have a different predefined pattern of cuts 410. Different patterns of cuts 410 may be needed depending on the user's body and/or a desired haptic stimulation. For example, a first joint on the user's finger may require a first shape in order to deliver an actuate haptic stimulation (and, thus, a first pattern of cuts 410), a second joint on the user's finger may require a second shape, different from the first shape, in order to deliver an actuate haptic stimulation (and, thus, a second pattern of cuts 410 different from the first pattern of cuts 410), and so on.

In some embodiments, a respective support structure 404 is configured to essentially maintain its shape regardless of the fluid pressure inside the inflatable bladder. Alternatively, in some embodiments, a respective support structure 404 is configured to have a first three-dimensional shape (e.g., a pointed shape) when a respective bladder 206 has a first fluid pressure and to have a second three-dimensional shape (e.g., an indented shape) that is different from the first three-dimensional shape when the respective bladder 206 has a second fluid pressure that is less than (e.g., smaller than) the first fluid pressure. In this example, a respective support structure 404 may be configured to have a pointed three-dimensional shape, as shown by support structure 404-E, when the fluid pressure in a respective bladder 206 is high and to have an indented three-dimensional shape, as shown by support structure 404-A when the fluid pressure in the respective bladder 206 is low. In other words, the respective support structure 404 may be configured to pop out of its intended shape to a pointed shape when the fluid pressure in the respective bladder 206 goes from low to high.

In some embodiments, the predefined pattern of cuts 410 imparts anisotropic properties onto the support structure 404. For example, the support structure 404, when having a three-dimensional shape, may have first strengths (or stiffnesses, or some other properties) in a first direction (e.g., longitudinally) and have second strengths (or stiffnesses, or some other properties) in a second direction (e.g., laterally), or vice versa. Also, the support structure 404, when having a three-dimensional shape, may have an elasticity and/or flexibility that is different from an elasticity and/or flexibility of the material of the support structure 404. In some embodiments, the anisotropic properties of a respective support structure 404 are designed (e.g., tailored) based on desired properties of a respective haptic assembly 123. For example, the respective support structure 404 may have a predefined pattern of cuts 410 that reinforces an end portion of a respective bladder 206 where weakness tends to be a concern.

Additionally, a first support structure 404, having a first three-dimensional shape (e.g., pointed), may impart a first degree of flexibility to the support layer 405, while a second support structure 404, having a second three-dimensional shape (e.g., indented), may impart a second degree of flexibility to the support layer 405 that is different from the first degree of flexibility. For example, as shown in FIG. 4D, a support layer 405 has a first portion 405-A and a second portion 405-B. The support structures 404 in the first portion 405-A of support layer 405 have pointed shapes that allow the first portion 405-A of support layer 405 to be flexible (e.g., bendable) and able to bend. In contrast, the support structures 404 in the second portion 405-B of support layer 405 have indented shapes that are configured to provide rigidity to the second portion 405-B of support layer 405, so that it is stiffer and less bendable compared to the to the first portion 405-A of support layer 405. In some instances, while the support structures 404 reinforce the inflatable bladder 206, the inflatable bladder 206 may also reinforce an inner surface of the support structures 404 so that the support structures 404 do not collapse when pressed against each other (e.g., during finger flexion).

While not shown for ease of illustration in FIG. 4D, the support structures 404 can inhibit bending by contacting a neighboring support structure 404 as a result of the support layer 405 bending some amount. In practice, the support structures 404 may be positioned closer together so that contact between neighboring support structures 404 occurs after a minimal degree of bending. In some instances, a user experiences a first haptic stimulation as a result of pointed support structures contacting each other, while the user may experience a second haptic stimulation, different from the first haptic stimulation, as a result of indented (or flat) support structures contacting each other.

Additional details regarding the material of support structure 404 are described above with respect to support structure 204, and thus are not repeated here for brevity.

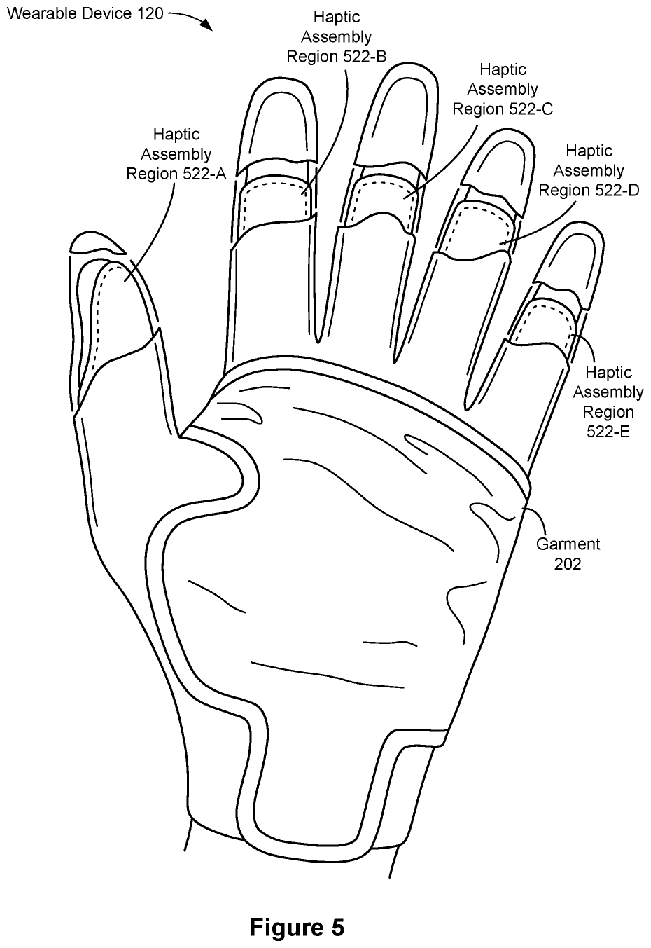

FIG. 5 shows an exemplary wearable device 120 in accordance with some embodiments. A wearable device 120 includes a garment 202 and one or more haptic assemblies 122 or 123 located in different haptic assembly regions 522. For ease of illustration, portions of the garment 202 have been removed to show the haptic assembly regions 522 hidden underneath the garment 202.

For example, as shown in FIG. 5, the wearable device includes a garment 202 that is a glove and five haptic assembly regions 522-A to 522-E, each corresponding to a digit (e.g., finger or thumb) of the glove. In this example, each haptic assembly region 522 corresponds to a finger region or thumb region on the garment 202 and may include one or more haptic assemblies 122 or 123, as described above. In particular, a haptic assembly 122 or 123 may be positioned on a palm region of the user's hand, or on palmar portions of the user's fingers or thumb (e.g., any of haptic assembly regions 522-A to 522-E). Thus, each of these regions of the user's body can experience one or more haptic stimulations. In some embodiments, one or more types of haptic assemblies 122 or 123 may be included in the wearable device 120. For example, haptic assembly region 522-A, which corresponds to a thumb region, may include one or more haptic assemblies 122. In contrast, haptic assembly region 522-B, which corresponds to a forefinger region, may include one or more haptic assemblies 123 and haptic assembly region 522-D, which corresponds to a ring finger region, may include a combination of haptic assemblies 122 and 123. Note that various other combinations of haptic assemblies 122/123 can be used in the haptic assembly regions 522.

Although not shown, in some embodiments, one or more haptic assemblies 122 or 123 are positioned on dorsal and/or palmar sides of the user's hand. For example, one or more of the user's fingers may include one or more haptic assemblies 122 or 123 on the dorsal-side of the finger, and also one or more other haptic assemblies 122 or 123 on the palmar-side of the finger. Similar configurations can be used on the palm and the back of the user's hand, and various other body parts of the user. In this way, the wearable device 120 is able to increase haptics to the back of the user's hand, create unique haptic stimulations across the user's hand, and also increase control of that portion of the user's hand.

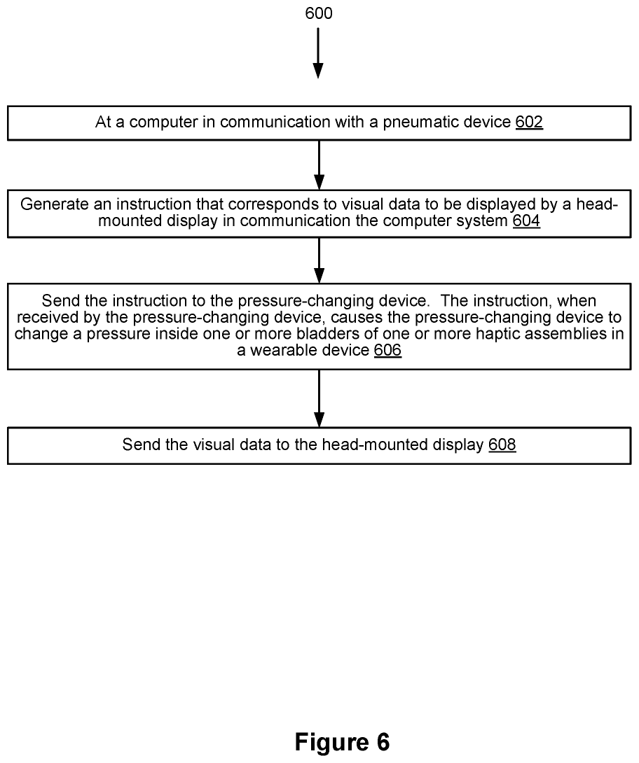

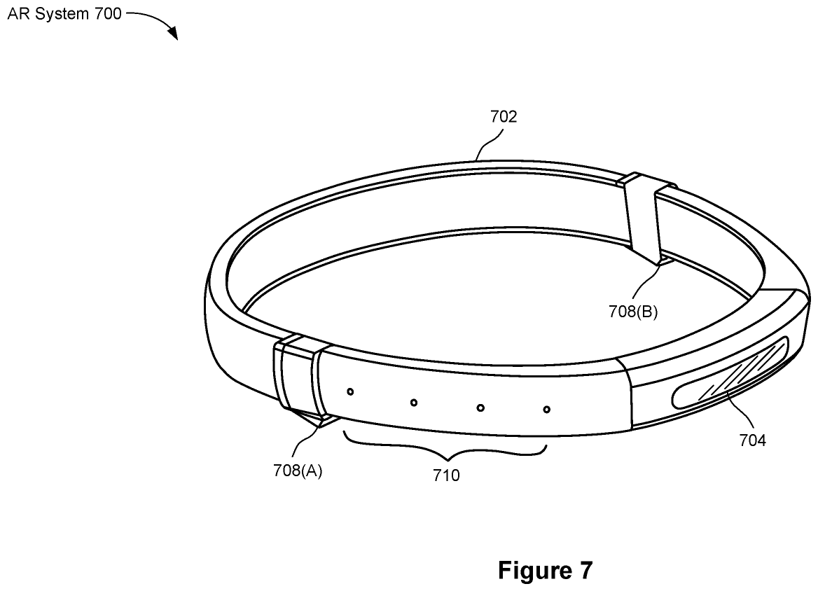

FIG. 6 is a flow diagram illustrating a method 600 of managing creation of haptic stimulations in accordance with some embodiments. The steps of the method 600 may be performed by a computer (e.g., computer system 130, FIG. 1)(602). FIG. 6 corresponds to instructions stored in a computer memory or computer readable storage medium (e.g., memory of the computer system 130). For example, the operations of method 600 are performed, at least in part, by a communication interface (e.g., similar to communication interface 126) and an artificial-reality generation module (e.g., part of engine 134. FIG. 1). It is noted that the method described below can be implemented with any of the wearable devices and haptic assemblies discussed above.

The method 600 includes generating (604) an instruction that corresponds to visual data (or some other data, such as audio data) to be displayed (or otherwise presented) by a head-mounted display in communication the computer system 130 (and/or corresponds to information received from one or more sensors 124 of the wearable device 120 and/or information received from one or more sensors 114 of the head-mounted display 110). In some embodiments, the computer system 130 generates the instruction based on information received from the sensors on the wearable device. Alternatively or in addition, in some embodiments, the computer system 130 generates the instruction based on information received from the sensors on the head-mounted display. For example, cameras (or other sensors) on the head-mounted display may capture movements of the wearable device, and the computer system 130 can use this information when generating the instruction.

The method 600 further includes sending (606) the instruction to a pressure-changing device (e.g., pressure-changing device 210, FIG. 2) that is in communication with the computer system 130 (e.g., send the instruction in a communication signal from a communication interface). The instruction, when received by the pressure-changing device, causes the pressure-changing device to change a pressure inside one or more bladders (e.g., bladder 206) of one or more haptic assemblies 122 or 123 of a wearable device 120. In doing so, a wearer of the wearable device 120 will experience a haptic stimulation that corresponds to the visual data. In some embodiments, the instruction specifies the change in the pressure to be made by the pressure changing device 210. It is noted that in some situations, instead of the computer system 130 sending the instruction to the pressure-changing device 210, the computer system 130 sends the instruction to the wearable device 120. In response to receiving the instruction, the wearable device 120 sends the instruction to the pressure-changing device 210. The pressure-changing device is discussed in further detail above with reference to FIG. 2.

After (or while, or before) sending the instruction, the method 600 also includes sending (608) the visual data to the head-mounted display. For example, the head-mounted display may receive the visual data from the computer system 130 and may, in turn, display the visual data on its display(s). As an example, if the computer system 130 receives information from the sensors 124 of the wearable device 120 that the user has closed his fingers around a position corresponding to a coffee mug in the artificial environment and raised his hand, a simulated hand in an artificial-reality application picks up the artificial coffee mug and lifts it to a corresponding height. Generating and sending visual data is discussed in further detail above with reference to FIG. 1.

In conjunction with displaying the visual data, one or more bladders of the wearable device are inflated or deflated to the pressure (as noted above). As an example, the wearable device may include one or more haptic assemblies 122 or 123 coupled to a garment 202. Each haptic assembly 122 or 123 includes: includes (i) a bladder 206, and (ii) a support structure 204 or 404 attached to a portion of the bladder, where the bladder is pneumatically coupled to the pressure-changing device 210 that is configured to control a pressurized state of the bladder. Further, each haptic assembly 122 or 123 is configured to: (i) have a first strain (e.g., be in a contracted state) in one or more directions when the inflatable bladder has a first fluid pressure (e.g., is in a first pressurized state), and (ii) have a second strain (e.g., be in an expanded state) in the one or more directions when the inflatable bladder has a second fluid pressure (e.g., is in a second pressurized state) that is greater than the first fluid pressure, thereby providing a haptic stimulation to a wearer of the garment when the respective bladder is in the second pressurized state. Accordingly, in this particular example, when the pressure changing device 210 changes the pressure inside one or more bladders 206 of the wearable device 120 (606), the respective support structure 204 or 404 in the respective haptic assembly 122 or 123 has the second strain that is greater than the first strain. This particular example relates to the haptic assemblies 122 discussed above with reference to FIGS. 3A through 4D.

Embodiments of this disclosure may include or be implemented in conjunction with various types of artificial-reality systems. Artificial reality may constitute a form of reality that has been altered by virtual objects for presentation to a user. Such artificial reality may include and/or represent virtual reality (VR), augmented reality (AR), mixed reality (MR), hybrid reality, or some combination and/or variation of one or more of the these. Artificial-reality content may include completely generated content or generated content combined with captured (e.g., real-world) content. The artificial-reality content may include video, audio, haptic feedback, or some combination thereof, any of which may be presented in a single channel or in multiple channels (such as stereo video that produces a three-dimensional effect to a viewer). Additionally, in some embodiments, artificial reality may also be associated with applications, products, accessories, services, or some combination thereof, which are used, for example, to create content in an artificial reality and/or are otherwise used in (e.g., to perform activities in) an artificial reality.

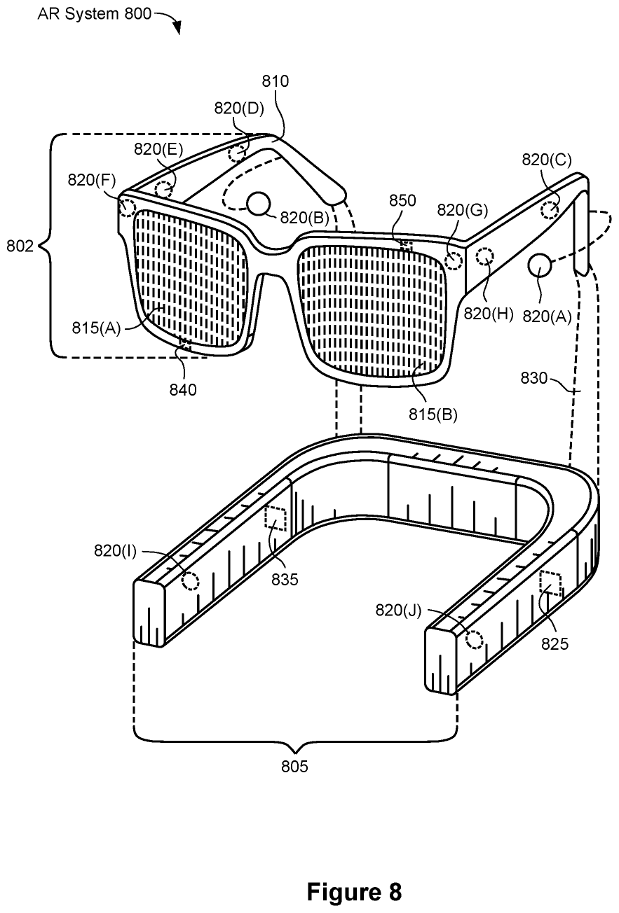

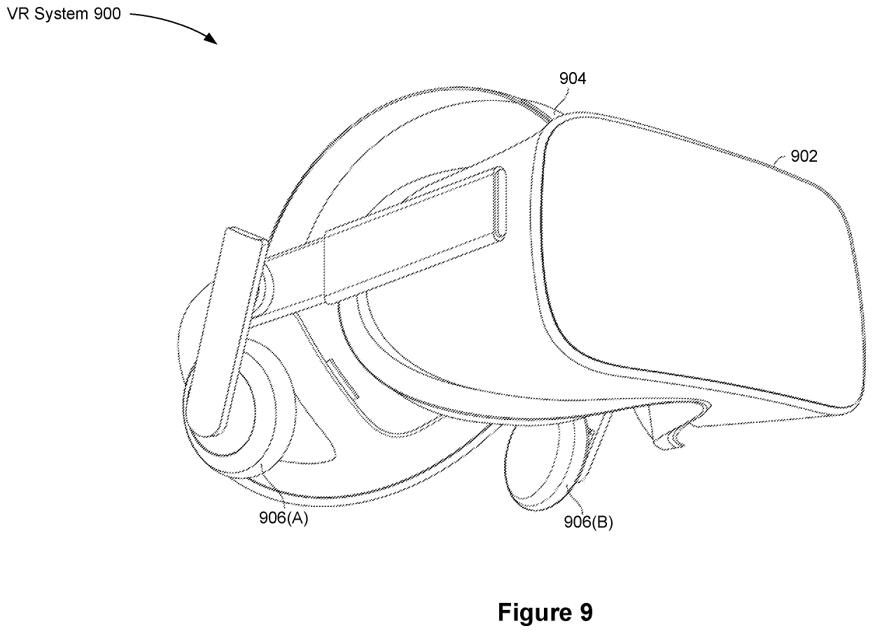

Artificial-reality systems may be implemented in a variety of different form factors and configurations. Some artificial-reality systems are designed to work without near-eye displays (NEDs), an example of which is the artificial-reality system 700 in FIG. 7. Other artificial-reality systems include an NED, which provides visibility into the real world (e.g., the augmented-reality (AR) system 800 in FIG. 8) or that visually immerses a user in an artificial reality (e.g., the virtual-reality (VR) system 900 in FIG. 9). While some artificial-reality devices are self-contained systems, other artificial-reality devices communicate and/or coordinate with external devices to provide an artificial-reality experience to a user. Examples of such external devices include handheld controllers, mobile devices, desktop computers, devices worn by a user (e.g., wearable device 120), devices worn by one or more other users, and/or any other suitable external system.

FIGS. 7-9 provide additional examples of the devices used in a system 100. The artificial-reality system 700 in FIG. 7 generally represents a wearable device dimensioned to fit about a body part (e.g., a head) of a user. The artificial-reality system 700 may include the functionality of a wearable device, and may include functions not described above. As shown, the artificial-reality system 700 includes a frame 702 (e.g., a band or wearable structure) and a camera assembly 704 that is coupled to the frame 702 and configured to gather information about a local environment by observing the local environment (and may include a display that displays a user interface). In some embodiments, the artificial-reality system 700 includes output transducers 708(A) and 708(B) and input transducers 710. The output transducers 708(A) and 708(B) may provide audio feedback, haptic feedback, and/or content to a user, and the input audio transducers may capture audio (or other signals/waves) in a user's environment.

Thus, the artificial-reality system 700 does not include a near-eye display (NED) positioned in front of a user's eyes. Artificial-reality systems without NEDs may take a variety of forms, such as head bands, hats, hair bands, belts, watches, wrist bands, ankle bands, rings, neckbands, necklaces, chest bands, eyewear frames, and/or any other suitable type or form of apparatus. While the artificial-reality system 700 may not include an NED, the artificial-reality system 700 may include other types of screens or visual feedback devices (e.g., a display screen integrated into a side of the frame 702).

The embodiments discussed in this disclosure may also be implemented in artificial-reality systems that include one or more NEDs. For example, as shown in FIG. 8, the AR system 800 may include an eyewear device 802 with a frame 810 configured to hold a left display device 815(B) and a right display device 815(A) in front of a user's eyes. The display devices 815(A) and 815(B) may act together or independently to present an image or series of images to a user. While the AR system 800 includes two displays, embodiments of this disclosure may be implemented in AR systems with a single NED or more than two NEDs.

In some embodiments, the AR system 800 includes one or more sensors, such as the sensors 840 and 850 (examples of sensors 114, FIG. 1). The sensors 840 and 850 may generate measurement signals in response to motion of the AR system 800 and may be located on substantially any portion of the frame 810. Each sensor may be a position sensor, an inertial measurement unit (IMU), a depth camera assembly, or any combination thereof. The AR system 800 may or may not include sensors or may include more than one sensor. In embodiments in which the sensors include an IMU, the IMU may generate calibration data based on measurement signals from the sensors. Examples of the sensors include, without limitation, accelerometers, gyroscopes, magnetometers, other suitable types of sensors that detect motion, sensors used for error correction of the IMU, or some combination thereof. Sensors are also discussed above with reference to FIG. 1.

The AR system 800 may also include a microphone array with a plurality of acoustic sensors 820(A)-820(J), referred to collectively as the acoustic sensors 820. The acoustic sensors 820 may be transducers that detect air pressure variations induced by sound waves. Each acoustic sensor 820 may be configured to detect sound and convert the detected sound into an electronic format (e.g., an analog or digital format). The microphone array in FIG. 8 may include, for example, ten acoustic sensors: 820(A) and 820(B), which may be designed to be placed inside a corresponding ear of the user, acoustic sensors 820(C), 820(D), 820(E), 820(F), 820(G), and 820(H), which may be positioned at various locations on the frame 810, and/or acoustic sensors 820(I) and 820(J), which may be positioned on a corresponding neckband 805. In some embodiments, the neckband 805 is an example of a computer system 130.

The configuration of the acoustic sensors 820 of the microphone array may vary. While the AR system 800 is shown in FIG. 8 having ten acoustic sensors 820, the number of acoustic sensors 820 may be greater or less than ten. In some embodiments, using more acoustic sensors 820 may increase the amount of audio information collected and/or the sensitivity and accuracy of the audio information. In contrast, using a lower number of acoustic sensors 820 may decrease the computing power required by a controller 825 to process the collected audio information. In addition, the position of each acoustic sensor 820 of the microphone array may vary. For example, the position of an acoustic sensor 820 may include a defined position on the user, a defined coordinate on the frame 810, an orientation associated with each acoustic sensor, or some combination thereof.

The acoustic sensors 820(A) and 820(B) may be positioned on different parts of the user's ear, such as behind the pinna or within the auricle or fossa. In some embodiments, there are additional acoustic sensors on or surrounding the ear in addition to acoustic sensors 820 inside the ear canal. Having an acoustic sensor positioned next to an ear canal of a user may enable the microphone array to collect information on how sounds arrive at the ear canal. By positioning at least two of the acoustic sensors 820 on either side of a user's head (e.g., as binaural microphones), the AR device 800 may simulate binaural hearing and capture a 3D stereo sound field around a user's head. In some embodiments, the acoustic sensors 820(A) and 820(B) may be connected to the AR system 800 via a wired connection, and in other embodiments, the acoustic sensors 820(A) and 820(B) may be connected to the AR system 800 via a wireless connection (e.g., a Bluetooth connection). In still other embodiments, the acoustic sensors 820(A) and 820(B) may not be used at all in conjunction with the AR system 800.

The acoustic sensors 820 on the frame 810 may be positioned along the length of the temples, across the bridge, above or below the display devices 815(A) and 815(B), or some combination thereof. The acoustic sensors 820 may be oriented such that the microphone array is able to detect sounds in a wide range of directions surrounding the user wearing AR system 800. In some embodiments, an optimization process may be performed during manufacturing of the AR system 800 to determine relative positioning of each acoustic sensor 820 in the microphone array.

The AR system 800 may further include or be connected to an external device (e.g., a paired device), such as a neckband 805. As shown, the neckband 805 may be coupled to the eyewear device 802 via one or more connectors 830. The connectors 830 may be wired or wireless connectors and may include electrical and/or non-electrical (e.g., structural) components. In some cases, the eyewear device 802 and the neckband 805 operate independently without any wired or wireless connection between them. While FIG. 8 illustrates the components of the eyewear device 802 and the neckband 805 in example locations on the eyewear device 802 and the neckband 805, the components may be located elsewhere and/or distributed differently on the eyewear device 802 and/or on the neckband 805. In some embodiments, the components of the eyewear device 802 and the neckband 805 may be located on one or more additional peripheral devices paired with the eyewear device 802. the neckband 805, or some combination thereof. Furthermore, the neckband 805 generally represents any type or form of paired device. Thus, the following discussion of neckband 805 may also apply to various other paired devices, such as smart watches, smart phones, wrist bands, other wearable devices, hand-held controllers, tablet computers, or laptop computers.

Pairing external devices, such as a neckband 805, with AR eyewear devices may enable the eyewear devices to achieve the form factor of a pair of glasses while still providing sufficient battery and computation power for expanded capabilities. Some or all of the battery power, computational resources, and/or additional features of the AR system 800 may be provided by a paired device or shared between a paired device and an eyewear device, thus reducing the weight, heat profile, and form factor of the eyewear device overall while still retaining desired functionality. For example, the neckband 805 may allow components that would otherwise be included on an eyewear device to be included in the neckband 805 because users may tolerate a heavier weight load on their shoulders than they would tolerate on their heads. The neckband 805 may also have a larger surface area over which to diffuse and disperse heat to the ambient environment. Thus, the neckband 805 may allow for greater battery and computation capacity than might otherwise have been possible on a stand-alone eyewear device. Because weight carried in the neckband 805 may be less invasive to a user than weight carried in the eyewear device 802, a user may tolerate wearing a lighter eyewear device and carrying or wearing the paired device for greater lengths of time than the user would tolerate wearing a heavy, stand-alone eyewear device, thereby enabling an artificial-reality environment to be incorporated more fully into a user's day-to-day activities.

The neckband 805 may be communicatively coupled with the eyewear device 802 and/or to other devices (e.g., a wearable device). The other devices may provide certain functions (e.g., tracking, localizing, depth mapping, processing, storage, etc.) to the AR system 800. In the embodiment of FIG. 8, the neckband 805 includes two acoustic sensors 820(1) and 820(J), which are part of the microphone array (or potentially form their own microphone subarray). The neckband 805 includes a controller 825 and a power source 835.

The acoustic sensors 820(I) and 820(J) of the neckband 805 may be configured to detect sound and convert the detected sound into an electronic format (analog or digital). In the embodiment of FIG. 8, the acoustic sensors 820(I) and 820(J) are positioned on the neckband 805, thereby increasing the distance between neckband acoustic sensors 820(I) and 820(J) and the other acoustic sensors 820 positioned on the eyewear device 802. In some cases, increasing the distance between the acoustic sensors 820 of the microphone array improves the accuracy of beamforming performed via the microphone array. For example, if a sound is detected by the acoustic sensors 820(C) and 820(D) and the distance between acoustic sensors 820(C) and 820(D) is greater than, for example, the distance between the acoustic sensors 820(D) and 820(E), the determined source location of the detected sound may be more accurate than if the sound had been detected by the acoustic sensors 820(D) and 820(E).

The controller 825 of the neckband 805 may process information generated by the sensors on the neckband 805 and/or the AR system 800. For example, the controller 825 may process information from the microphone array, which describes sounds detected by the microphone array. For each detected sound, the controller 825 may perform a direction of arrival (DOA) estimation to estimate a direction from which the detected sound arrived at the microphone array. As the microphone array detects sounds, the controller 825 may populate an audio data set with the information. In embodiments in which the AR system 800 includes an IMU, the controller 825 may compute all inertial and spatial calculations from the IMU located on the eyewear device 802. The connector 830 may convey information between the AR system 800 and the neckband 805 and between the AR system 800 and the controller 825. The information may be in the form of optical data, electrical data, wireless data, or any other transmittable data form. Moving the processing of information generated by the AR system 800 to the neckband 805 may reduce weight and heat in the eyewear device 802, making it more comfortable to a user.

The power source 835 in the neckband 805 may provide power to the eyewear device 802 and/or to the neckband 805. The power source 835 may include, without limitation, lithium-ion batteries, lithium-polymer batteries, primary lithium batteries, alkaline batteries, or any other form of power storage. In some cases, the power source 835 may be a wired power source. Including the power source 835 on the neckband 805 instead of on the eyewear device 802 may help better distribute the weight and heat generated by the power source 835.

As noted, some artificial-reality systems may, instead of blending an artificial-reality with actual reality, substantially replace one or more of a user's sensory perceptions of the real world with a virtual experience. One example of this type of system is a head-worn display system, such as the VR system 900 in FIG. 9, which mostly or completely covers a user's field of view. The VR system 900 may include a front rigid body 902 and a band 904 shaped to fit around a user's head. In some embodiments, the VR system 900 includes output audio transducers 906(A) and 906(B), as shown in FIG. 9. Furthermore, while not shown in FIG. 9, the front rigid body 902 may include one or more electronic elements, including one or more electronic displays, one or more IMUs, one or more tracking emitters or detectors, and/or any other suitable device or system for creating an artificial-reality experience.

Artificial-reality systems may include a variety of types of visual feedback mechanisms. For example, display devices in the AR system 800 and/or the VR system 900 may include one or more liquid-crystal displays (LCDs), light emitting diode (LED) displays, organic LED (OLED) displays, and/or any other suitable type of display screen. Artificial-reality systems may include a single display screen for both eyes or may provide a display screen for each eye, which may allow for additional flexibility for varifocal adjustments or for correcting a user's refractive error. Some artificial-reality systems also include optical subsystems having one or more lenses (e.g., conventional concave or convex lenses, Fresnel lenses, or adjustable liquid lenses) through which a user may view a display screen. These systems and mechanisms are discussed in further detail above with reference to FIG. 1.

In addition to or instead of using display screens, some artificial-reality systems include one or more projection systems. For example, display devices in the AR system 800 and/or the VR system 900 may include micro-LED projectors that project light (e.g., using a waveguide) into display devices, such as clear combiner lenses that allow ambient light to pass through. The display devices may refract the projected light toward a user's pupil and may enable a user to simultaneously view both artificial-reality content and the real world. Artificial-reality systems may also be configured with any other suitable type or form of image projection system.

Artificial-reality systems ma also include various types of computer vision components and subsystems. For example, the system 700, the AR system 800, and/or the VR system 900 may include one or more optical sensors such as two-dimensional (2D) or three-dimensional (3D) cameras, time-of-flight depth sensors, single-beam or sweeping laser rangefinders, 3D LiDAR sensors, and/or any other suitable type or form of optical sensor. An artificial-reality system may process data from one or more of these sensors to identify a location of a user, to map the real world, to provide a user with context about real-world surroundings, and/or to perform a variety of other functions.

Artificial-reality systems may also include one or more input and/or output audio transducers. In the examples shown in FIGS. 7 and 9, the output audio transducers 708(A), 708(B), 906(A), and 906(B) may include voice coil speakers, ribbon speakers, electrostatic speakers, piezoelectric speakers, bone conduction transducers, cartilage conduction transducers, and/or any other suitable type or form of audio transducer. Similarly, the input audio transducers may include condenser microphones, dynamic microphones, ribbon microphones, and/or any other type or form of input transducer. In some embodiments, a single transducer may be used for both audio input and audio output.

The artificial-reality systems shown in FIGS. 7-9 may include tactile (i.e., haptic) feedback systems, which may be incorporated into headwear, gloves, body suits, handheld controllers, environmental devices (e.g., chairs or floormats), and/or any other type of device or system, such as the wearable devices 120 discussed herein. Additionally, in some embodiments, the haptic feedback systems may be incorporated with the artificial-reality systems (e.g., systems 700, 800, and 900 may include the wearable device 120 shown in FIG. 1). Haptic feedback systems may provide various types of cutaneous feedback, including vibration, force, traction, shear, texture, and/or temperature. Haptic feedback systems may also provide various types of kinesthetic feedback, such as motion and compliance. Haptic feedback may be implemented using motors, piezoelectric actuators, fluidic systems, and/or a variety of other types of feedback mechanisms. Haptic feedback systems may be implemented independently of other artificial-reality devices, within other artificial-reality devices, and/or in conjunction with other artificial-reality devices.

In accordance with some implementations, an apparatus (e.g., haptic assembly 122, 123) for creating haptic stimulations is provided. The apparatus includes an inflatable bladder (e.g., bladder 206) and a support structure (e.g., support structure 204, 404) that is attached to the inflatable bladder. The inflatable bladder is fluidically coupled (e.g., pneumatically, electrically, hydraulically, etc.) to a pressure-changing device (e.g., pressure-changing device 210) (e.g., a pneumatic device, a hydraulic device, etc.) that is configured to control a fluid pressure (e.g., pressurized state) of the inflatable bladder. The support structure includes a predefined pattern of cuts (e.g., predefined pattern of cuts 310, 410), and is configured to deform (e.g., elastically deform, expand, or lengthen) in one or more directions (e.g., in-plane, out-of-plane, longitudinally, laterally, and/or radially) according to a design of the predefined pattern of cuts and in relation with (e.g., based on, proportional with) a fluid pressure inside the inflatable bladder. When the inflatable bladder receives fluid (e.g., a fluid medium such as a gas or liquid) from the source, the inflatable bladder expands, which causes the support structure to expand in the one or more directions and also to reinforce the inflatable bladder in the one or more directions.

By changing the fluid pressure in the one or more bladders, the one or more bladders will expand in the one or more directions and the haptic assembly will exert a force on the wearer (e.g., against a user's limb or fingers), generating different haptic stimulations for the wearer. Details are described above with respect to FIGS. 3A-3B.

In some embodiments, as the support structure expands or otherwise deforms, it strains and exerts a force against the portion of the inflatable bladder, thereby constricting expansion of the inflatable bladder in the one or more directions. In some embodiments, the support structure is strain hardened when expanded in the one or more directions. In some embodiments, the support structure is elastic (or semi-elastic). In some embodiments, the inflatable bladder is configured to receive fluid from the pressure-changing device.

In some embodiments, the support structure is configured to have a variable shape according to a design of the predefined pattern of cuts (e.g., predefined pattern of cuts 310, 410) and in relation with (e.g., based on) the fluid pressure inside the inflatable bladder. The support structure is configured to impart an amount of force that is related to the fluid pressure inside the inflatable bladder.

In some embodiments, the support structure is configured to be planar (e.g., two-dimensional, flat) when the fluid pressure inside the inflatable bladder is below a threshold pressure and to form a three-dimensional shape when the fluid pressure inside the inflatable bladder is at or above the threshold pressure. Examples illustrating support structures having a planar shape and transitioning to a three-dimensional shape are shown and described with respect to FIGS. 3A-3D.

In some embodiments, the one or more directions include at least one out-of-plane direction, illustrated and described above with respect to FIGS. 3A-4D.

In some embodiments, the support structure is configured to (i) have a first strain (e.g., be in a contracted state) in the one or more directions when the inflatable bladder has a first fluid pressure, and (ii) have a second strain (e.g., be in an expanded state) in the one or more directions when the inflatable bladder has a second fluid pressure that is greater than the first fluid pressure. The second strain is greater than the first strain. In some embodiments, the second fluid pressure is at or above the threshold pressure. In some embodiments, the first fluid pressure is below the threshold pressure.

In light of the above, the strain created by the support structures can cause respective bladders to take different shapes. For example, the strain created by a support structure 204 can restrict how much a respective bladder 206 can expand in any of the x, y, or z directions.

As such, in some embodiments, a first haptic assembly 122 or 123 of the one or more haptic assemblies is configured to provide a first haptic stimulation to the wearer of the wearable device 120 when the bladder 206 of the first haptic assembly is in the second pressurized state, the first haptic stimulation impeding movement of the respective portion of the wearer's body. Further, a second haptic assembly 122 or 123, distinct from the first haptic assembly, of the one or more haptic assemblies is configured to provide a second haptic stimulation to the wearer of the wearable device when the bladder 206 of the second haptic assembly is in the second pressurized state, the second haptic stimulation forcing movement of the respective portion of the wearer's body in a direction.

To provide some additional context, each of the haptic assemblies 122 or 123 may be adjacent to a respective portion of the wearer body, and in such instances, the bladder 206 of each haptic assembly does not impede free movement of the respective portion of the wearer's body when the bladder is in the first pressurized state. Put another way, the bladder of each haptic assembly can conform to a posture of the respective portion of the wearer's body when the bladder is in the first pressurized state. In contrast, the bladder of each haptic assembly transitions to a predetermined three-dimensional shape (e.g., a nonplanar shape) when the bladder is in the second pressurized state (i.e., the bladder is pressurized).

In some embodiments, the support structure is further configured to impart an amount of force onto the inflatable bladder, whereby the amount of force is related (e.g., linearly proportional, exponentially proportional, or some other relationship) to the fluid pressure inside the inflatable bladder. In some embodiments, the amount of force is directly proportional to the fluid pressure inside the inflatable bladder. FIGS. 3A-3B and 4A-4B illustrate the different ways in which a respective support structure may reinforce a respective bladder in various pressurized states (e.g., above and below a threshold pressure).

In some embodiments, the predefined pattern of cuts of the support structure imparts anisotropic properties onto the support structure. In some embodiments, the predefined pattern of cuts makes the support structure more elastic (e.g., more stretchable/expandable) in one or more directions relative to one or more other directions and/or increases the tensile strength of the support structure in one or more directions relative to one or more other directions. FIGS. 3C-3D and 4C-4D show how the three-dimensional shape of a respective support structure is determined, at least in part, by the predefined pattern of cuts.

In some embodiments, the support structure is configured to have a first three-dimensional shape when the inflatable bladder has a first fluid pressure and to have a second three-dimensional shape, distinct from the first three-dimensional shape, when the inflatable bladder has a second fluid pressure that is smaller than the first fluid pressure. Details are provided above with respect to FIGS. 4A-4D, which show support structures that have the same predefined pattern of cuts (e.g., predefined pattern of cuts 410) may have different three-dimensional shapes (e.g., an indented shape as shown by support structure 404-A and a pointed shape as shown by support structure 404-D).

In some embodiments, the support structure is further configured to impart a first amount of force onto the inflatable bladder when the support structure has the first three-dimensional shape and to impart a second amount of force, greater than the first amount of force, onto the inflatable bladder when the support structure has the second three-dimensional shape. Also, in some embodiments, the support structure is further configured to impart directional forces of different magnitudes onto the inflatable bladder when the support structure has the first three-dimensional shape and to impart different directional forces of further different magnitudes onto the inflatable bladder when the support structure has the second three-dimensional shape. In doing so, information about the curvature of the finger can be used to change the shape and internal pressure of the inflatable bladder to render higher or lower forces felt by the user.

Details are provided above with respect to FIG. 4D, which shows that support structures that have different three-dimensional shapes reinforce their respective bladders in different ways. For example, as shown in FIG. 4D, the first portion 405-A of support layer 405 includes support structures having pointed shapes, allowing (or causing) the first portion 405-A of the support layer 405 to bend or curl. In contrast, a second portion 405-B of the support layer 405 includes support structures having indented shapes, providing a rigidity and/or stiffness to the second portion 405-B of the support layer 405 and, thus, resisting a bend or curl of the second portion of 405-B of the support layer 405.

In some embodiments, the support structure undergoes strain hardening in the one or more directions when the pressure-changing device increases the fluid pressure inside the inflatable bladder above the threshold pressure. For example, the support structure may be made from an elastic material (or semi-elastic material), and expansion of the support structure causes the elastic material to strain and store energy. The strain and stored energy in the support structure is at least partially responsible for reinforcing the inflatable bladder in the one or more directions.

In some embodiments, the predefined pattern of cuts includes any of: orthogonal cuts or triangular cuts. Examples of predefined pattern of cuts, such as the predefined pattern of cuts 310 and 410, are shown with respect to FIGS. 3C-3D and 4C-4D.

In some embodiments, cuts of the predefined pattern of cuts are no greater than 5 millimeters in size. In some other embodiments, cuts of the predefined pattern of cuts are no greater than 10 millimeters in size. In some other embodiments, cuts of the predefined pattern of cuts are no greater than 20 millimeters in size. In some other embodiments, cuts of the predefined pattern of cuts are no greater than 50 millimeters in size. Various other size cuts are also possible.

In some embodiments, the support structure includes a material that has a larger tensile strength than a material of the inflatable bladder. The predefined pattern of cuts are defined by the material of the support structure.

In some embodiments, the support structure includes a thin film or a polyester thin film (e.g., biaxially-oriented polyethylene terephthalate (BoPET)) and the predefined pattern of cuts is defined by the thin film.

Properties of the material can influence the haptic stimulation experience by the user. For instance, the material may be stronger, more rigid/stiff, or have stronger tensile strength than a material of a respective bladder and thus, the material of a respective support structure may allow the respective support structure to reinforce the respective bladder.

In some embodiments, the pressure-changing device is in communication with a computing device. The pressure-changing device is configured to change the fluid pressure of the inflatable bladder in response to receiving one or more signals from the computing device. Details regarding operation of the pressure-changing device are described above with respect to FIGS. 1-2 and FIG. 6.

In some embodiments, the computing device is in communication with a head-mounted display that includes an electronic display. The head-mounted display is configured to present content to the wearer, and the one or more signals correspond to content displayed on the electronic display. Details regarding operation of the wearable device 120 in conjunction with a head-mounted display is provided above with respect to FIGS. 6-9.

In accordance with some embodiments, the solution explained above can be implemented on a wearable device that includes a garment configured to be worn on a portion of a wearer's body and a haptic assembly attached to the garment. The haptic assembly includes an inflatable bladder and a support structure that is attached to a portion of the inflatable bladder. The inflatable bladder is fluidically coupled (e.g., pneumatically, electrically, hydraulically, etc.) to a pressure-changing device (e.g., a pneumatic device, a hydraulic device, etc.) that is configured to control a fluid pressure (e.g., pressurized state) of the inflatable bladder. The support structure includes a predefined pattern of cuts and is configured to deform (e.g., elastically deform, expand, or lengthen) in one or more directions according to a design of the predefined pattern of cuts and based on a fluid pressure inside the inflatable bladder. When the inflatable bladder receives the fluid from the source, the inflatable bladder expands, which causes the support structure to deform in the one or more directions and also to reinforce the inflatable bladder in the one or more directions. In some embodiments, as the support structure expands, it strains and exerts a force against the portion of the inflatable bladder, thereby constricting expansion of the inflatable bladder in the one or more directions. In some embodiments, the support structure is strain hardened when expanded in the one or more directions. In some embodiments, the support structure is elastic. In some embodiments, the inflatable bladder is configured to receive a fluid from the pressure-changing device. An example of a wearable device 120 that includes haptic assembly 122 or 124 are shown in FIG. 5 (see haptic assembly regions 522 and the corresponding description).

In accordance with some embodiments, the solution explained above can be implemented by a system that includes a computing device, a pressure-changing device (e.g., pressure-changing device 210) in communication with the computing device (e.g., computing device 130), and a haptic assembly (e.g., haptic assembly 122, 123). The haptic assembly includes an inflatable bladder (e.g., bladder 206) and a support structure (e.g., support structure 204, 404) that is attached to a portion of the inflatable bladder. The inflatable bladder is fluidically coupled (e.g., pneumatically, electrically, hydraulically, etc.) to the pressure-changing device (e.g., a pneumatic device, a hydraulic device, etc.) that is configured to control a fluid pressure (e.g., pressurized state) of the inflatable bladder. The support structure includes a predefined pattern of cuts (e.g., predefined pattern of cuts 310, 410), and is configured to deform (e.g., expand or lengthen) in one or more directions according to a design of the predefined pattern of cuts and in relation with (e.g., based on) a fluid pressure inside the inflatable bladder. When the inflatable bladder receives the fluid from the source, the inflatable bladder expands, which causes the support structure to expand in the one or more directions and also to reinforce the inflatable bladder in the one or more directions. In some embodiments, as the support structure expands, it strains and exerts a force against the portion of the inflatable bladder, thereby constricting expansion of the inflatable bladder in the one or more directions. In some embodiments, the support structure is strain hardened when expanded in the one or more directions. In some embodiments, the support structure is elastic. In some other embodiments, the inflatable bladder is configured to receive a fluid from the pressure-changing device.

In some embodiments, the system further includes a head-mounted display that is in communication with the computing device. The computing device is configured to generate an instruction that corresponds to visual data to be displayed by the head-mounted display, send the instruction to the pressure-changing device, and send the visual data to the head-mounted display. The instruction, when received by the pressure-changing device, causes the pressure-changing device to change the fluid pressure inside the inflatable bladder. Examples are provided above with respect to FIGS. 7-9.

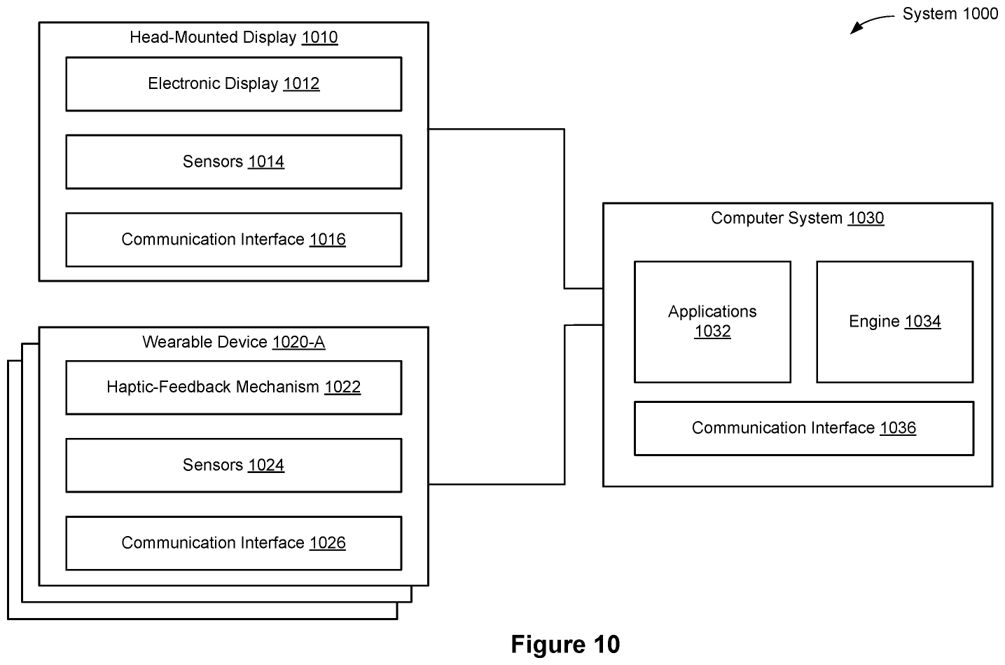

FIG. 10 is a block diagram illustrating an artificial-reality system 1000 in accordance with various embodiments. While some example features are illustrated, various other features have not been illustrated for the sake of brevity and so as not to obscure pertinent aspects of the example embodiments disclosed herein. To that end, as a non-limiting example, the system 1000 includes one or more wearable devices 1020, which are used in conjunction with a computer system 1030 (sometimes referred to as a “computer device” or a “remote computer device”) and a head-mounted display 1010. In some embodiments, the system 1000 provides the functionality of a virtual-reality device with haptic feedback, an augmented-reality device with haptic feedback, a mixed-reality device with haptic feedback, or a combination thereof.

The head-mounted display 1010 presents media to a user. Examples of media presented by the head-mounted display 1010 include images, video, audio, or some combination thereof. In some embodiments, audio is presented via an external device (e.g., speakers and/or headphones), which receives audio information from the head-mounted display 1010, the computer system 1030, or both, and presents audio data based on the audio information.

The head-mounted display 1010 includes an electronic display 1012, sensors 1014 (optional), and a communication interface 1016. The electronic display 1012 displays images to the user in accordance with data received from the computer system 1030. In various embodiments, the electronic display 1012 comprises a single electronic display 1012 or multiple electronic displays 1012 (e.g., one display for each eye of a user).

The sensors 1014 include one or more hardware devices that detect spatial and motion information about the head-mounted display 1010. Spatial and motion information can include information about the position, orientation, velocity, rotation, and acceleration of the head-mounted display 1010. For example, the sensors 1014 may include one or more inertial measurement units (IMUs) that detect rotation of the user's head while the user is wearing the head-mounted display 1010. This rotation information can then be used (e.g., by the engine 1034) to adjust the images displayed on the electronic display 1012. In some embodiments, each IMU includes one or more gyroscopes, accelerometers, and/or magnetometers to collect the spatial and motion information. In some embodiments, the sensors 1014 include one or more cameras positioned on the head-mounted display 1010.

The communication interface 1016 enables input and output to the computer system 1030. In some embodiments, the communication interface 1016 is a single communication channel, such as HDMI, USB, VGA, DVI, or DisplayPort. In other embodiments, the communication interface 1016 includes several distinct communication channels operating together or independently. In some embodiments, the communication interface 1016 includes hardware capable of data communications using any of a variety of custom or standard wireless protocols (e.g., IEEE 101602.15.4. Wi-Fi, ZigBee, 6LoWPAN, Thread, Z-Wave, Bluetooth Smart, ISA100.11a, WirelessHART, or MiWi) and/or any other suitable communication protocol. The wireless and/or wired connections may be used for sending data collected by the sensors 1014 from the head-mounted display to the computer system 1030. In such embodiments, the communication interface 1016 may also receive audio/visual data to be rendered on the electronic display 1012.

The wearable device 1020 includes a wearable structure worn by the user (e.g., a glove, a shirt, wristband, pants, etc.). In some embodiments, the wearable device 1020 collects information about a portion of the user's body (e.g., the user's hand) that can be used as input for artificial-reality applications 1032 executing on the computer system 1030. In the illustrated embodiment, the wearable device 1020 includes a haptic-feedback mechanism 1022 (sometimes referred to herein as a “haptic assembly 1022” and a “haptic device 1022”), sensors 1024 (optional), and a communication interface 1026. The wearable device 1020 may include additional components that are not shown in FIG. 10, such as a power source (e.g., an integrated battery, a connection to an external power source, a container containing compressed air, or some combination thereof), one or more processors, memory, a display, microphones, and speakers.

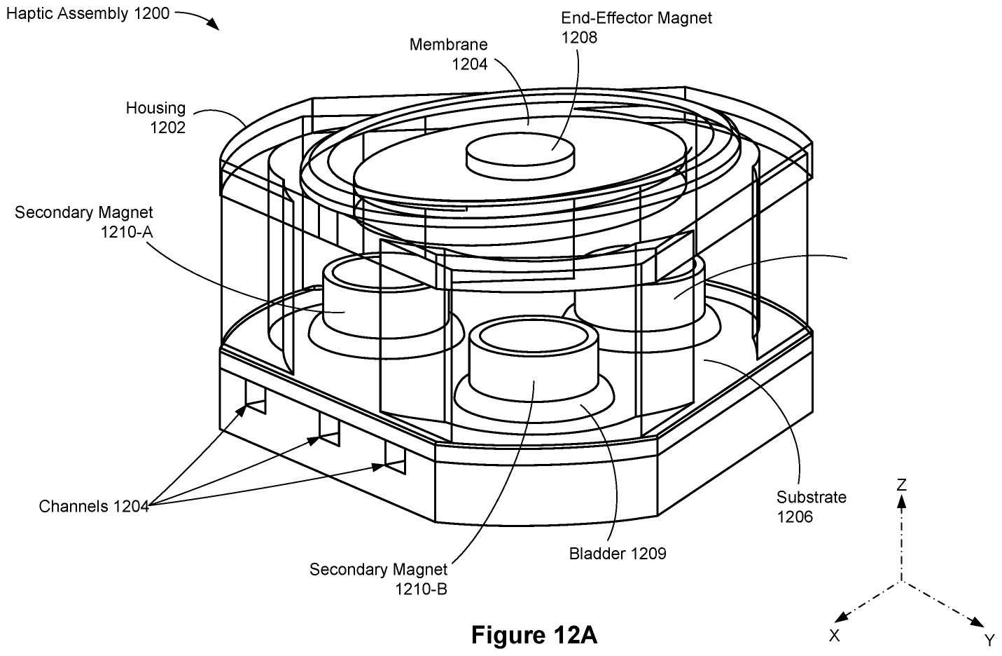

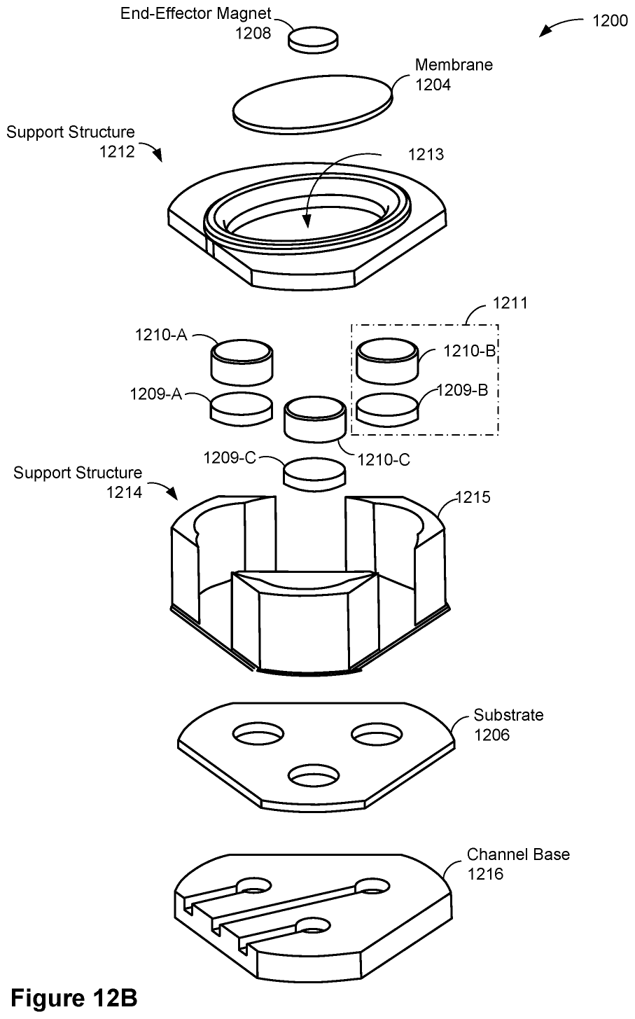

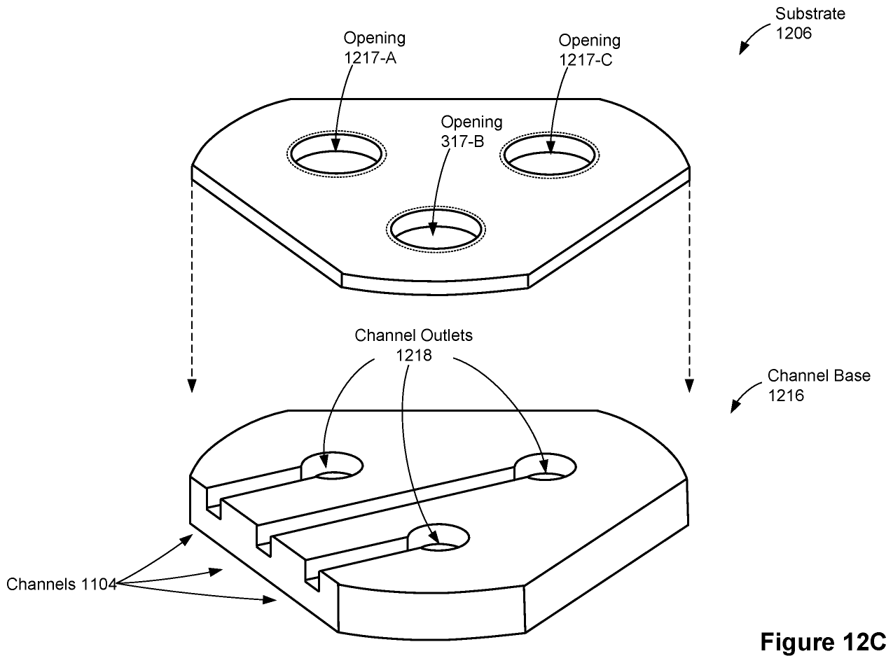

The haptic-feedback mechanism 1022 provides haptic feedback (i.e., haptic stimulations) to a portion of the user's body (e.g., hand, wrist, arm, leg, etc.). The haptic feedback may be a vibration stimulation, a pressure stimulation, a shear stimulation, or some combination thereof. To accomplish this, the haptic-feedback mechanism 1022 includes strategically positioned magnets (e.g., end-effector magnet 1208 and secondary magnets 1210) that are configured to apply a force to the portion of the user's body (e.g., in response to a fluid source moving one or more of the magnets). Various embodiments of the haptic-feedback mechanism 1022 are described with reference to FIGS. 12A through 15.

In some embodiments, the sensors 1024 include one or more hardware devices that detect spatial and motion information about the wearable device 1020. Spatial and motion information can include information about the position, orientation, velocity, rotation, and acceleration of the wearable device 1020 or any subdivisions of the wearable device 1020, such as fingers, fingertips, knuckles, the palm, or the wrist when the wearable device 1020 is worn near the user's hand. The sensors 1024 may be IMUs, as discussed above with reference to the sensors 1014. The sensors 1024 may include one or more hardware devices that monitor a pressurized state of a respective channel 1104 of the haptic-feedback mechanism 1022.

The communication interface 1026 enables input and output to the computer system 1030. In some embodiments, the communication interface 1026 is a single communication channel, such as USB. In other embodiments, the communication interface 1026 includes several distinct communication channels operating together or independently. For example, the communication interface 1026 may include separate communication channels for receiving control signals for the haptic-feedback mechanism 1022 and sending data from the sensors 1024 to the computer system 1030. The one or more communication channels of the communication interface 1026 can be implemented as wired or wireless connections. In some embodiments, the communication interface 1026 includes hardware capable of data communications using any of a variety of custom or standard wireless protocols (e.g., IEEE 101602.15.4. Wi-Fi, ZigBee, 6LoWPAN, Thread, Z-Wave, Bluetooth Smart, ISA100.11a, WirelessHART, or MiWi), custom or standard wired protocols (e.g., Ethernet or HomePlug), and/or any other suitable communication protocol, including communication protocols not yet developed as of the filing date of this document.

The computer system 1030 is a computing device that executes artificial-reality applications (e.g., virtual-reality applications, augmented-reality applications, or the like) to process input data from the sensors 1014 on the head-mounted display 1010 and the sensors 1024 on the wearable device 1020. The computer system 1030 provides output data for (i) the electronic display 1012 on the head-mounted display 1010 and (ii) the haptic-feedback mechanism 1022 on the wearable device 1020. In some embodiments, the computer system 1030 is integrated with the head-mounted display 1010 or the wearable device 1020.

The computer system includes a communication interface 1036 that enables input and output to other devices in the system 1000. The communication interface 1036 is similar to the communication interface 1016 and the communication interface 1026.

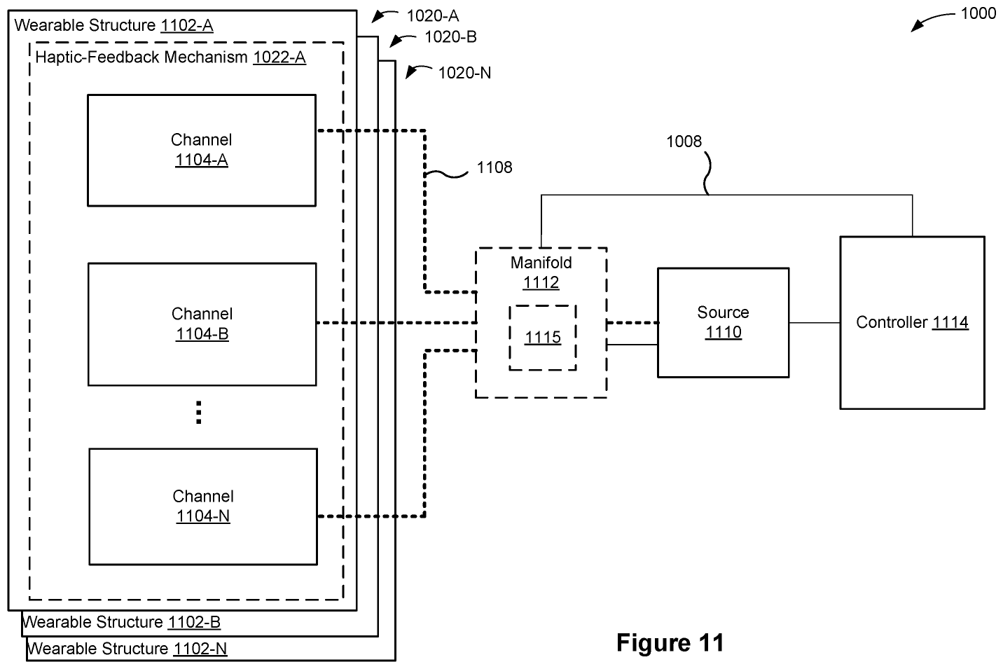

In some embodiments, the computer system 1030 sends instructions (e.g., the output data) to the wearable device 1020. In response to receiving the instructions, the wearable device 1020 creates one or more haptic stimulations. Alternatively, in some embodiments, the computer system 1030 sends instructions to an external device, such as a fluid (pressure) source (e.g., source 1110, FIG. 11), and in response to receiving the instructions, the external device creates one or more haptic stimulations (e.g., the output data bypasses the wearable device 1020). Alternatively, in some embodiments, the computer system 1030 sends instructions to the wearable device 1020, which in turn sends the instructions to the external device. The external device then creates one or more haptic stimulations by adjusting fluid pressure in one or more of channels (e.g., channels 1104, FIG. 11). Although not shown, in the embodiments that include a distinct external device, the external device may be connected to the head-mounted display 1010, the wearable device 1020, and/or the computer system 1030 via a wired or wireless connection. The external device may be a pneumatic device, a hydraulic device, some combination thereof, or any other device capable of adjusting pressure.

The computer system 1030 can be implemented as any kind of computing device, such as an integrated system-on-a-chip, a microcontroller, a desktop or laptop computer, a server computer, a tablet, a smart phone or other mobile device. Thus, the computer system 1030 includes components common to typical computing devices, such as a processor, random access memory, a storage device, a network interface, an IO interface, and the like. The processor may be or include one or more microprocessors or application specific integrated circuits (ASICs). The memory may be or include RAM, ROM, DRAM, SRAM and MRAM, and may include firmware, such as static data or fixed instructions, BIOS, system functions, configuration data, and other routines used during the operation of the computing device and the processor. The memory also provides a storage area for data and instructions associated with applications and data handled by the processor.

The storage device provides non-volatile, bulk, or long term storage of data or instructions in the computing device. The storage device may take the form of a magnetic or solid state disk, tape. CD, DVD, or other reasonably high capacity addressable or serial storage medium. Multiple storage devices may be provided or available to the computing device. Some of these storage devices may be external to the computing device, such as network storage or cloud-based storage. The network interface includes an interface to a network and can be implemented as either wired or wireless interface. The I/O interface interfaces the processor to peripherals (not shown) such as, for example and depending upon the computing device, sensors, displays, cameras, color sensors, microphones, keyboards, and USB devices.

In the example shown in FIG. 10, the computer system 1030 further includes artificial-reality applications 1032 and an artificial-reality engine 1034. In some embodiments, the artificial-reality applications 1032 and the artificial-reality engine 1034 are implemented as software modules that are stored on the storage device and executed by the processor. Some embodiments of the computer system 1030 include additional or different components than those described in conjunction with FIG. 10. Similarly, the functions further described below may be distributed among components of the computer system 1030 in a different manner than is described here.

Each artificial-reality application 1032 is a group of instructions that, when executed by a processor, generates artificial-reality content for presentation to the user. An artificial-reality application 1032 may generate artificial-reality content in response to inputs received from the user via movement of the head-mounted display 1010 or the wearable device 1020. Examples of artificial-reality applications 1032 include gaming applications, conferencing applications, and video playback applications.

The artificial-reality engine 1034 is a software module that allows artificial-reality applications 1032 to operate in conjunction with the head-mounted display 1010 and the wearable device 1020. In some embodiments, the artificial-reality engine 1034 receives information from the sensors 1014 on the head-mounted display 1010 and provides the information to an artificial-reality application 1032. Based on the received information, the artificial-reality engine 1034 determines media content to provide to the head-mounted display 1010 for presentation to the user via the electronic display 1012 and/or a type of haptic feedback to be created by the haptic-feedback mechanism 1022 of the wearable device 1020. For example, if the artificial-reality engine 1034 receives information from the sensors 1014 on the head-mounted display 1010 indicating that the user has looked to the left, the artificial-reality engine 1034 generates content for the head-mounted display 1010 that mirrors the user's movement in a virtual environment.

Similarly, in some embodiments, the artificial-reality engine 1034 receives information from the sensors 1024 on the wearable device 1020 and provides the information to an artificial-reality application 1032. The application 1032 can use the information to perform an action within the artificial world of the application 1032. For example, if the artificial-reality engine 1034 receives information from the sensors 1024 that the user has closed his fingers around a position corresponding to a coffee mug in the artificial environment and raised his hand, a simulated hand in the artificial-reality application 1032 picks up the artificial coffee mug and lifts it to a corresponding height. As noted above, the information received by the artificial-reality engine 1034 can also include information from the head-mounted display 1010. For example, cameras on the head-mounted display 1010 (or elsewhere) may capture movements of the wearable device 1020, and the application 1032 can use this additional information to perform the action within the artificial world of the application 1032.

In some embodiments, the artificial-reality engine 1034 provides feedback to the user that the action was performed. The provided feedback may be visual via the electronic display 1012 in the head-mounted display 1010 (e.g., displaying the simulated hand as it picks up and lifts the virtual coffee mug) and/or haptic feedback via the haptic-feedback mechanism 1022 in the wearable device 1020. For example, the haptic feedback may vibrate in a certain way to simulate the sensation of firing a firearm in an artificial-reality video game. To do this, the wearable device 1020 and/or the computer system 1030 changes (either directly or indirectly) fluid pressure of one or more channels of the haptic-feedback mechanism 1022. When the one or more channels are pressurized at or above some threshold pressure (and/or pressurized at a threshold frequency, such as at least 5 Hz), the haptic-feedback mechanism 1022 presses against the user's body, resulting in the haptic feedback.

In another example, the haptic-feedback mechanism 1022 may simulate the sensation a user's finger (or fingers) touching and otherwise interacting with a solid object, such as a glass of water. Specifically, the haptic-feedback mechanism 1022 is capable of creating forces on finger phalanges, as one example, in directions that are very similar to the forces induced by physical objects during natural hand-object interaction (i.e., simulate the forces that would actually be felt by a user when he or she touches, lifts, and empties a full glass of water in the real world). To do this, the wearable device 1020 and/or the computer system 1030 changes (either directly or indirectly) a pressurized state inside one or more channels 1104 of the haptic-feedback mechanism 1022. In particular, one or more first channels are pressurized during a first stage of the interaction (e.g., grasping the glass of water) to render contact normal forces proportional to a grasping force, while one or more second channels are pressurized during a second stage of the interaction (e.g., lifting the glass of water) to render shear forces proportional to the weight and inertia of the glass. Finally, one or more third channels are pressurized during a third stage of the interaction (e.g., pouring the water from the glass) to render shear forces proportional to the weight of the glass being emptied. Importantly, with the last step, the shear forces are changed dynamically based on the rate at which the glass is being emptied.

In view of the examples above, the wearable device 1020 is used to further immerse the user in an artificial-reality experience such that the user not only sees (at least in some instances) the data on the head-mounted display 1010, but the user may also “feel” certain aspects of the displayed data. Moreover, the wearable device 1020 is designed to limit encumbrances imposed onto the user, at least when encumbrances are not desired.

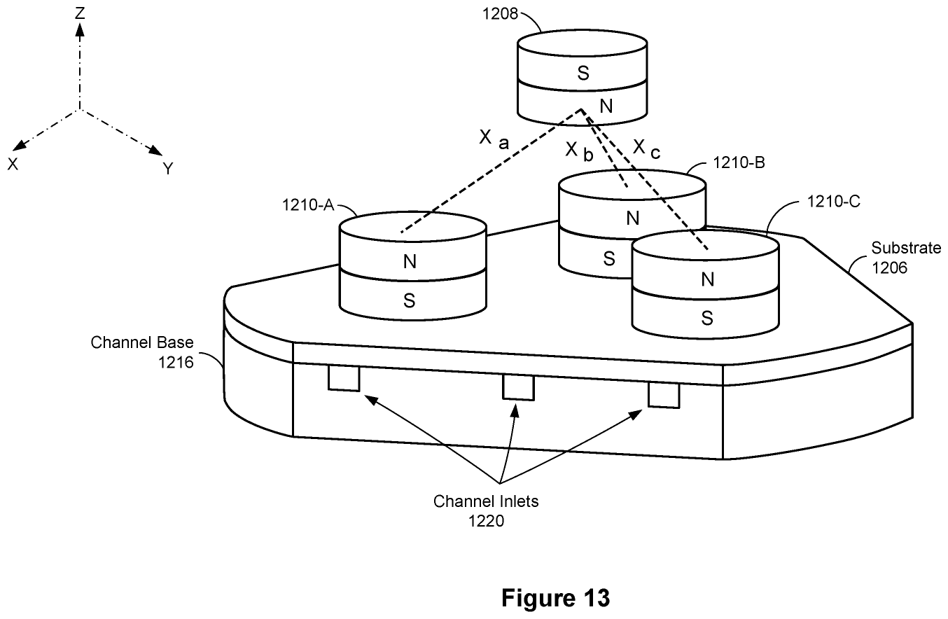

FIG. 11 is a schematic of the system 1000 in accordance with some embodiments. The components in FIG. 11 are illustrated in a particular arrangement for ease of illustration and one skilled in the art will appreciate that other arrangements are possible. Moreover, while some example features are illustrated, various other features have not been illustrated for the sake of brevity and so as not to obscure pertinent aspects of the example implementations disclosed herein. For example, several components of the haptic-feedback mechanism 1022 are not shown in FIG. 11. These components of the haptic-feedback mechanism 1022 are discussed below with reference to FIGS. 12A-12C and FIG. 13.

As a non-limiting example, the system 1000 includes a plurality of wearable devices 1020-A, 1020-B, . . . 1020-M, each of which includes a wearable structure 1102 and a haptic-feedback mechanism 1022. Each haptic-feedback mechanism 1022 includes one or more channels 1104, as explained above, that are configured to receive a fluid from a source 1110. The wearable structure 1102 of each wearable device 1020 can be various articles of clothing (e.g., gloves, socks, shirts, or pants) or other wearable structure (e.g., watch band), and, thus, the user may wear multiple wearable devices 1020 that provide haptic stimulations to different parts of the body.

Each haptic-feedback mechanism 1022 is integrated with (e.g., embedded in or coupled to) the wearable structure 1102. Fluid as used herein can be various media, including air, an inert gas, or a liquid. In some embodiments, each haptic-feedback mechanism 1022 delivers (e.g., imparts, applies) a haptic stimulation to the user wearing the wearable structure 1102 when a fluid pressure within one or more channels 1104 is changed (e.g., increased to a threshold pressure or decreased from some baseline pressure). In some embodiments, each haptic-feedback mechanism 1022 can also deliver a haptic stimulation to the user wearing the wearable structure 1102 when pressure inside one or more of the channels 1104 is oscillated at a threshold frequency (e.g., greater than approximately 5 Hz).

The system 1000 also includes a controller 1114 and a fluid source 1110 (e.g., a pneumatic device). In some embodiments, the controller 1114 is part of the computer system 1030 (e.g., the processor of the computer system 1030). Alternatively, in some embodiments, the controller 1114 is part of the wearable device 1020. The controller 1114 is configured to control operation of the source 1110, and in turn the operation (at least partially) of the wearable devices 1020. For example, the controller 1114 sends one or more signals to the source 1110 to activate the source 1110 (e.g., turn it on and off). The one or more signals may specify a desired pressure (e.g., pounds-per-square inch) to be output by the source 1110. Additionally, the one or more signals may specify a desired frequency or rate for outputting the desired pressure (e.g., 0.5 Hz to 50 Hz). The one or more signals may further specify one or more of (i) one or more target channels 1104 to be inflated and (ii) a pattern of inflation for the one or more target channels 1104.

Generation of the one or more signals, and in turn the pressure output by the source 1110, may be based on information collected by the HMD sensors 1014 and/or the wearable device sensors 1024. For example, the one or more signals may cause the source 1110 to increase the pressure inside one or more channels 1104 of a first wearable device 1020 at a first time, based on the information collected by the sensors 1014 and/or the sensors 1024 (e.g., the user gestures to make contact with the virtual coffee mug). Then, the controller 1114 may send one or more additional signals to the source 1110 that cause the source 1110 to further increase the pressure inside the one or more channels 1104 of the first wearable device 1020 at a second time after the first time, based on additional information collected by the sensors 1014 and/or the sensors 1024 (e.g., the user grasps and lifts the virtual coffee mug). Further, the one or more signals may cause the source 1110 to increase (or otherwise change) the pressure inside one or more channels 1104 in a first wearable device 1020-A, while a pressure inside one or more channels 1104 in a second wearable device 1020-B remains unchanged (or is modified to some other pressure). Additionally, the one or more signals may cause the source 1110 to increase (or otherwise change) the pressure inside one or more channels 1104 in the first wearable device 1020-A to a first pressure and increase (or otherwise change) the pressure inside one or more other channels 1104 in the first wearable device 1020-A to a second pressure different from the first pressure. Depending on the number of wearable devices 1020 serviced by the source 1110, and the number of channels 1104 therein, many different inflation configurations can be achieved through the one or more signals and the examples above are not meant to be limiting.

In some embodiments, the system 1000 includes a manifold 1112 between the source 1110 and the wearable devices 1020. In some embodiments, the manifold 1112 includes one or more valves (not shown) that fluidically (e.g., pneumatically) couple each of the haptic-feedback mechanisms 1022 with the source 1110 via tubing 1108 (also referred to herein as “conduits”). In some embodiments, the tubing is ethylene propylene diene monomer (EPDM) rubber tubing with 1/32″ inner diameter (various other tubing can also be used). In some embodiments, the manifold 1112 is in communication with the controller 1114, and the controller 1114 controls the one or more valves of the manifold 1112 (e.g., the controller generates one or more control signals). The manifold 1112 is configured to switchably couple the source 1110 with the channels 1104 of the same or different wearable devices 1020 based on one or more control signals from the controller 1114. In some embodiments, instead of the manifold 1112 being used to fluidically couple the source 1110 with the haptic-feedback mechanisms 1022, the system 1000 includes multiple sources 1110, where each is fluidically coupled directly with a single (or multiple) channel(s) 1104. In some embodiments, the source 1110 and the optional manifold 1112 are configured as part of one or more of the wearable devices 1020 (not illustrated) while, in other embodiments, the source 1110 and the optional manifold 1112 are configured as external to the wearable device 1020. A single source 1110 may be shared by multiple wearable devices 1020.

In some embodiments, the manifold 1112 includes one or more back-flow valves 1115 that are configured to selectively open and close to regulate fluid flow between the manifold 1112 from the channels 1104. When closed, the one or more back-flow valves 1115 stop fluid flowing out of the channels 1104 and back to the manifold 1112. In some other embodiments, the one or more back-flow valves 1115 are distinct components separate from the manifold 1112.

In some embodiments, the source 1110 is a pneumatic device, hydraulic device, a pneudraulic device, or some other device capable of adding and removing a medium from the one or more channels 1104. In other words, the discussion herein is not limited to pneumatic devices, but for ease of discussion, pneumatic devices are used as the primary example in the discussion below.

The devices shown in FIG. 11 may be coupled via a wired connection (e.g., via busing 108). Alternatively, one or more of the devices shown in FIG. 11 may be wirelessly connected (e.g., via short-range communication signals).

FIGS. 12A to 12C show various views of a representative haptic assembly 1200 in accordance with some embodiments. The representative haptic assembly 1200 is an example of the haptic-feedback mechanism 1022 of FIGS. 10 and 11. Moreover, while some example features are illustrated, various other features have not been illustrated for the sake of brevity and so as not to obscure pertinent aspects of the example implementations disclosed herein.

FIG. 12A shows an oblique view of the representative haptic assembly 1200. As shown, the representative haptic assembly 1200 includes a housing 1202, a plurality of channels 1104 defined in the housing 1202, a flexible membrane 1204, a substrate 1206, an end-effector magnet 1208, and a plurality of secondary magnets 1210-A, 1210-B, and 1210-C. For ease of illustration, the housing 1202 is shown as being transparent (in practice, the housing may or may not be made from transparent materials). Notably, the housing 1202 is a rigid (or semi-rigid) structure that is configured to support the flexible membrane 1204. Put another way, the housing 1202 is used to suspend the flexible membrane 1204, which allows a central portion of the flexible membrane 1204 to flex and stretch (e.g., oscillate upwards and downwards) according to a magnetic interaction between the end-effector magnet 1208 and the plurality of secondary magnets 1210-A, 1210-B, and 1210-C (discussed below). Additional components of the housing 1202 are discussed below with reference to FIG. 12B. In some embodiments, the components of the housing 1202 are separate components joined together to form the housing 1202. In other embodiments, the housing 1202 is a unitary structure (e.g., the housing 1202 is made during an injection-molding operation). The housing 1202 may be made from a variety of known materials that can be used to create rigid (or semi-rigid) structures, such as plastics, metals, ceramics, and the like.

The flexible membrane 1204 is supported by the housing 1202 and is configured to support the end-effector magnet 1208. The membrane 1204 is flexible so that the end-effector magnet 1208 can move (e.g., translate upwards and downwards, and also pivot/rotate) according to the magnetic interaction between the end-effector magnet 1208 and the plurality of secondary magnets 1210-A, 1210-B, and 1210-C. Moreover, the flexible membrane 1204 can be made from an elastic or semi-elastic material, and, thus, the flexible membrane 1204 is able to return the end-effector magnet 1208 to a default position when the plurality of secondary magnets 1210-A, 1210-B, and 1210-C cease to magnetically influence the end-effector magnet 1208 (i.e., when the plurality of secondary magnets 1210-A, 1210-B, and 1210-C are also returned to their respective default positions). In some embodiments, the flexible membrane 1204 is made from an elastic plastic, such a thermoplastic polyurethane or the like. In some other embodiments, the flexible membrane 1204 is made from an elastic textile or fabric (or a fiber-reinforced material). In view of the above, the flexible membrane 1204 may also be referred to herein as a stretchable membrane 1204 or an elastic membrane 1204.

The end-effector magnet 1208 is coupled to the flexible membrane 1204. When a user dons a wearable device 1020, the flexible membrane 1204 and the end-effector magnet 1208 are positioned adjacent to the user's body. In this configuration, the end-effector magnet 1208 is the component of the haptic assembly 1200 that is configured to impart (i.e., deliver, apply) one or more haptic stimulations to a portion of a user's body (e.g., movement of the end-effector magnet 1208 along the Z-axis (at a minimum) results in a user experiencing some form of haptic feedback). In the illustrated embodiment, the end-effector magnet 1208 is centrally positioned on the flexible membrane 1204. In other embodiments, the end-effector magnet 1208 may be offset from a center of the flexible membrane 1204. The end-effector magnet 1208 may be coupled to the flexible membrane 1204 in a variety of ways. For example, the end-effector magnet 1208 may be chemically and/or mechanically fastened to the flexible membrane 1204. In other words, the end-effector magnet 1208 may be adhered to a surface of the flexible membrane 1204 and/or mechanical fasteners may be used to fix the end-effector magnet 1208 to the surface of the flexible membrane 1204. In another example, the flexible membrane 1204 may be an annulus, whereby a diameter of the annulus's inner opening may be slightly smaller than a diameter of the end-effector magnet 1208. In such a configuration, and because the flexible membrane 1204 is made from an elastic (or semi-elastic) material, the annulus's inner opening fits snuggly around the end-effector magnet 1208, such that the end-effector magnet 1208 is held in place by the flexible membrane 1204. In this example, the end-effector magnet 1208 may also be chemically and/or mechanically fastened to the flexible membrane 1204 to further secure the end-effector magnet 1208 to the flexible membrane 1204.

Each of the plurality of secondary magnets 1210-A, 1210-B, and 1210-C is coupled to the substrate 1206 of the housing 1202. The plurality of secondary magnets 1210-A, 1210-B, and 1210-C are configured to move (e.g., repel) the end-effector magnet through magnetic force. More precisely, each respective secondary magnet 1210 is coupled to the substrate 1206 in a particular position so as to be aligned with a respective channel of the plurality of channels 1104. In this configuration, each respective secondary magnet 1210 is configured to elevate from a default position toward the end-effector magnet 1208 and move the end-effector magnet 1208 through magnetic force, in response to the source increasing the fluid pressure in a respective channel, of the plurality of channels, that is aligned with the respective secondary magnet 1210.

In the illustrated embodiments, the plurality of secondary magnets 1210-A, 1210-B. and 1210-C consists of three magnets. In other embodiments, the plurality of secondary magnets includes more than three magnets (e.g., four, five, or six magnets) or less than three magnets (e.g., one or two magnets). Additionally, in some embodiments, the plurality of secondary magnets are part of a single magnet with different magnetic encodings (e.g., some portions of the single magnet are positively polarized while some other portions are negatively polarized).

In some embodiments, the plurality of secondary magnets 1210-A, 1210-B, and 1210-C are coupled to the substrate 1206 by elastic bladders 1209 (i.e., a first bladder 1209 couples the first secondary magnet 1210-A to the substrate 1206 at a first location, a second bladder 1209 couples the second secondary magnet 1210-B to the substrate 1206 at a second location, and so on). In such embodiments, the elastic bladder 1209 is configured to stretch or otherwise expand in response to the source increasing the fluid pressure in a respective/corresponding channel 1104. Expansion of the bladder 1209 pushes the corresponding secondary magnet 1210 toward the end-effector magnet 1208. Furthermore, the elastic bladders 1209 are used to seal outlets of the plurality of channels 1104, which ensures that the haptic assembly 1200 does not leak fluid, thus creating an efficient assembly. It is noted that the elastic bladders 1209 may be integrally formed with the substrate 1206.

Note that the end-effector magnet 1208 and the plurality of secondary magnets 1210 can be various magnets, including various rare earth magnets, electromagnets, and so on.

FIG. 12B shows an exploded view of the representative haptic assembly 1200. As shown, the representative haptic assembly 1200 also includes a first support structure 1212 and a second support structure 1214, which are both components of the housing 1202. The first support structure 1212 is coupled to arms 1215 of the second support structure 1214 and is used to support the flexible membrane 1204 (e.g., the flexible membrane 1204 is radially supported by an inner opening 1213 of the support structure 1212). The second support structure 1214 supports the substrate 1206 and is used to offset (in this case, vertically) the flexible membrane 1204 from the substrate 1206. FIG. 12B also shows that the representative haptic assembly 1200 includes channel base 1216, which is discussed in detail below with reference to FIG. 12C.

In some instances, a secondary magnet 1210 and its corresponding bladder 1209 together form a pocket/bubble actuator 1211. Stated differently, a pocket actuator 1211 includes a first portion that is a magnet and a second portion that is an inflatable bladder that is used to change a position of the magnet (e.g., in response to the inflatable bladder receiving a fluid from a source).

FIG. 12C shows close-up views of the substrate 1206 and the channel base 1216 of the representative haptic assembly 1200. As shown, the substrate 1206 defines a plurality of openings 1217-A, 1217-B, and 1217-C and the channel base 1216 defines multiple channels 1104, each of which includes a channel outlet 1218. When the substrate 1206 is attached to the channel base 1216, the plurality of openings 1217-A. 1217-B, and 1217-C are concentrically aligned with the channel outlets 1218. In other words, the portions of the channels 1104 left exposed by the substrate 1206 are the channel outlets 1218 (and the channel inlets 1220 of FIG. 13). In this configuration, the plurality of openings 1217-A, 1217-B, and 1217-C are configured to direct a fluid, received by the channels 1104 from the source 1110, to the bladders 1209 that are coupled to the plurality of secondary magnets 1210. In some embodiments, the bladders 1209 are coupled to the substrate 1206, as indicated by the dotted lines on the substrate 1206's surface in FIG. 12C. The bladders 1209 may be coupled to the substrate 1206 in a variety of other ways as well.

FIG. 13 shows another oblique view of the representative haptic assembly 1200 in accordance with some embodiments. For ease of illustration and discussion, several components of the representative haptic assembly 1200 are not shown in FIG. 13, such as the first support structure 1212, the second support structure 1214, and the bladders 1209. As shown, the channel base 1216 is coupled to the substrate 1206, and in this configuration, channel inlets 320 are defined along an edge surface of the channel base 1216. While not shown, the representative haptic assembly 1200 may include conduits 1108, fluidically coupled with the source 1110, positioned within each of the channel inlets 320.

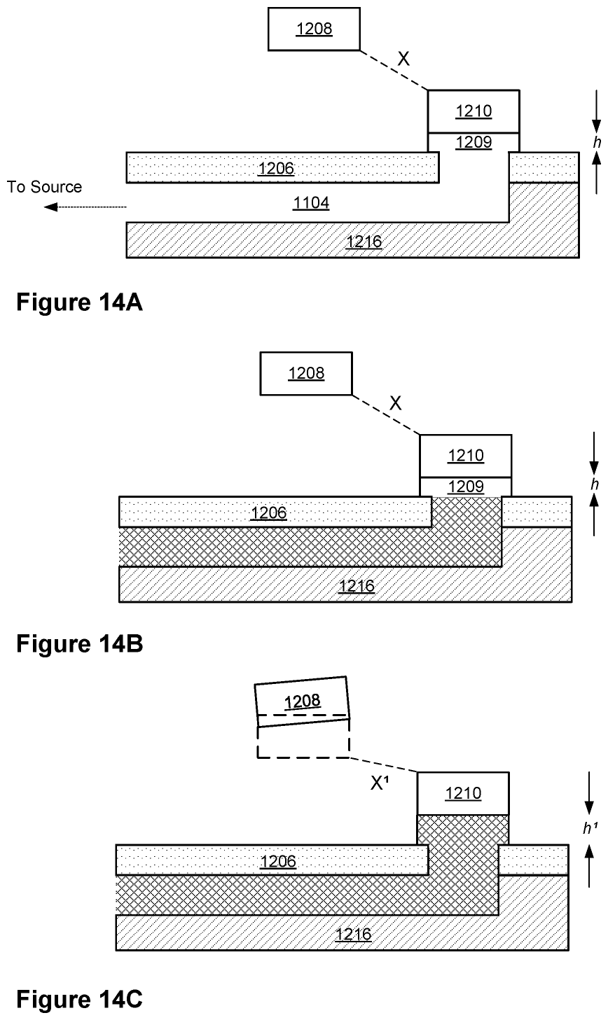

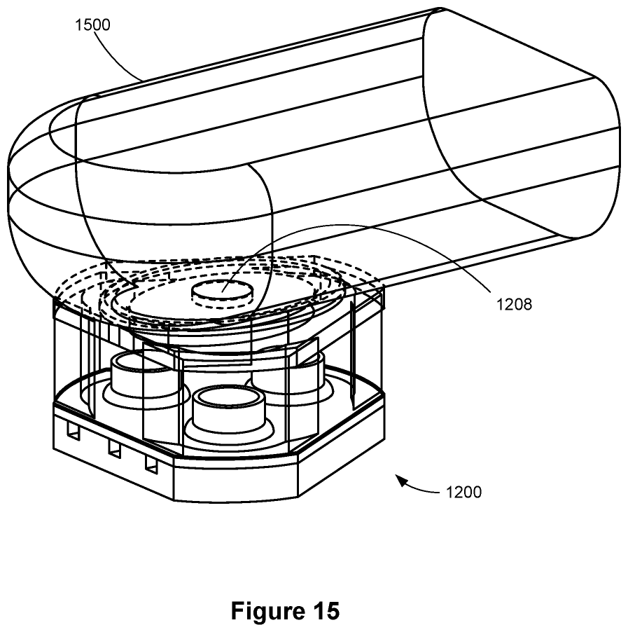

FIG. 13 also shows the northern and southern (e.g., positive and negative, or vice versa) poles of each distinct magnet included in the representative haptic assembly 1200. Importantly, the plurality of secondary magnets 1210-A, 1210-B, and 1210-C are arranged so that the northern poles are the closest poles to the end-effector magnet 1208, while the end-effector magnet 1208 is arranged in the opposite fashion, such that the northern pole of the end-effector magnet 1208 is the closest pole to the plurality of secondary magnets 1210-A, 1210-B, and 1210-C. Consequently, in this arrangement, the northern poles of the plurality of secondary magnets 1210-A, 1210-B, and 1210-C magnetically interact with the northern pole of the end-effector magnet 1208, thus creating a magnetic repulsion between the secondary magnets 1210 and the end-effector magnet 1208. Put another way, the illustrated arrangement of magnets creates a magnetic field between the secondary magnets 1210 and the end-effector magnet 1208, and a position and orientation of the end-effector magnet 1208 can be adjusted by manipulating this magnetic field. Specifically, the magnetic field can be manipulated by elevating one or more of the secondary magnets 1210 toward the end-effector magnet 1208, as illustrated in FIGS. 14A-14C (discussed below), which in turn causes the end-effector magnet 1208 to elevate.

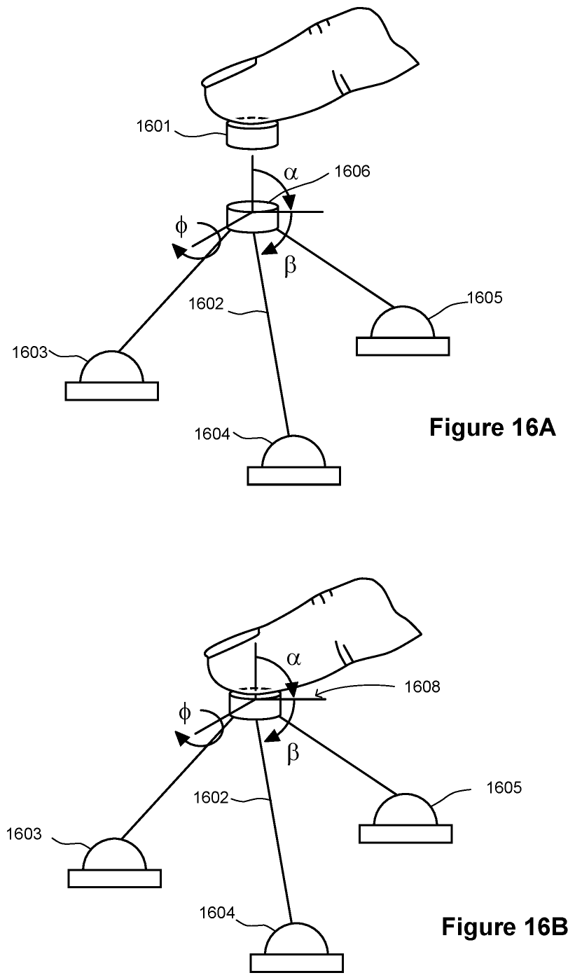

The key here is that respective distances (Xₐ, X_{b}, X_{c}) between the secondary magnets 1210 and the end-effector magnet 1208 can be finely adjusted by elevating one or more of the secondary magnets 1210 toward the end-effector magnet 1208. Furthermore, the magnetic field between the end-effector magnet 1208 and any one of the secondary magnets 1210 changes as a ratio of 1/X⁴, where X (e.g., Xₐ, X_{b}, or X_{c}) is, again, the distance between a respective secondary magnet 1210 and the end-effector magnet 1208. The current embodiment leverages this principle to exert large ranges of forces to the user by small displacement of a respective secondary magnet 1210. Accordingly, the representative haptic assembly 1200 physically decouples the end-effector magnet 1208 from the secondary magnets 1210 by using a magnetic field to transmit forces. This decoupling is beneficial because it reduces the risk of damaging the haptic assembly 1200 when the end-effector magnet 1208 is obstructed by external forces. Also, the decoupling allows for improved ranges of angular motion, as explained below with reference to FIGS. 16A and 16B.

As mentioned earlier, the end-effector magnet 1208 is configured to elevate (e.g., along the Z-axis) and also rotate or otherwise turn or pivot. For example, the end-effector magnet 1208 is configured to impart a first haptic stimulation (e.g., a shear stimulation) to a portion of the user's body (e.g., fingertip) when the fluid pressure in one or more (less than all) of the plurality of channels 1104 is changed from a default pressure level (e.g., ambient temperature), thereby causing one or more (less than all) of the plurality of secondary magnets 1210 to elevate toward and move (e.g., magnetically repel) the end-effector magnet 1208 through a magnetic force. In this example, secondary magnet 1210-A and secondary magnet 1210-B may be elevated, while secondary magnet 1210-C remains at its default position. In such a scenario, the end-effector magnet 1208 would be elevated along the Z-axis, and also rotated (slightly) about the X-axis in the clockwise direction.

In another example, the end-effector magnet is configured to impart a second haptic stimulation (e.g., a pure pressure stimulation), different from the first haptic stimulation, to the portion of the user's body when the fluid pressure in each of the plurality of channels 1104 is changed from the default pressure level to some desired pressure level, thereby causing each of the plurality of secondary magnets 1210 to elevate toward (or otherwise move) and move the end-effector magnet 1208 through the magnetic force. In such a scenario, the end-effector magnet 1208 would be elevated along the Z-axis, but not rotated as each secondary magnet 1210 would be acting equally upon the end-effector magnet 1208.

Importantly, countless variations of the two examples above can be used in order for the end-effector magnet 1208 to impart unique haptic stimulations to the user. Indeed, the end-effector magnet 1208 is configured to impart different shear stimulations to the user's body depending on (i) which of the plurality of channels 1104 experiences a fluid pressure change (increase or decrease), and (ii) a magnitude of the fluid pressure change. Moreover, due to the ever-changing nature of artificial reality, structures of the haptic assembly 1200 described herein are durable and designed to quickly transition from state to state. For example, the bladders 1209 that are used to elevate the secondary magnets 1210 are made from an elastic material, such as thermoplastic polyurethane (TPU), meaning that the bladders 1209 can be rapidly inflated and deflated so that the haptic stimulation applied to the user can be quickly changed, e.g., according to the media presented on the head-mounted display 1010.

In some embodiments, the secondary magnets 1210 are spaced equally apart from one another (e.g., to substantially form an equilateral triangle with the end-effector magnet 1208 positioned near the triangle's center). In other embodiments, the secondary magnets 1210 are not equally spaced apart. Note that the end-effector magnet 1208 in FIG. 13 is aligned with a primary axis (e.g., a central axis defined in the Z-direction), while each of the plurality of magnets 1210 is aligned with a distinct secondary axis (also defined in the Z-direction) that (i) parallels the primary axis and (ii) is offset from the primary axis is a unique direction.

FIGS. 14A-14C show cross-sectional views of the representative haptic assembly 1200 in accordance with some embodiments. In particular, FIGS. 14A-14C show the process of a respective channel 1104 receiving fluid from the source 1110 in order to elevate a respective secondary magnet 1210 toward the end-effector magnet 1208. It is noted that while only one channel 1104 and one secondary magnet 1210 are shown in FIGS. 14A-14C, it should be understood that the principles discussed below apply equally to other channels 1104 and secondary magnets 1210 of the representative haptic assembly 1200 (either separately or concurrently).

To begin, FIG. 14A shows the representative haptic assembly 1200 in an unpressurized state. In such a state, the channel 1104 is not receiving fluid from the source 1110, and, thus, the channel 1104 is at ambient pressure. Also in this state, the secondary magnet 1210 is not magnetically influencing the end-effector magnet 1208 (i.e., both magnets are in a steady state). The positions of the secondary magnet 1210 and the end-effector magnet 1208 shown in FIG. 14A are sometimes referred to herein as their respective default positions. Note that the bladder 1209 has an initial/default thickness (h) in FIG. 14A.

Continuing, FIG. 14B shows the representative haptic assembly 1200 in a first pressurized state. In this state, the channel 1104 is receiving (or has started to receive) fluid from the source 1110, and, thus, the channel 1104 is no longer at ambient pressure. However, because a pressure level inside the channel 1104 has not reached a threshold pressure, the secondary magnet 1210 is still at its default position (i.e., the fluid pressure inside the channel 1104 is not strong enough to elevate the secondary magnet 1210 from its default position). Accordingly, the secondary magnet 1210 is not magnetically influencing the end-effector magnet 1208 in FIG. 14B (i.e., the end-effector magnet 1208 is still at its default position). Note that the bladder 1209 still has its initial/default thickness (h) in FIG. 14B.

FIG. 14C shows the representative haptic assembly 1200 in a second pressurized state. In this state, the channel 1104 is receiving (or has continued to receive) fluid from the source 1110, and, thus, the channel 1104 is no longer at ambient pressure. Importantly, the pressure level inside the channel 1104 is at or above the threshold pressure, which causes the bladder 1209 to expand and elevate the secondary magnet 1210 from its default position (e.g., the bladder 1209 has a thickness (h) that is greater than its default thickness (h)). Accordingly, the secondary magnet 1210 is magnetically influencing (i.e., repelling) the end-effector magnet 1208 in FIG. 14C (i.e., the end-effector magnet 1208 is no longer at its default position, which is indicated by the dashed box in FIG. 14C). Note that the distance X¹ in FIG. 14C is less than the distance X in FIGS. 14A-14B.

In FIG. 14C, the secondary magnet 1210 is the only secondary magnet of the haptic assembly 1200 that has been elevated by the source 1110. Because of this, the end-effector magnet 1208 is elevated and rotated from its default position. In such a configuration, the end-effector magnet 1208 would provide a shear stimulation to a user (e.g., if the user were wearing a wearable device 1020 that include the haptic assembly 1200).

FIG. 15 shows a user's finger 1500 in contact with the representative haptic assembly 1200. As shown, the end-effector magnet 1208, while covered by the finger 1500, is in direct contact with the finger 1500. In some embodiments, multiple instances of the representative haptic assembly 1200 are distributed along a length of the finger 1500. Moreover, in some embodiments, each of the user's fingers may be attached with one or more instances of the representative haptic assembly 1200. In other words, the wearable device 1020 may include an array of haptic assemblies 1200 distributed across or along one or more portions of the user's body.

FIGS. 16A and 16B show two simplified illustrations of different haptic creating devices. FIG. 16A relates to the representative haptic assembly 1200 (i.e., a haptic creating device that leverage magnetic forces to impart haptic feedback) while FIG. 16B relates to a similar device lacking magnets. In particular, the device in FIG. 16A includes three rigid links 1602 connected to a magnet 1606, whereby the rigid links 1602 are moved by pocket/bubble actuators 1603, 1604, 1605. Furthermore, the magnet 1606 is magnetically coupled to another magnet 1601 in a repulsion configuration. Notably, the magnet 1601 is held in place by a stretchable membrane, like the end-effector magnet 1208. In contrast, the device in FIG. 16B includes three rigid links 1602 connected to a mass 1608 (i.e., not a magnet), whereby the rigid links 1602 in FIG. 16B are also moved by pocket/bubble actuators 1603, 1604, 1605.

In FIGS. 16A-16B, R:{αₘₐₓ, βₘₐₓ, Øₘₐₓ} is the range of angular motion, whereby R_{7A} (i.e., the range of angular motion of the device in FIG. 16A) is limited by the maximum strain of the stretchable fabric (i.e., the membrane 1204), while R_{7B} is limited by the rigid links 1602. Therefore, R_{7A}>R_{7B} because the magnet (1601) in FIG. 16A can move freely due to its inertia even when magnet (1606) is limited in motion by the rigid links (1602). This increase in range of motion in the current system (FIG. 16A) is beneficial to creating haptic feedback because the user skin gets stretched by a larger range in FIG. 16A than in the configuration of 16B, resulting in stronger and more diverse haptic feedback. In practice, the representative haptic assembly 1200 does not implement the rigid links 1602, but rather, as explained in detail above, uses magnetic forces. Again, FIGS. 16A and 16B are merely included herein to demonstrate the versatility (i.e., range of angular motion) of haptic devices that uses magnetic forces (like the haptic assembly 1200), as opposed to rigid links and direct physical coupling.

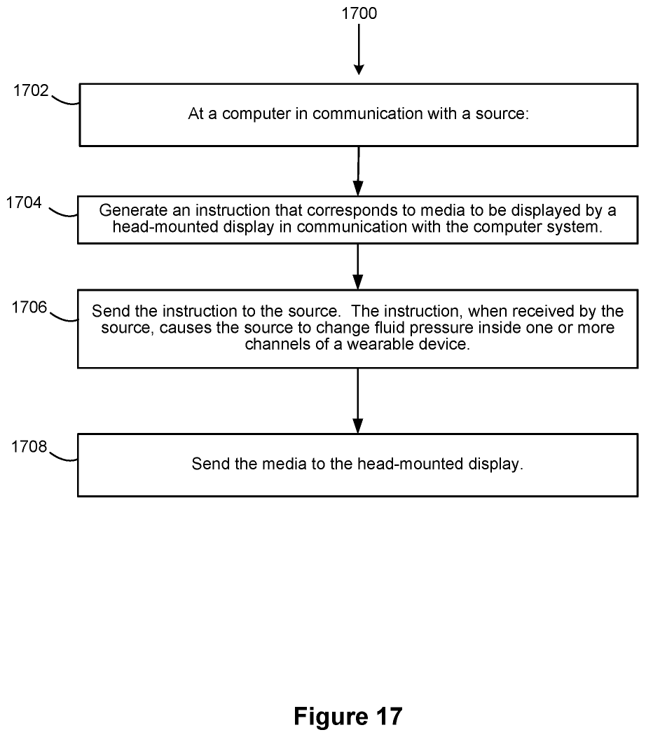

FIG. 17 is a flow diagram illustrating a method 1700 of creating haptic stimulations in accordance with some embodiments. The steps of the method 1700 may be performed (1702) by a computer 1030. FIG. 17 corresponds to instructions stored in a computer memory or computer readable storage medium (e.g., the memory of the computer system 1030). For example, the operations of the method 1700 are performed, at least in part, by a communication interface 1036 and an artificial-reality generation module (e.g., part of the engine 1034).

The method 1700 includes generating (1704) an instruction that corresponds to media (e.g., visual data) to be displayed by a head-mounted display 1010 in communication the computer system (and/or corresponds to information received from one or more sensors 1024 of the wearable device 1020 and/or information received from one or more sensors 1014 of the head-mounted display 1010). In some embodiments, the computer system generates the instruction based on information received from the sensors on the wearable device. Alternatively or in addition, in some embodiments, the computer system generates the instruction based on information received from the sensors on the head-mounted display. For example, cameras (or other sensors 1014) on the head-mounted display may capture movements of the wearable device, and the computer system can use this information when generating the instruction.

The method 1700 further includes sending (1706) the instruction to a fluid source 1110 in communication with the computer system (e.g., send the instruction in a communication signal from a communication interface). The instruction, when received by the source, causes the source to change a pressure inside a haptic-feedback mechanism 1022 of the wearable device 1020 (e.g., the source injects fluid into one or more channels 1104 of the haptic assembly 1200). In doing so, a wearer of the wearable device experiences a haptic stimulation that corresponds to the data (e.g., fluid in channel(s) causes one or more of the secondary magnets 1210 to move from their respective default positions, which in turn causes the end-effector magnet 1208 to move and press into the user's body, as explained above). In some embodiments, the instruction specifies the change in the pressure to be made by the source. Moreover, in some embodiments, the instruction specifics which channel 1104 (or channels 1104) to inject the fluid into. In some situations, instead of the computer system sending the instruction to the source, the computer system sends the instruction to the wearable device, and in response to receiving the instruction, the wearable device sends the instruction to the source. The source is discussed in further detail above with reference to FIG. 11.

After (or while, or before) sending the instruction, the method 1700 also includes sending (1706) the media to the head-mounted display. For example, the head-mounted display may receive visual data from the computer system, and may in turn display the visual data on its display(s). As an example, if the computer system receives information from the sensors 1024 of the wearable device 1020 that the user has closed his fingers around a position corresponding to a coffee mug in the virtual environment and raised his hand, a simulated hand in a virtual-reality application picks up the virtual coffee mug and lifts it to a corresponding height. Generating and sending media is discussed in further detail above with reference to FIG. 10.

In conjunction with displaying the visual data (or other media), one or more channels of the haptic-feedback mechanism are pressurized or depressurized to the desired pressure (as noted above). As an example, the haptic-feedback mechanism 1022 may include: (A) a housing that (i) supports a flexible membrane, and (ii) defines a plurality of channels configured to receive a fluid from a source, (B) an end-effector magnet, coupled to the flexible membrane, configured to impart one or more haptic stimulations to a portion of a user's body, and (C) a plurality of secondary magnets, housed by the housing, configured to move (e.g., repel) the end-effector magnet through magnetic force, whereby a distance separating the end-effector magnet from the plurality of secondary magnets is varied according to a fluid pressure in one or more of the plurality of channels.

In some embodiments, the computer and the head-mounted display together form an artificial-reality system. Furthermore, in some embodiments, the artificial-reality system is a virtual-reality system 1100. Alternatively, in some embodiments, the artificial-reality system is an augmented-reality system 1000 or augmented-reality system 1100. In some embodiments, the visual data presented to the user by the artificial-reality system includes visual media displayed on one or more displays of the virtual-reality or augmented-reality system.

Embodiments of this disclosure may include or be implemented in conjunction with various types of artificial-reality systems. Artificial reality may constitute a form of reality that has been altered by virtual objects for presentation to a user. Such artificial reality may include and/or represent virtual reality (VR), augmented reality (AR), mixed reality (MR), hybrid reality, or some combination and/or variation of one or more of the these. Artificial-reality content may include completely generated content or generated content combined with captured (e.g., real-world) content. The artificial reality content may include video, audio, haptic feedback, or some combination thereof, any of which may be presented in a single channel or in multiple channels (such as stereo video that produces a three-dimensional effect to a viewer). Additionally, in some embodiments, artificial reality may also be associated with applications, products, accessories, services, or some combination thereof, which are used, for example, to create content in an artificial reality and/or are otherwise used in (e.g., to perform activities in) an artificial reality.

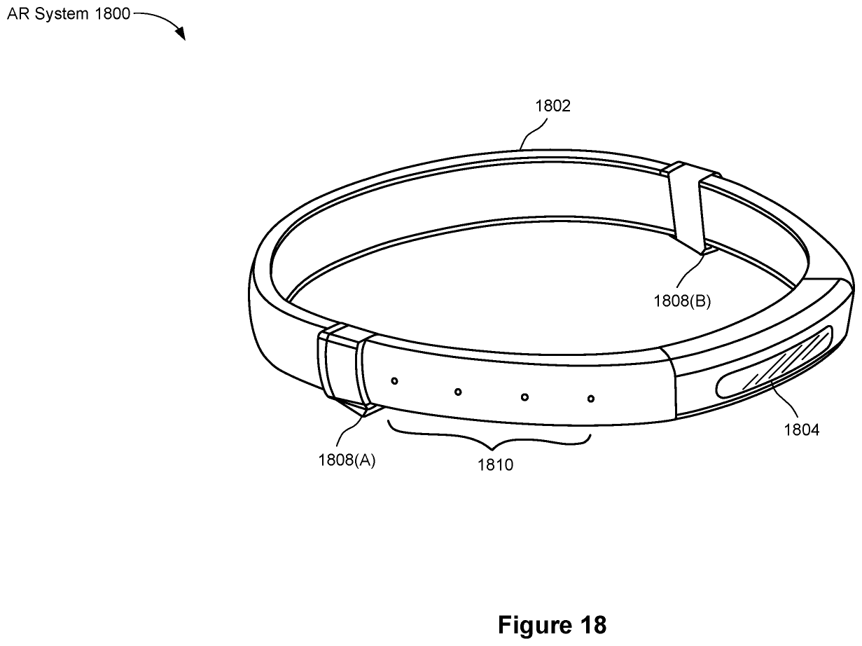

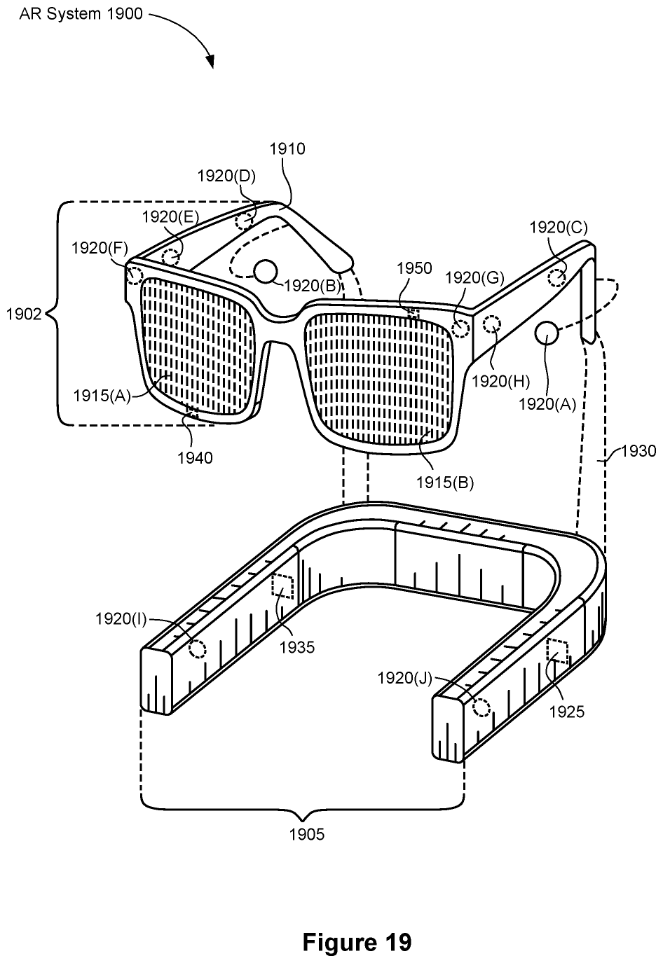

Artificial-reality systems may be implemented in a variety of different form factors and configurations. Some artificial reality systems are designed to work without near-eye displays (NEDs), an example of which is the AR system 1800 in FIG. 18. Other artificial reality systems include an NED, which provides visibility into the real world (e.g., the AR system 1800 in FIG. 19) or that visually immerses a user in an artificial reality (e.g., the VR system 1000 in FIG. 10). While some artificial reality devices are self-contained systems, other artificial reality devices communicate and/or coordinate with external devices to provide an artificial reality experience to a user. Examples of such external devices include handheld controllers, mobile devices, desktop computers, devices worn by a user (e.g., a wearable device 1020), devices worn by one or more other users, and/or any other suitable external system.

FIGS. 18-20 provide additional examples of the devices used in the system 1000. The AR system 1800 in FIG. 18 generally represents a wearable device dimensioned to fit about a body part (e.g., a head) of a user. The AR system 1800 may include the functionality of the wearable device 1020, and may include additional functions not described above. As shown, the AR system 1800 includes a frame 1802 (e.g., a band or wearable structure 1102) and a camera assembly 1804, which is coupled to the frame 1802 and configured to gather information about a local environment by observing the local environment (and may include a display 1804 that displays a user interface). The AR system 1800 may also include one or more transducers. In one example, the AR system 1800 includes output transducers 1808(A) and 1808(B) and input transducers 1810. The output transducers 1808(A) and 1808(B) may provide audio feedback, haptic feedback, and/or content to a user, and the input audio transducers may capture audio (or other signals/waves) in a user's environment.

Thus, the AR system 1800 does not include a near-eye display (NED) positioned in front of a user's eyes. AR systems without NEDs may take a variety of forms, such as head bands, hats, hair bands, belts, watches, wrist bands, ankle bands, rings, neckbands, necklaces, chest bands, eyewear frames, and/or any other suitable type or form of apparatus. While the AR system 1800 may not include an NED, the AR system 1800 may include other types of screens or visual feedback devices (e.g., a display screen integrated into a side of the frame 1802).

The embodiments discussed in this disclosure may also be implemented in AR systems that include one or more NEDs. For example, as shown in FIG. 19, the AR system 1900 may include an eyewear device 1902 with a frame 1910 configured to hold a left display device 1915(A) and a right display device 1915(B) in front of a user's eyes. The display devices 1915(A) and 1915(B) may act together or independently to present an image or series of images to a user. While the AR system 1900 includes two displays, embodiments of this disclosure may be implemented in AR systems with a single NED or more than two NEDs.

In some embodiments, the AR system 1900 may include one or more sensors, such as the sensors 1940 and 1950 (e.g., instances of the sensors 1014 in FIG. 10). The sensors 1940 and 1950 may generate measurement signals in response to motion of the AR system 1900 and may be located on substantially any portion of the frame 1910. Each sensor may be a position sensor, an inertial measurement unit (IMU), a depth camera assembly, or any combination thereof. The AR system 1900 may or may not include sensors or may include more than one sensor. In embodiments in which the sensors include an IMU, the IMU may generate calibration data based on measurement signals from the sensors. Examples of the sensors include, without limitation, accelerometers, gyroscopes, magnetometers, other suitable types of sensors that detect motion, sensors used for error correction of the IMU, or some combination thereof. Sensors are also discussed above with reference to FIG. 10.

The AR system 1900 may also include a microphone array with a plurality of acoustic sensors 1920(A)-1920(J), referred to collectively as the acoustic sensors 1920. The acoustic sensors 1920 may be transducers that detect air pressure variations induced by sound waves. Each acoustic sensor 1920 may be configured to detect sound and convert the detected sound into an electronic format (e.g., an analog or digital format). The microphone array in FIG. 19 may include, for example, ten acoustic sensors: 1920(A) and 1920(B), which may be designed to be placed inside a corresponding ear of the user, acoustic sensors 1920(C). 1920(D), 1920(E), 1920(F), 1920(G), and 1920(H), which may be positioned at various locations on the frame 11810, and/or acoustic sensors 1920(1) and 1920(J), which may be positioned on a corresponding neckband 1905. In some embodiments, the neckband 1905 is an example of the computer system 1030.

The configuration of the acoustic sensors 1920 of the microphone array may vary. While the AR system 1900 is shown in FIG. 19 having ten acoustic sensors 1920, the number of acoustic sensors 1920 may be greater or less than ten. In some embodiments, using more acoustic sensors 1920 may increase the amount of audio information collected and/or the sensitivity and accuracy of the audio information. In contrast, using a lower number of acoustic sensors 1920 may decrease the computing power required by a controller 1925 to process the collected audio information. In addition, the position of each acoustic sensor 1920 of the microphone array may vary. For example, the position of an acoustic sensor 1920 may include a defined position on the user, a defined coordinate on the frame 1910, an orientation associated with each acoustic sensor, or some combination thereof.

The acoustic sensors 1920(A) and 1920(B) may be positioned on different parts of the user's ear, such as behind the pinna or within the auricle or fossa. Or, there may be additional acoustic sensors on or surrounding the ear in addition to acoustic sensors 1920 inside the ear canal. Having an acoustic sensor positioned next to an ear canal of a user may enable the microphone array to collect information on how sounds arrive at the ear canal. By positioning at least two of the acoustic sensors 1920 on either side of a user's head (e.g., as binaural microphones), the AR device 1900 may simulate binaural hearing and capture a 3D stereo sound field around a user's head. In some embodiments, the acoustic sensors 1920(A) and 1920(B) may be connected to the AR system 1900 via a wired connection, and in other embodiments, the acoustic sensors 1920(A) and 1920(B) may be connected to the AR system 1900 via a wireless connection (e.g., a Bluetooth connection). In still other embodiments, the acoustic sensors 1920(A) and 1920(B) may not be used at all in conjunction with the AR system 1900.

The acoustic sensors 1920 on the frame 1910 may be positioned along the length of the temples, across the bridge, above or below the display devices 1915(A) and 1915(B), or some combination thereof. The acoustic sensors 1920 may be oriented such that the microphone array is able to detect sounds in a wide range of directions surrounding the user wearing AR system 1900. In some embodiments, an optimization process may be performed during manufacturing of the AR system 1900 to determine relative positioning of each acoustic sensor 1920 in the microphone array.

The AR system 1900 may further include or be connected to an external device (e.g., a paired device), such as a neckband 1905. As shown, the neckband 1905 may be coupled to the eyewear device 1902 via one or more connectors 1930. The connectors 1930 may be wired or wireless connectors and may include electrical and/or non-electrical (e.g., structural) components. In some cases, the eyewear device 1902 and the neckband 1905 may operate independently without any wired or wireless connection between them. While FIG. 19 illustrates the components of the eyewear device 1902 and the neckband 1905 in example locations on the eyewear device 1902 and the neckband 1905, the components may be located elsewhere and/or distributed differently on the eyewear device 1902 and/or the neckband 1905. In some embodiments, the components of the eyewear device 1902 and the neckband 1905 may be located on one or more additional peripheral devices paired with the eyewear device 1902, the neckband 1905, or some combination thereof. Furthermore, the neckband 1905 generally represents any type or form of paired device. Thus, the following discussion of neckband 1905 may also apply to various other paired devices, such as smart watches, smart phones, wrist bands, other wearable devices, hand-held controllers, tablet computers, or laptop computers.

Pairing external devices, such as a neckband 1905, with AR eyewear devices may enable the eyewear devices to achieve the form factor of a pair of glasses while still providing sufficient battery and computation power for expanded capabilities. Some or all of the battery power, computational resources, and/or additional features of the AR system 1900 may be provided by a paired device or shared between a paired device and an eyewear device, thus reducing the weight, heat profile, and form factor of the eyewear device overall while still retaining desired functionality. For example, the neckband 1905 may allow components that would otherwise be included on an eyewear device to be included in the neckband 1905 because users may tolerate a heavier weight load on their shoulders than they would tolerate on their heads. The neckband 1905 may also have a larger surface area over which to diffuse and disperse heat to the ambient environment. Thus, the neckband 1905 may allow for greater battery and computation capacity than might otherwise have been possible on a stand-alone eyewear device. Because weight carried in the neckband 1905 may be less invasive to a user than weight carried in the eyewear device 1902, a user may tolerate wearing a lighter eyewear device and carrying or wearing the paired device for greater lengths of time than the user would tolerate wearing a heavy standalone eyewear device, thereby enabling an artificial reality environment to be incorporated more fully into a user's day-to-day activities.

The neckband 1905 may be communicatively coupled with the eyewear device 1902 and/or to other devices (e.g., wearable device 1020). The other devices may provide certain functions (e.g., tracking, localizing, depth mapping, processing, storage, etc.) to the AR system 1900. In the embodiment of FIG. 19, the neckband 1905 may include two acoustic sensors 1920(I) and 1920(J), which are part of the microphone array (or potentially form their own microphone subarray). The neckband 1905 may also include a controller 1925 (e.g., an instance of the controller 1114 in FIG. 11) and a power source 1935.

The acoustic sensors 1920(1) and 1920(J) of the neckband 1905 may be configured to detect sound and convert the detected sound into an electronic format (analog or digital). In the embodiment of FIG. 19, the acoustic sensors 1920(I) and 1920(J) may be positioned on the neckband 1905, thereby increasing the distance between neckband acoustic sensors 1920(I) and 1920(J) and the other acoustic sensors 1920 positioned on the eyewear device 1902. In some cases, increasing the distance between the acoustic sensors 1920 of the microphone array may improve the accuracy of beamforming performed via the microphone array. For example, if a sound is detected by the acoustic sensors 1920(C) and 1920(D) and the distance between acoustic sensors 1920(C) and 1920(D) is greater than, for example, the distance between the acoustic sensors 1920(D) and 1920(E), the determined source location of the detected sound may be more accurate than if the sound had been detected by the acoustic sensors 1920(D) and 1920(E).

The controller 1925 of the neckband 1905 may process information generated by the sensors on the neckband 1905 and/or the AR system 1900. For example, the controller 1925 may process information from the microphone array, which describes sounds detected by the microphone array. For each detected sound, the controller 1925 may perform a direction of arrival (DOA) estimation to estimate a direction from which the detected sound arrived at the microphone array. As the microphone array detects sounds, the controller 1925 may populate an audio data set with the information. In embodiments in which the AR system 1900 includes an IMU, the controller 1925 may compute all inertial and spatial calculations from the IMU located on the eyewear device 1902. The connector 1930 may convey information between the AR system 1900 and the neckband 1905 and between the AR system 1900 and the controller 1925. The information may be in the form of optical data, electrical data, wireless data, or any other transmittable data form. Moving the processing of information generated by the AR system 1900 to the neckband 1905 may reduce weight and heat in the eyewear device 1902, making it more comfortable to a user.

The power source 1935 in the neckband 1905 may provide power to the eyewear device 1902 and/or to the neckband 1905 (and potentially the wearable device 1020, while in other embodiments the wearable device 1020 includes its own power source). The power source 1935 may include, without limitation, lithium-ion batteries, lithium-polymer batteries, primary lithium batteries, alkaline batteries, or any other form of power storage. In some cases, the power source 1935 may be a wired power source. Including the power source 1935 on the neckband 1905 instead of on the eyewear device 1902 may help better distribute the weight and heat generated by the power source 1935.

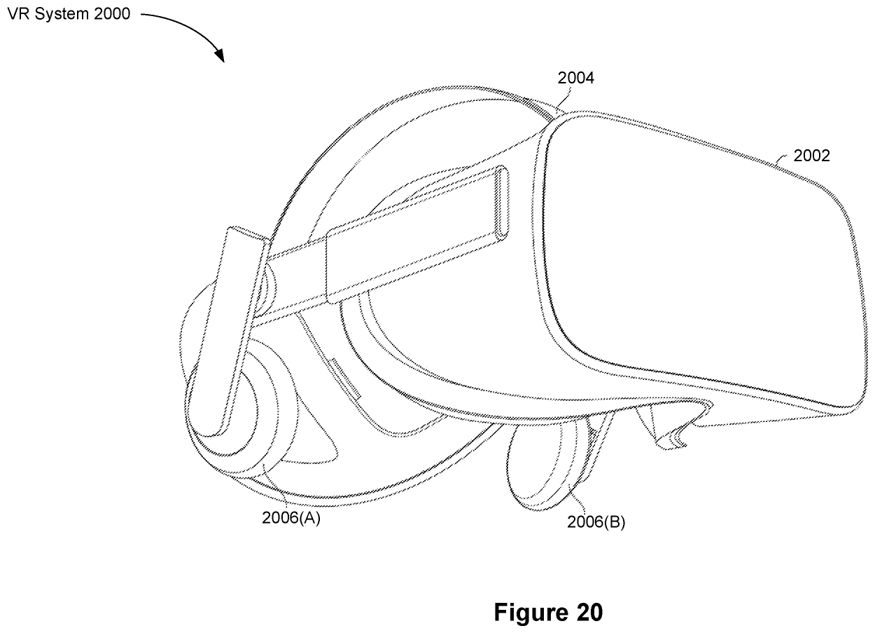

As noted, some artificial reality systems may, instead of blending an artificial reality with actual reality, substantially replace one or more of a user's sensory perceptions of the real world with a virtual experience. One example of this type of system is a head-worn display system, such as the VR system 2000 in FIG. 20, which mostly or completely covers a user's field of view. The VR system 2000 may include a front rigid body 2002 and a band 2004 shaped to fit around a user's head. the VR system 2000 may also include output audio transducers 2006(A) and 2006(B). Furthermore, while not shown in FIG. 20, the front rigid body 2002 may include one or more electronic elements, including one or more electronic displays, one or more IMUs, one or more tracking emitters or detectors, and/or any other suitable device or system for creating an artificial reality experience. Although not shown, the VR system 2000 may include the computer system 1030.

Artificial-reality systems may include a variety of types of visual feedback mechanisms. For example, display devices in the AR system 1900 and/or the VR system 2000 may include one or more liquid-crystal displays (LCDs), light emitting diode (LED) displays, organic LED (OLED) displays, and/or any other suitable type of display screen. Artificial-reality systems may include a single display screen for both eyes or may provide a display screen for each eye, which may allow for additional flexibility for varifocal adjustments or for correcting a user's refractive error. Some artificial reality systems also include optical subsystems having one or more lenses (e.g., conventional concave or convex lenses, Fresnel lenses, or adjustable liquid lenses) through which a user may view a display screen.

In addition to or instead of using display screens, some artificial reality systems include one or more projection systems. For example, display devices in the AR system 1900 and/or the VR system 2000 may include micro-LED projectors that project light (e.g., using a waveguide) into display devices, such as clear combiner lenses that allow ambient light to pass through. The display devices may refract the projected light toward a user's pupil and may enable a user to simultaneously view both artificial reality content and the real world. Artificial-reality systems may also be configured with any other suitable type or form of image projection system.

Artificial-reality systems may also include various types of computer vision components and subsystems. For example, the AR system 1800, the AR system 1900, and/or the VR system 2000 may include one or more optical sensors such as two-dimensional (2D) or three-dimensional (3D) cameras, time-of-flight depth sensors, single-beam or sweeping laser rangefinders, 3D LiDAR sensors, and/or any other suitable type or form of optical sensor. An artificial-reality system may process data from one or more of these sensors to identify a location of a user, to map the real world, to provide a user with context about real-world surroundings, and/or to perform a variety of other functions.

Artificial-reality systems may also include one or more input and/or output audio transducers. In the examples shown in FIGS. 18 and 20, the output audio transducers 1808(A), 1808(B), 2006(A), and 2006(B) may include voice coil speakers, ribbon speakers, electrostatic speakers, piezoelectric speakers, bone conduction transducers, cartilage conduction transducers, and/or any other suitable type or form of audio transducer. Similarly, the input audio transducers 1810 may include condenser microphones, dynamic microphones, ribbon microphones, and/or any other type or form of input transducer. In some embodiments, a single transducer may be used for both audio input and audio output.

The artificial-reality systems shown in FIGS. 18-20 may include tactile (i.e., haptic) feedback systems, which may be incorporated into headwear, gloves, body suits, handheld controllers, environmental devices (e.g., chairs or floormats), and/or any other type of device or system, such as the wearable devices 1020 discussed herein. Additionally, in some embodiments, the haptic feedback systems may be incorporated with the artificial-reality systems (e.g., haptic assembly 1200 shown in FIG. 12A). Haptic feedback systems may provide various types of cutaneous feedback, including vibration, force, traction, texture, and/or temperature. Haptic feedback systems may also provide various types of kinesthetic feedback, such as motion and compliance. Haptic feedback may be implemented using motors, piezoelectric actuators, fluidic systems, and/or a variety of other types of feedback mechanisms, as described herein. Haptic feedback systems may be implemented independently of other artificial-reality devices, within other artificial-reality devices, and/or in conjunction with other artificial-reality devices.

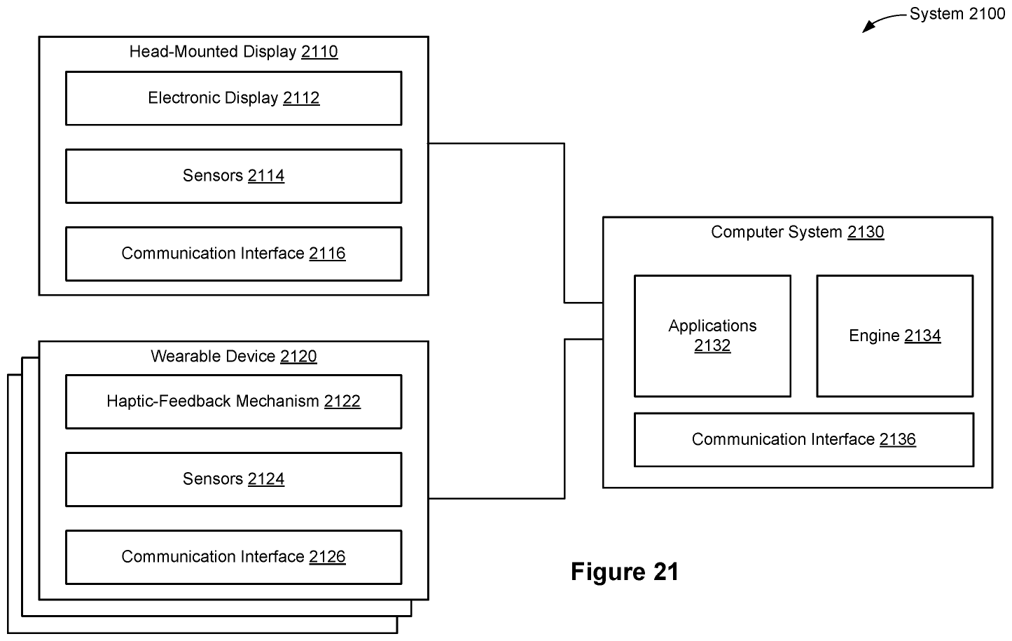

FIG. 21 is a block diagram illustrating an artificial-reality system 2100 in accordance with various embodiments. While some example features are illustrated, various other features have not been illustrated for the sake of brevity and so as not to obscure pertinent aspects of the example embodiments disclosed herein. To that end, as a non-limiting example, the system 2100 includes one or more wearable devices 2120 (sometimes referred to as “wearable apparatuses,” or simply “apparatuses”), which are used in conjunction with a computer system 2130 (sometimes referred to as a “computer device” or a “remote computer device”) and ahead-mounted display 2110. In some embodiments, the system 2100 provides the functionality of a virtual-reality device with haptic feedback, an augmented-reality device with haptic feedback, a mixed-reality device with haptic feedback, or a combination thereof.

The head-mounted display 2110 presents media to a user. Examples of media presented by the head-mounted display 2110 include images, video, audio, or some combination thereof. In some embodiments, audio is presented via an external device (e.g., speakers and/or headphones) that receives audio information from the head-mounted display 2110, the computer system 2130, or both, and presents audio data based on the audio information.

The head-mounted display 2110 includes an electronic display 2112, sensors 2114, and a communication interface 2116. The electronic display 2112 displays images to the user in accordance with data received from the computer system 2130. In various embodiments, the electronic display 2112 may comprise a single electronic display 2112 or multiple electronic displays 2112 (e.g., one display for each eye of a user).

The sensors 2114 include one or more hardware devices that detect spatial and motion information about the head-mounted display 2110. Spatial and motion information can include information about the position, orientation, velocity, rotation, and acceleration of the head-mounted display 2110. For example, the sensors 2114 may include one or more inertial measurement units (IMUs) that detects rotation of the user's head while the user is wearing the head-mounted display 2110. This rotation information can then be used (e.g., by the engine 2134) to adjust the images displayed on the electronic display 2112. In some embodiments, each IMU includes one or more gyroscopes, accelerometers, and/or magnetometers to collect the spatial and motion information. In some embodiments, the sensors 2114 include one or more cameras positioned on the head-mounted display 2110.

The communication interface 2116 enables input and output to the computer system 2130. In some embodiments, the communication interface 2116 is a single communication channel, such as HDMI, USB, VGA, DVI, or DisplayPort. In some other embodiments, the communication interface 2116 includes several distinct communication channels operating together or independently. In some embodiments, the communication interface 2116 includes hardware capable of data communications using any of a variety of custom or standard wireless protocols (e.g., IEEE 802.15.4, Wi-Fi, ZigBee, 6LoWPAN, Thread, Z-Wave, Bluetooth Smart, ISA100.11a, WirelessHART, or MiWi) and/or any other suitable communication protocol. The wireless and/or wired connections may be used for sending data collected by the sensors 2114 from the head-mounted display to the computer system 2130. In such embodiments, the communication interface 2116 may also receive audio/visual data to be rendered on the electronic display 2112.

The wearable device 2120 includes a wearable structure worn by the user (e.g., a glove, a shirt, pants, or some other garment). In some embodiments, the wearable device 2120 collects information about a portion of the user's body (e.g., the user's hand) that can be used as input for artificial-reality applications 2132 executing on the computer system 2130. In the illustrated embodiment, the wearable device 2120 includes a haptic-feedback mechanism 2122, one or more sensors 2124, and a communication interface 2126. The wearable device 2120 may include additional components that are not shown in FIG. 21, such as a power source (e.g., an integrated battery, a connection to an external power source, a container containing compressed air, or some combination thereof), one or more processors, memory, a display, microphones, and speakers. The haptic-feedback mechanism 2122 is sometimes referred to herein as a “haptic assembly 2122” or a “haptic device 2122.”

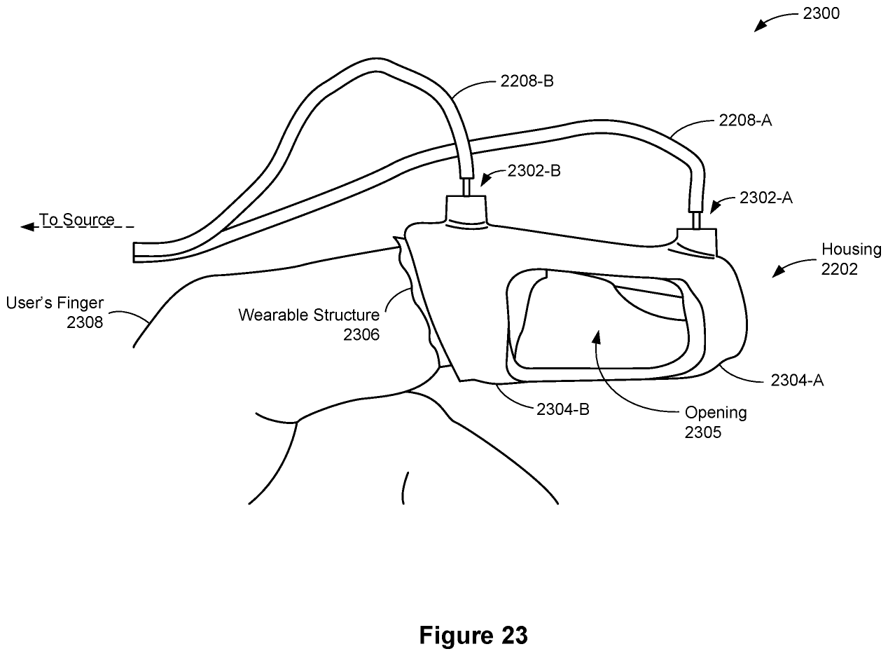

The haptic-feedback mechanism 2122 includes multiple functionalities. Firstly, the haptic-feedback mechanism 2122 is designed to secure (i.e., ground) itself to a portion of the user's body (e.g., the user's fingertip). To accomplish this and as will be described in more detail below, the haptic-feedback mechanism 2122 is designed to tighten around the portion of the user's body when desired. The haptic-feedback mechanism 2122 is also designed to impart haptic feedback onto the portion of the user's body. In some embodiments, the haptic feedback is imparted using the same components that are used to achieve the grounding. Alternatively or in addition, in some embodiments, the haptic feedback is imparted using different components than those used to achieve the grounding. Structures for the components used to accomplish the grounding and the haptic feedback are discussed in further detail below with reference to FIGS. 23 through 28B.

In some embodiments, the sensors 2124 include one or more hardware devices that detect spatial and motion information about the wearable device 2120. Spatial and motion information can include information about the position, orientation, velocity, rotation, and acceleration of the wearable device 2120 or any subdivisions of the wearable device 2120, such as fingers, fingertips, knuckles, the palm, or the wrist when the wearable device 2120 is worn near the user's hand. The sensors 2124 may be IMUs, as discussed above with reference to the sensors 2114. The sensors 2124 may also include one or more hardware devices that monitor a state of a respective bladder 2204 of the haptic-feedback mechanism 2122. In some embodiments, the sensors may be pressure or force sensors. Also, the sensors 2124 may monitor a grounding force applied to the user by a respective bladder 2204 of the haptic-feedback mechanism 2122. In some embodiments, the sensors 2124 are part of the haptic-feedback mechanism 2122.

The communication interface 2126 enables input and output to the computer system 2130. In some embodiments, the communication interface 2126 is a single communication channel, such as USB. In some other embodiments, the communication interface 2126 includes several distinct communication channels operating together or independently. For example, the communication interface 2126 may include separate communication channels for receiving control signals for the haptic-feedback mechanism 2122 and sending data from the sensors 2124 to the computer system 2130. The one or more communication channels of the communication interface 2126 can be implemented as wired or wireless connections. In some embodiments, the communication interface 2126 includes hardware capable of data communications using any of a variety of custom or standard wireless protocols (e.g., IEEE 802.15.4. Wi-Fi, ZigBee, 6LoWPAN, Thread, Z-Wave, Bluetooth Smart, ISA100.11a, WirelessHART, or MiWi), custom or standard wired protocols (e.g., Ethernet or HomePlug), and/or any other suitable communication protocol, including communication protocols not yet developed as of the filing date of this document.

The computer system 2130 is a computing device that executes artificial-reality applications (e.g., virtual-reality applications, augmented-reality applications, or the like) to process input data from the sensors 2114 on the head-mounted display 2110 and the sensors 2124 on the wearable device 2120. The computer system 2130 provides output data for (i) the electronic display 2112 on the head-mounted display 2110 and (ii) the haptic-feedback mechanism 2122 on the wearable device 2120.

The computer system includes a communication interface 2136 that enables input and output to other devices in the system 2100. The communication interface 2136 is similar to the communication interface 2116 and the communication interface 2126, and, thus, for the sake brevity, duplicate description is not repeated here.

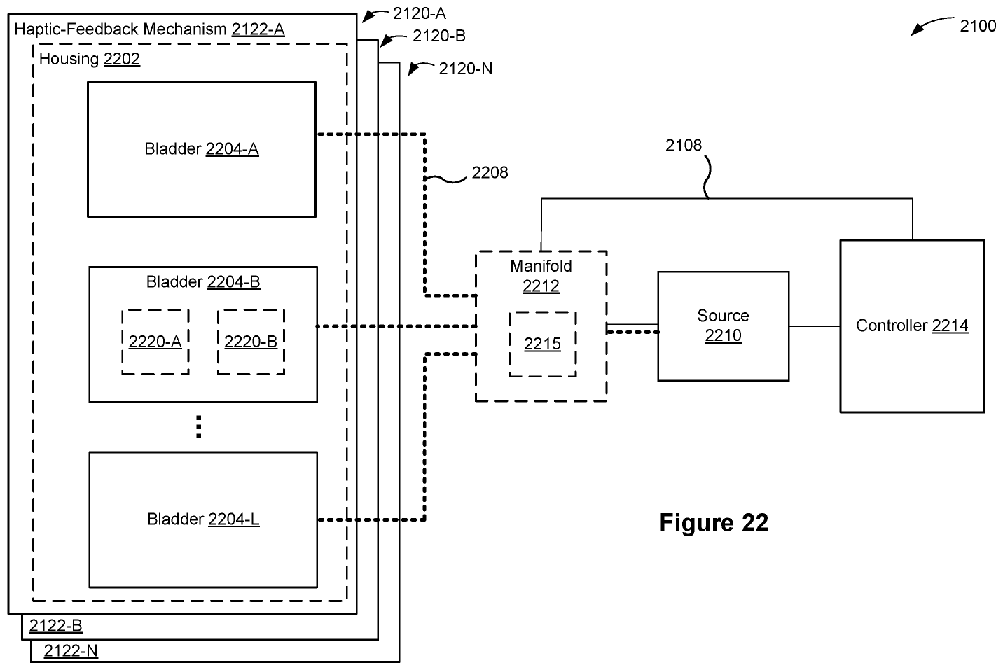

In some embodiments, the computer system 2130 sends instructions (e.g., the output data) to the wearable device 2120. In response to receiving the instructions, the wearable device 2120 creates one or more haptic stimulations (e.g., activates one or more of the bladders 2204 for grounding purposes and/or haptic feedback purposes). Alternatively, in some embodiments, the computer system 2130 sends instructions to an external device, such as a fluid (pressure) source (e.g., source 2210, FIG. 22), and in response to receiving the instructions, the external device creates one or more haptic stimulations (e.g., the output data bypasses the wearable device 2120). Alternatively, in some embodiments, the computer system 2130 sends instructions to the wearable device 2120, which in turn sends the instructions to the external device. The external device then creates one or more haptic stimulations by adjusting fluid pressure in one or more of the bladders 2204. Although not shown, in the embodiments that include a distinct external device, the external device may be connected to the head-mounted display 2110, the wearable device 2120, and/or the computer system 2130 via a wired or wireless connection. The external device may be a pneumatic device, a hydraulic device, some combination thereof, or any other device capable of adjusting pressure.

The computer system 2130 can be implemented as any kind of computing device, such as an integrated system-on-a-chip, a microcontroller, a desktop or laptop computer, a server computer, a tablet, a smart phone or other mobile device. Thus, the computer system 2130 includes components common to typical computing devices, such as a processor, random access memory, a storage device, a network interface, an I/O interface, and the like. The processor may be or include one or more microprocessors or application specific integrated circuits (ASICs). The memory may be or include RAM, ROM, DRAM, SRAM and MRAM, and may include firmware, such as static data or fixed instructions, BIOS, system functions, configuration data, and other routines used during the operation of the computing device and the processor. The memory also provides a storage area for data and instructions associated with applications and data handled by the processor.

The storage device provides non-volatile, bulk, or long term storage of data or instructions in the computing device. The storage device may take the form of a magnetic or solid state disk, tape, CD, DVD, or other reasonably high capacity addressable or serial storage medium. Multiple storage devices may be provided or available to the computing device. Some of these storage devices may be external to the computing device, such as network storage or cloud-based storage. The network interface includes an interface to a network and can be implemented as either wired or wireless interface. The I/O interface interfaces the processor to peripherals (not shown) such as, for example and depending upon the computing device, sensors, displays, cameras, color sensors, microphones, keyboards, and USB devices.

In the example shown in FIG. 21, the computer system 2130 further includes artificial-reality applications 2132 and an artificial-reality engine 2134. In some embodiments, the artificial-reality applications 2132 and the artificial-reality engine 2134 are implemented as software modules that are stored on the storage device and executed by the processor. Some embodiments of the computer system 2130 include additional or different components than those described in conjunction with FIG. 21. Similarly, the functions further described below may be distributed among components of the computer system 2130 in a different manner than is described here.

Each artificial-reality application 2132 is a group of instructions that, when executed by a processor, generates artificial-reality content for presentation to the user. An artificial-reality application 2132 may generate artificial-reality content in response to inputs received from the user via movement of the head-mounted display 2110 or the wearable device 2120. Examples of artificial-reality applications 2132 include gaming applications, conferencing applications, video playback applications, and numerous others.

The artificial-reality engine 2134 is a software module that allows artificial-reality applications 2132 to operate in conjunction with the head-mounted display 2110 and the wearable device 2120. In some embodiments, the artificial-reality engine 2134 receives information from the sensors 2114 on the head-mounted display 2110 and provides the information to an artificial-reality application 2132. Based on the received information, the artificial-reality engine 2134 determines media content to provide to the head-mounted display 2110 for presentation to the user via the electronic display 2112 and/or a type of haptic feedback to be created by the haptic-feedback mechanism 2122 of the wearable device 2120. For example, if the artificial-reality engine 2134 receives information from the sensors 2114 on the head-mounted display 2110 indicating that the user has looked to the left, the artificial-reality engine 2134 generates content for the head-mounted display 2110 that mirrors the user's movement in an artificial environment.

Similarly, in some embodiments, the artificial-reality engine 2134 receives information from the sensors 2124 on the wearable device 2120 and provides the information to an artificial-reality application 2132. The application 2132 can use the information to perform an action within the artificial world of the application 2132. For example, if the artificial-reality engine 2134 receives information from the sensors 2124 that the user has closed his fingers around a position corresponding to a coffee mug in the artificial environment and raised his hand, a simulated hand in the artificial-reality application 2132 picks up the artificial coffee mug and lifts it to a corresponding height. As noted above, the information received by the artificial-reality engine 2134 can also include information from the head-mounted display 2110. For example, cameras on the head-mounted display 2110 may capture movements of the wearable device 2120, and the application 2132 can use this additional information to perform the action within the artificial world of the application 2132.

In some embodiments, the artificial-reality engine 2134 provides feedback to the user that the action was performed. The provided feedback may be visual via the electronic display 2112 in the head-mounted display 2110 (e.g., displaying the simulated hand as it picks up and lifts the virtual coffee mug) and/or haptic feedback via the haptic-feedback mechanism 2122 in the wearable device 2120. For example, the haptic feedback may vibrate in a certain way to simulate the sensation of firing a firearm in an artificial-reality video game. To do this, the wearable device 2120 changes (either directly or indirectly) fluid pressure of one or more of bladders of the haptic-feedback mechanism 2122. When inflated by a threshold amount (and/or inflated at a threshold frequency, such as at least 5 Hz), a respective bladder of the haptic-feedback mechanism 2122 presses against the user's body, resulting in the haptic feedback.

In another example, the haptic-feedback mechanism 2122 may simulate the sensation a user's finger (or fingers) touching and otherwise interacting with a solid object, such as a glass of water. Specifically, the haptic-feedback mechanism 2122 is capable of creating forces on finger phalanges, as one example, in directions that are very similar to the forces induced by physical objects during natural hand-object interaction (i.e., simulate the forces that would actually be felt by a user when he or she touches, lifts, and empties a full glass of water in the real world). To do this, the wearable device 2120 and/or the computer system 2130 changes (either directly or indirectly) a pressurized state inside one or more bladders 2204 of the haptic-feedback mechanism 2122, which results in the user experiencing a shear-compression stimulation. Importantly, the shear forces can be changed dynamically based on the rate at which the glass is being emptied (i.e., a pressure inside the one or more bladders can be changed dynamically based the state of an object in the artificial environment).

In view of the examples above, the wearable device 2120 is used to further immerse the user in artificial-reality experience such that the user not only sees (at least in some instances) the data on the head-mounted display 2110, but the user may also “feel” certain aspects of the displayed data. Moreover, the wearable device 2120 is designed to limit encumbrances imposed onto the user, at least when encumbrances are not desired.

To provide some additional context, the bladders described herein are configured to transition between a first pressurized state and a second pressurized state to provide haptic feedback to the user and/or ground a structure to the user's body. Due to the ever-changing nature of artificial reality, the bladders may be required to transition between the two states hundreds, or perhaps thousands of times, during a single use. Thus, the bladders described herein are durable and designed to quickly transition from state to state (e.g., within 10 milliseconds). In the first pressurized state, a respective bladder is unpressurized (or a fluid pressure inside the respective bladder is below a threshold pressure) and does not provide haptic feedback (or grounding forces) to a portion of the wearer's body. However, once in the second pressurized state (e.g., the fluid pressure inside the respective bladder reaches the threshold pressure), the respective bladder is configured to expand, and impart haptic feedback to the user (for grounding purposes and/or haptic feedback purposes).

FIG. 22 is a schematic of the system 2100 in accordance with some embodiments. The components in FIG. 22 are illustrated in a particular arrangement for ease of illustration and one skilled in the art will appreciate that other arrangements are possible. Moreover, while some example features are illustrated, various other features have not been illustrated for the sake of brevity and so as not to obscure pertinent aspects of the example implementations disclosed herein.

As a non-limiting example, the system 2100 includes a plurality of wearable devices 2120-A, 2120-B, . . . 2120-N, each of which includes at least one haptic-feedback mechanism 2122 having a housing 2202 and one or more bladders 2204-A, 2204-B, . . . 2204-L. In some embodiments, each haptic-feedback mechanism 2122 is configured to secure (i.e., ground) the housing 2202 to a portion of the user's body (e.g., a fingertip). Alternatively or in addition, in some embodiments, each haptic-feedback mechanism 2122 is configured to impart haptic feedback to the portion of the user's body. While not shown, the system 2100 may also include a wearable structure, which can be various articles of clothing (e.g., gloves, socks, shirts, or pants). Each bladder 2204 (e.g., a membrane) is a sealed, inflatable bladder made from a durable, puncture resistance material, such as thermoplastic polyurethane (TPU) or the like. The bladder 2204 is configured to contain a fluid (e.g., air, an inert gas, or some other fluid) that can be added to or removed from the bladder 2204 to change a pressure inside the bladder 2204.

The system 2100 also includes a controller 2214 and a source 2210. In some embodiments, the controller 2214 is part of the computer system 2130 (e.g., the processor of the computer system 2130). The controller 2214 is configured to control operation of the source 2210, and in turn operation of the wearable devices 2120. For example, the controller 2214 may send one or more signals to the source 2210 to activate the source 2210 (e.g., turn it on and off). The one or more signals may specify a desired pressure (e.g., pounds-per-square inch) to be output by the source 2210. Generation of the one or more signals, and in turn the pressure output by the source 2210, may be based on information collected by the sensors 2114, the sensors 2124, or some other information source. For example, the one or more signals may cause the source 2210 to increase the pressure inside a first bladder 2204 at a first time, based on the information collected by the sensors 2114 and/or the sensors 2124 (e.g., the user put on the wearable device 2120). Then, the controller may send one or more additional signals to the source 2210 that cause the source 2210 to further increase the pressure inside the first bladder 2204 at a second time after the first time, based on additional information collected by the sensors 2114 and/or the sensors 2124 (e.g., the user contacts a virtual coffee mug). Further, the one or more signals may cause the source 2210 to inflate one or more bladders 2204 in a first wearable device 2120-A, while one or more bladders 2204 in a second wearable device 2120-B remain unchanged (or the one or more bladders 2204 in the second wearable device 2120-B are inflated to some other pressure). Additionally, the one or more signals may cause the source 2210 to inflate one or more bladders 2204 in a first wearable device 2120-A to a first pressure and inflate one or more other bladders 2204 in the first wearable device 2120-A to a second pressure different from the first pressure. Depending on the number of wearable devices 2120 serviced by the source 2210, and the number of bladders 2204 therein, many different inflation configurations can be achieved through the one or more signals and the examples above are not meant to be limiting.

The system 2100 may include an optional manifold 2212 between the source 2210 and the wearable devices 2120. The manifold 2212 may include one or more valves (not shown) that fluidically (e.g., pneumatically, hydraulically, etc.) couple each of the haptic-feedback mechanisms 2122 (and the bladders 2204 and pockets 2220 therein) with the source 2210 via one or more conduits 2208 (e.g., tubing). In some embodiments, the manifold 2212 is in communication with the controller 2214, and the controller 2214 controls the one or more valves of the manifold 2212 (e.g., the controller generates one or more control signals). The manifold 2212 is configured to switchably couple the source 2210 with haptic-feedback mechanism(s) 2122 of the same or different wearable devices 2120 based on one or more control signals from the controller 2214. In some embodiments, instead of using the manifold 2212 to fluidically couple the source 2210 with a haptic-feedback mechanism 2122, the system 2100 may include multiple sources 2210, where each is fluidically coupled directly with a single (or multiple) bladder(s) 2204. In some embodiments, the source 2210 and the optional manifold 2212 can be configured as part of one or more of the wearable devices 2120 (not illustrated) while, in other embodiments, the source 2210 and the optional manifold 2212 can be configured as external to the wearable device 2120. A single source 2210 may be shared by multiple wearable devices 2120.

In some embodiments, the manifold 2212 includes one or more back-flow valves 2215 that are configured to selectively open and close to regulate fluid flow between the manifold 2212 from the bladders 2204. When closed, the one or more back-flow valves 2215 stop fluid flowing from the bladders 2204 back to the manifold 2212. In some other embodiments, the one or more back-flow valves 2215 are distinct components separate from the manifold 2212.

In some embodiments, the source 2210 is a hydraulic device, a pneudraulic device, or some other device capable of adding and removing a medium/fluid from the one or more grounding assemblies 2122. In other words, the discussion herein is not limited to pneumatic devices, but for ease of discussion, pneumatic devices are used as the primary example in the discussion below. Lastly, the devices shown in FIG. 22 may be coupled via a wired connection (e.g., via busing 108). Alternatively, one or more of the devices shown in FIG. 22 may be wirelessly connected (e.g., via short-range communication signals).

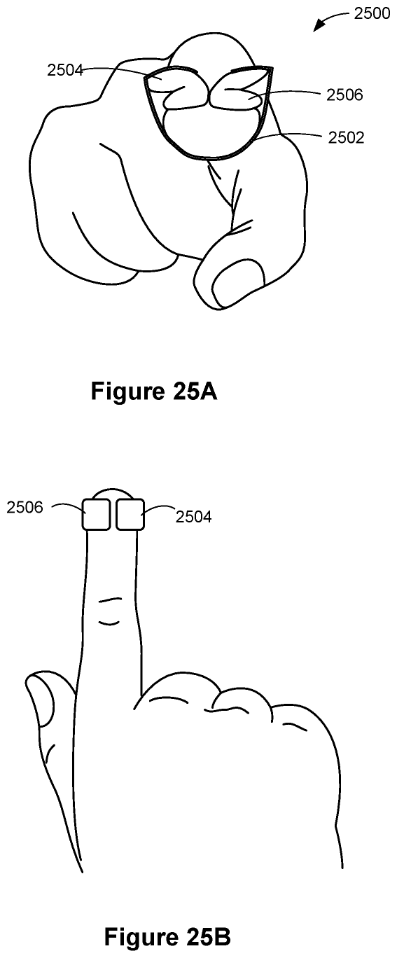

FIG. 23 shows a representative haptic-feedback mechanism 2300 attached to a user's index finger 2308 in accordance with some embodiments. The haptic-feedback mechanism 2300 is an example of the haptic-feedback mechanism 2122 (FIG. 22). While not shown, the haptic-feedback mechanism 2300 may be part of a wearable device 2120 (e.g., a haptic glove) configured to be worn by a user of the system 2100. Like the haptic-feedback mechanism 2122, the haptic-feedback mechanism 2300 is configured to secure a housing 2202 to a portion of the user's body, which, in this case, is the user's fingertip. Also, the haptic-feedback mechanism 2300 may be configured to impart haptic feedback to the portion of the user's body. In some instances, the haptic-feedback mechanism 2300 is referred to herein as a “haptic thimble 2300,” a “haptic assembly 2300,” or a “haptic device 2300.” While not shown in FIG. 23, the haptic-feedback mechanism 2300 can include additional structure to impart a wide variety of haptic feedback onto the user. This additional structure is discussed in further detail below with reference to FIGS. 25A through 28B.

As shown in FIG. 23, the haptic-feedback mechanism 2300 includes a housing 2202. The housing 2202 is designed to receive a portion of the user's index finger 2308 (or some other finger), such as the fingertip. The housing 2202 may have a tapered design that matches a geometry of a human finger (e.g., from left to right, the housing 2202 gradually narrows). In the illustrated embodiment, the housing 2202 includes (i) a first structure 2304-A configured to be positioned on a distal phalange of the user's finger 2308, and (ii) a second structure 2304-B configured to be positioned at a joint connecting the distal phalange and an intermediate phalange of the user's finger 2308. In some other embodiments, the housing 2202 may include one or more additional structures not shown in the illustrated embodiment. For example, the housing 2202 may include a third structure configured to be positioned at a joint connecting the intermediate phalange and a proximal phalange of the user's finger. In another example (potentially in combination with the previous example), the housing 2202 may include an additional structure configured to be positioned at the intermediate phalange, or the proximal phalange of the user's finger. In other words, the housing 2202 may extend from the base of the finger 2308 to the tip of the finger 2308. Note that the housing 2202 may include other structures not shown in FIG. 23 (although similar to those structures shown in FIG. 23) that allow the housing 2202 to couple to other parts of the fingers as well as the user's wrist, forearm, ankle, or leg. The housing 2202 may be made from rigid, semi-rigid, and soft materials (e.g., for improved wearability and comfort).

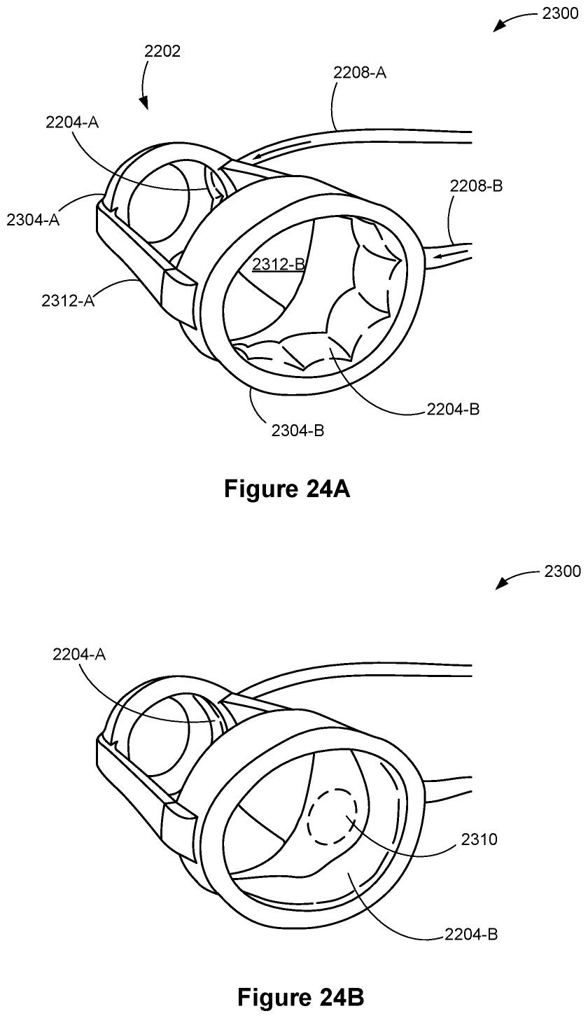

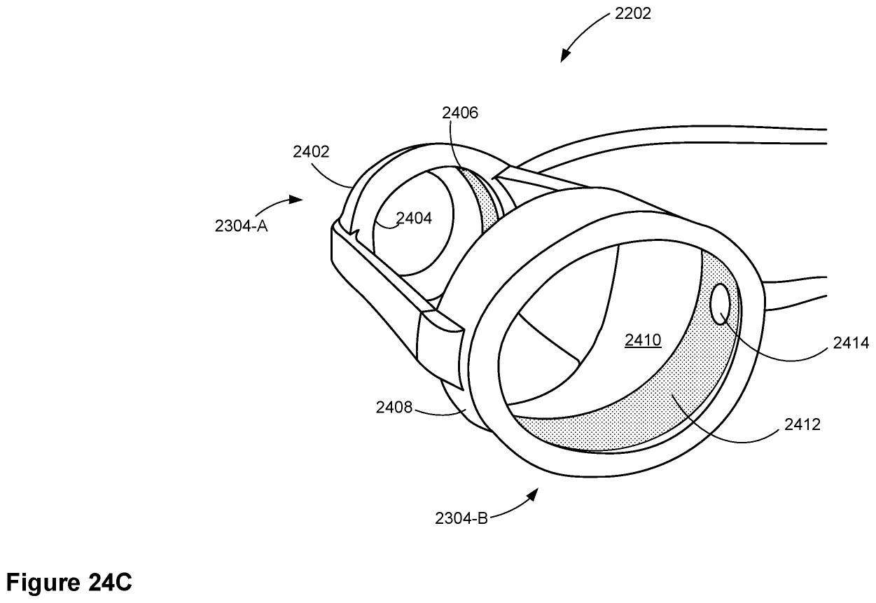

The housing 2202 also includes a first port 2302-A shaped to receive a first conduit 2208-A that is coupled with the fluid source (e.g., source 2210). Notably, the first port 2302-A extends through the housing 2202 to the inner surface of the first structure 2304-A (e.g., port opening 2414, FIG. 24C). The housing 2202 further includes a second port 2302-B shaped to receive a second conduit 2208-B that is coupled with the fluid source. Like the first portion 2302-A, the second port 2302-B extends through the housing 2202 to the inner surface of the second structure 2304-B (e.g., port opening 2414, FIG. 24C). As will be explained in detail below with reference to FIGS. 24A-24B, fluid from the fluid source travels through the first conduit 2208-A to the first port 2302-A and inflates a bladder coupled to an inner surface of the first structure 2304-A. Likewise, fluid from the fluid source travels through the second conduit 2208-B to the second port 2302-B and inflates a bladder coupled to an inner surface of the second structure 2304-B.

In some other embodiments, the housing 2202 includes a single port 2302 that fluidically couples the source with different portions of the housing 2202. In such embodiments, the housing 2202 may include routing from the single port 302 that is configured to route the fluid to the different portions of the housing 2202. In some other embodiments, the housing 2202 includes more than two ports 2302. For example, in those embodiments where the housing 2202 includes additional structure not shown in FIG. 23, the housing 2202 may include one or more additional ports 2302 shaped to receive a respective conduit 2208 that is coupled with the fluid source.

In the illustrated embodiment, the housing 2202 defines a first opening 2305 (or open space) that separates the first structure 2304-A from the second structure 2304-B. The housing 2202 may also define a second opening (or open space) in a portion of the housing 2202 opposite the first opening 2305. Like the first opening 2305, the second opening separates the first structure 2304-A from the second structure 2304-B. The first and second openings are both shown in FIGS. 24A and 24B. The open space collectively formed by the first and second openings allows for other structures to be mounted to the housing 2202 in the open space. The other structures may include actuators that are configured to impart haptic feedback onto the user (e.g., onto portions of the user's body positioned in the open space when the haptic-feedback mechanism 2300 is worn by the user).

As mentioned above, the haptic-feedback mechanism 2300 may be part of a wearable device 2120. In those embodiments, the housing 2202 is coupled to a wearable structure 2306 of the wearable device 2120. The wearable structure 2306 may be a textile material shaped to receive a portion of the user's body, such as the user's hand and fingers. Furthermore, the housing 2202 is coupled to the wearable structure 2306 in such a manner that the housing 2202 can be easily donned and doffed with the wearable structure 2306. Note that the housing 2202, at least in some embodiments, can be detachably coupled to the wearable structure 2306 so that the housing 2202 can be easily detached from the wearable structure 2306, if needed.

FIGS. 24A and 24B show the haptic-feedback mechanism 2300 in different pressure states in accordance with some embodiments. In particular, FIG. 24A shows the haptic-feedback mechanism 2300 in a pressurized state (e.g., inflated state) while FIG. 24B shows the haptic-feedback mechanism 2300 in an unpressurized state. The states of the haptic-feedback mechanism 2300 are discussed in further detail below.

FIGS. 24A and 24B also show additional components of the haptic-feedback mechanism 2300 not shown in FIG. 23. Specifically (and with reference to FIG. 24C), the haptic-feedback mechanism 2300 includes a first bladder 2204-A positioned on an inner surface 2404 of the first structure 2304-A that is fluidically coupled to a fluid source (e.g., by the port 2208-A). The haptic-feedback mechanism 2300 also includes a second bladder 2204-B positioned on an inner surface 2410 of the second structure 2304-B that is fluidically coupled to the fluid source (e.g., by the port 2208-B). Furthermore, in the illustrated embodiment of FIG. 24C, the inner surface 2404 of the first structure 2304-A defines a first channel 2406, and the first bladder 2204-A is positioned in the first channel 2406, as shown in FIGS. 24A and 24B. In addition, in the illustrated embodiment of FIG. 24C, the inner surface 2410 of the second structure 2304-B defines a second channel 2412, and the second bladder 2204-B is positioned in the second channel 2412, as shown in FIGS. 24A and 24B. In some other embodiments, the first structure 2304-A and the second structure 2304-B do not define channels on their respective inner surfaces. In such embodiments, the first bladder 2204-A and the second bladder 2304-B are coupled to the inner surfaces of the first structure 2304-A and the second structure 2304-B, as opposed to being positioned within a respective channel, as shown in FIGS. 24A and 24B.

The first bladder 2204-A is configured to (i) inflate in response to receiving a fluid from the fluid source and (ii) tighten around the distal phalange of the user's finger 2308 when inflated to a desired pressure. Similarly, the second bladder 2204-B is configured to (i) inflate in response to receiving the fluid from the source and (ii) tighten around the joint connecting the distal phalange and the intermediate phalange of the user's finger when inflated to a desired pressure. In doing so, the first bladder 2204-A and the second bladder 2204-B secure the housing 2202 to the user's finger 2308 (i.e., the housing 2202, and the haptic-feedback mechanism 2300 as a whole, are grounded to the user's body). In some embodiments, the first bladder 2204-A and the second bladder 2204-B are inflated to the same pressure (i.e., the desired pressures are the same). In other embodiments, the first bladder 2204-A and the second bladder 2204-B are inflated to a different pressure (i.e., the desired pressures differ).

In some embodiments, the first bladder 2204-A and the second bladder 2204-B are configured to expand equally in all directions. Stated differently, the first bladder 2204-A and the second bladder 2204-B are configured to apply equal pressure to the user's finger (e.g., the user's finger experiences equal pressure in all directions). In some other embodiments, the first bladder 2204-A and/or the second bladder 2204-B are (is) configured to expand unequally. For example, the first bladder 2204-A and the second bladder 2204-B may be designed so that certain portions of the first bladder 2204-A and the second bladder 2204-B expand more than other portions. To illustrate, the first bladder 2204-A (and/or the second bladder 2204-B) may be designed so that a portion of the first bladder 2204-A adjacent to a dorsal surface of the user's finger 2308 expands further than a portion of the first bladder 2204-A adjacent to a palmer surface of the user's finger 2308 (or vice versa). In such a configuration, the first bladder 2204-A pushes the first structure 2304-A (and, in turn, the housing 2202) upwards away from the dorsal surface of the user's finger 2308, which causes the first structure 2304-A to press against the palmer surface of the user's finger 2308. This configuration may also cause an actuator (e.g., actuator 2500 or 2700) coupled to the housing 2202 to also press firmly against the palmer surface of the user's finger 2308. In doing so, the actuator is able to more efficiency and effectively transfer haptic feedback to the user's finger 2308. Thus, the first bladder 2204-A and the second bladder 2204-B not only ground the housing 2202 to the user's body, but are also designed so that actuators coupled to the housing 2202 transfer haptic feedback to the user in an effective manner.

In some embodiments, the haptic-feedback mechanism 2300 includes a sensor 2310 (e.g., a pressure/force sensor) coupled to the inner surface of the housing 2202 (e.g., the inner surface 2410 of the second structure 2304-B). In such embodiments, the sensor 2310 is used to determine a size the user's finger 2308. For example, the sensor 2310 may be configured to measure a gap between the housing 2202 and the user's finger 2308. In some instances, the desired pressures for the first and second bladders 2204-A, 2204-B can be set (e.g., by the controller 2214) based on the size of the user's finger determined by the sensor 2310. For example, the sensor 2310 may determine (it may be determined from information collected by the sensor 2310) that a first user has a first sized finger 2308, while a second user has a second sized finger 2308 that is smaller than the first user's finger. In such an example, the desired pressures for the first and second bladders 2204-A, 2204-B, as applied to the first user, can be set lower relative to the desired pressures for the first and second bladders 2204-A, 2204-B, as applied to the second user. In this way an appropriate force is applied to the first user (and the second user) to secure the haptic-feedback mechanism 2300 to the first user's finger. In some embodiments, the haptic-feedback mechanism 2300 includes multiple instances of the sensor 2310. The sensor 2310 may also be used to determine a grounding force applied to the user by the first and second bladders 2204-A, 2204-B. In such embodiments, the desired pressures for the first and second bladders 2204-A, 2204-B can be adjusted according to the amount of grounding force applied to the user.

As shown in FIG. 24A (and FIG. 24B), the housing 2202 includes support structures 2312-A and 2312-B linking the first structure 2304-A with the second structure 2304-B. In some embodiments, the housing 2202 is unitary component, meaning that the first structure 2304-A, the second structure 2304-B, and the support structures 2312-A, 2312-B are integrally formed together. To accomplish this, the housing 2202 may be made during an injection molding operation (or multiple injection molding operations). In some embodiments, the first structure 2304-A, the second structure 2304-B, and the support structures 2312-A, 2312-B are formed from the same or different materials. In some embodiments, at least one of the first structure 2304-A, the second structure 2304-B, and the support structures 2312-A, 2312-B is fabricated separately, and attached with the other components using mechanical and/or chemical fasteners. The housing 2202 may be formed from commodity and engineering thermoplastics. Alternatively, the housing 2202 may be formed from thermosetting polymers or metals.

FIGS. 25A and 25B show an example actuator 2500 to be included with an example haptic-feedback mechanism 2122 in accordance with some embodiments. For ease of illustration, the haptic-feedback mechanism is not shown in FIGS. 25A and 25B, along with some other components associated with the actuator 2500. For example, the actuator 2500 may be couple with one or more conduits 2208 that provide fluid to the actuator 2500 from a fluid source.

As shown in FIG. 25A, the actuator 2500 includes a belt 2502 that wraps, at least partially, around the user's finger. The belt 2502 (e.g., strap) may be an elastic or inelastic material that pushes and/or slides against the user's finger when pulled. In some embodiments, the belt 2502 includes a texturized surface that is designed to interact with (i.e., contact) the user's skin, in order to create friction between the belt 2502 and the user's finger. In addition to texture, the belt 2502 may include heating/cooling elements to simulate heat transfer properties of the surfaces. The actuator 2500 also includes a first inflatable pocket 2504 coupled to a first end portion of the belt 2502 and a second inflatable pocket 2506 coupled to a second end portion of the belt 2502. The first inflatable pocket 2504 and the second inflatable pocket 2506 are examples of the bladder 2204 (FIG. 22), such that each inflatable pocket is made from a durable, puncture resistance material, such as TPU or the like. As shown in FIG. 25B, the first inflatable pocket 2504 and the second inflatable pocket 2506 are positioned adjacent to each other on a distal phalange of the user's finger. In other words, the first inflatable pocket 2504 and the second inflatable pocket 2506 are horizontally aligned with each other.

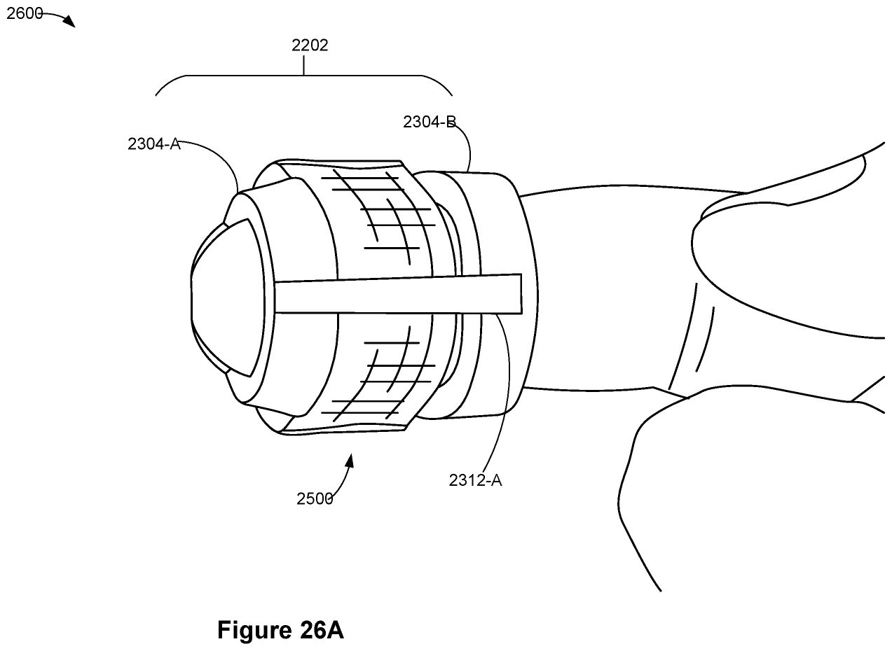

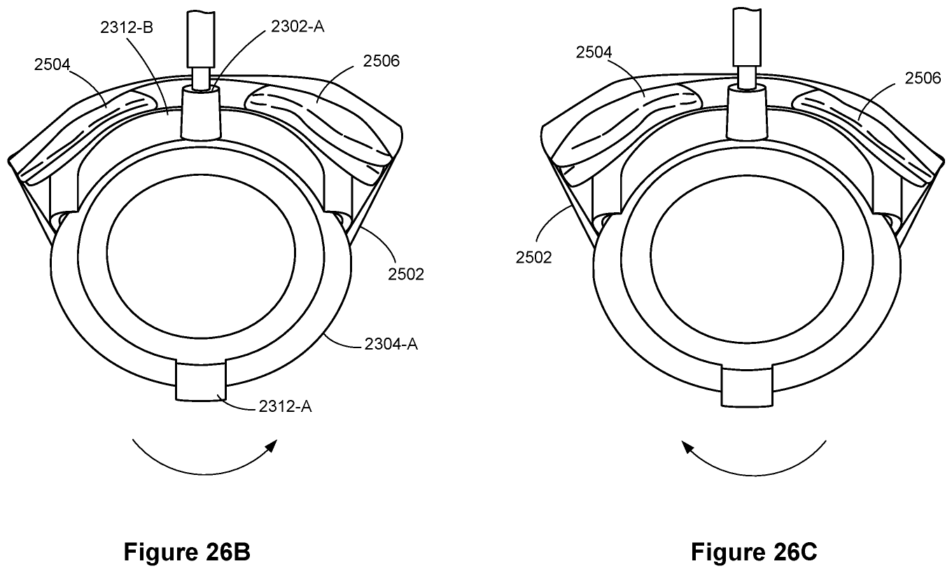

While not shown, the first inflatable pocket 2504 may be fluidically coupled to a fluid source by a first conduit 2208, and the second inflatable pocket 2506 may be fluidically coupled to the fluid source by a second conduit 2208. In this way, the first inflatable pocket 2504 and the second inflatable pocket 2506 can be individually serviced by the fluid source. For example, in the illustrated embodiment, the first inflatable pocket 2504 and the second inflatable pocket 2506 are both inflated, such that the belt 2502 is pulled equally by the first inflatable pocket 2504 and the second inflatable pocket 2506. In some other embodiments, one the first inflatable pocket 2504 is inflated while the second inflatable pocket 2506 is not inflated, or vice versa. In such embodiments, the belt 2502 is pulled clockwise or counterclockwise, which creates a shear stimulation against the user's body. Creating shear stimulations is discussed in further detail below with reference to FIGS. 26B and 26C.

Note that in FIG. 25A the first inflatable pocket 2504 and the second inflatable pocket 2506 are both inflated. However, when not inflatable, the first inflatable pocket 2504 and the second inflatable pocket 2506 are configured to collapse, thereby releasing any tension in the belt 2702.

FIGS. 26A through 26C show varies views of a representative haptic-feedback mechanism 2600 in accordance with some embodiments. The representative haptic-feedback mechanism 2600 is similar to the representative haptic-feedback mechanism 2300 of FIG. 23, in that the representative haptic-feedback mechanism 2600 includes the housing 2202. The representative haptic-feedback mechanism 2600 differs from the representative haptic-feedback mechanism 2300 in that it includes an actuator 2500 (FIGS. 25A and 25B) attached to the housing 2202. Thus, the representative haptic-feedback mechanism 2600 can create grounding forces and shear-based haptic stimulations.

FIG. 26A shows a bottom view of the representative haptic-feedback mechanism 2600. As shown, the actuator 2500 is positioned in the open space defined by the housing 2202 between the first structure 2304-A and the second structure 2304-B. Furthermore, the actuator 2500 is positioned inside the support structure 312-A, such that the belt 2502 of the actuator 2500 is in contact with (or is configured to contact) the user's body.

FIG. 26B shows a front view of the representative haptic-feedback mechanism 2600. In particular, in FIG. 26B, the second inflatable pocket 2506 is pressurized/inflated while the first inflatable pocket 2504 is not pressurized (e.g., at ambient pressure). In such circumstances, the second inflatable pocket 2506 pulls the belt 2502 counterclockwise (as indicted by the arrow in FIG. 26B), such that the belt 2502 rubs against the user's finger in the counterclockwise direction, thereby creating a first shear stimulation.

FIG. 26C also shows a front view of the representative haptic-feedback mechanism 2600. In FIG. 26C, the first inflatable pocket 2504 is pressurized/inflated while the second inflatable pocket 2506 is not pressurized (e.g., at ambient pressure). In such circumstances, the first inflatable pocket 2504 pulls the belt 2502 clockwise (as indicted by the arrow in FIG. 26C), such that the belt 2502 rubs against the user's finger in the clockwise direction, thereby creating a second shear stimulation.

While not shown in FIGS. 26A-26C, the first bladder 2304-A and the second bladder 2304-B may be inflated to their respective desired pressured when the first inflatable pocket 2504 and/or the second inflatable pocket 2506 is (are) pressurized. In this way, the first bladder 2304-A and the second bladder 2304-B prevent the housing 2202 from twisting or otherwise rotating when the first inflatable pocket 2504 and/or the second inflatable pocket 2506 pull(s) on the belt 2502. As a result, the user is not distracted by the housing 2202 potentially moving, allowing him or her to concentrate on the haptic feedback created by the actuator 2500. Also, the first inflatable pocket 2504 and the second inflatable pocket 2506 may be inflated simultaneously to the same or different pressures.

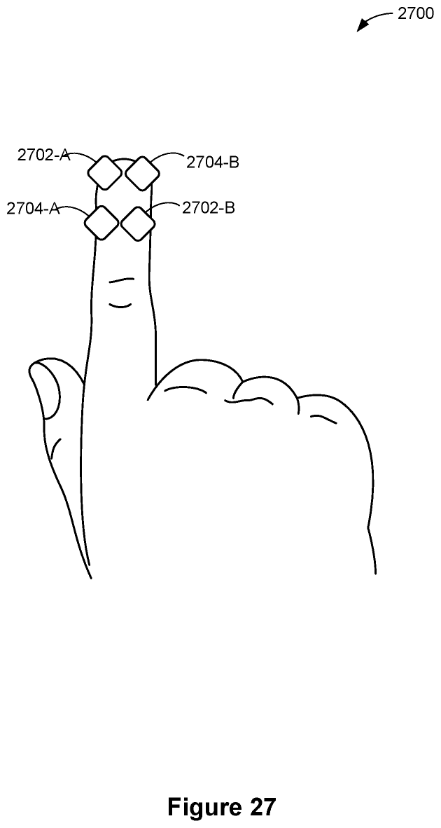

FIG. 27 shows another example actuator 2700 to be included with an example haptic-feedback mechanism 2122 in accordance with some embodiments. For ease of illustration, the haptic-feedback mechanism is not shown in FIG. 27, along with some other components associated with the actuator 2700. For example, the actuator 2700 may be coupled with one or more conduits 2208 that provide fluid to the actuator 2700 from a fluid source.

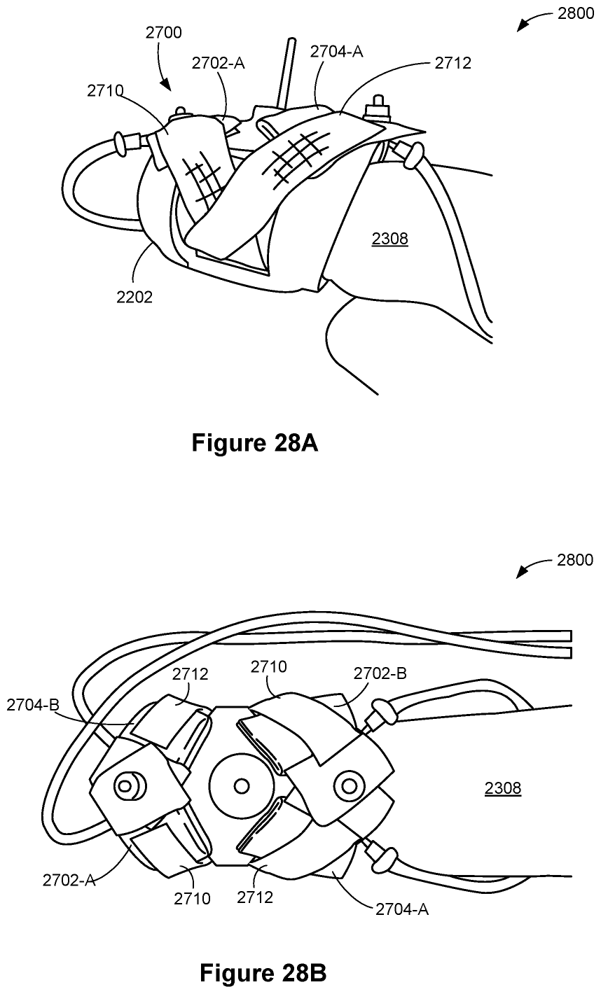

The actuator 2700 includes four inflatable pockets: (i) a first inflatable pocket 2702-A linked to a second inflatable pocket 2702-B by a first belt 2710 (shown in FIG. 28A), and (ii) a third inflatable pocket 2704-A linked to a fourth inflatable pocket 2704-B by a second belt 2712 (shown in FIG. 28A). Unlike the inflatable pockets 2504, 2506 of the actuator 2500, the first inflatable pocket 2702-A and the second inflatable pocket 2702-B are not horizontally aligned. Rather, the first inflatable pocket 2702-A and the second inflatable pocket 2702-B are vertically offset from each other. Likewise, the third inflatable pocket 2704-A and the fourth inflatable pocket 2704-B are vertically offset from each other, such that the first belt 2710 and the second belt 2712 crossover each other, as shown in FIG. 28A. The four pocket design of the actuator 2700 allows for additional shear forces to be created, relative to the two pocket design of the actuator 2500. For example, the two pocket design of the actuator 2500 can generate one degree-of-freedom of shear and compression forces. In contrast, the four pocket design of the actuator 2700 can generate two degrees-of-freedom of shear and compression forces.

FIGS. 28A and 28B show varies views of a representative haptic-feedback mechanism 2800 in accordance with some embodiments. The representative haptic-feedback mechanism 2800 is similar to the representative haptic-feedback mechanism 2300 of FIG. 23 and the representative haptic-feedback mechanism 2600 of FIG. 26A, in that the representative haptic-feedback mechanism 2800 includes the housing 2202. The representative haptic-feedback mechanism 2800 differs from the representative haptic-feedback mechanism 2600 in that it includes the actuator 2700 (FIG. 27) attached to the housing 2202.

FIG. 28A shows a side view of the representative haptic-feedback mechanism 2800. As shown, the actuator 2700 is positioned in the open space defined by the housing 2202 between the first structure 2304-A and the second structure 2304-B (not labelled). Furthermore, the actuator 2700 is positioned inside the support structure 2312-A (not labelled), such that the first belt 2710 and the second belt 2712 of the actuator 2700 are in contact with (or is configured to contact) the user's body.

FIG. 28B shows a top view of the representative haptic-feedback mechanism 2800. As shown, each inflatable pocket 2702-A, 2702-B, 2704-A, 2704-B is coupled to a distinct conduit 2208. In this way, the inflatable bladders/pockets of the actuator 2700 can be individually serviced by the fluid source, such that numerous inflation configurations are possible with the actuator 2700. For example, in FIG. 28B, the first inflatable pocket 2702-A and the fourth inflatable pocket 2704-B are inflated while the second inflatable pocket 2702-B and the third inflatable pocket 2704-A are not inflated. In this configuration, the representative haptic-feedback mechanism 2800 imparts a first shear stimulation onto the user's finger 2308.

In some embodiments, a representative haptic-feedback mechanism is provided that is a combination of the representative haptic-feedback mechanism 2600 and the representative haptic-feedback mechanism 2800. Put another way, this additional representative haptic-feedback mechanism includes the actuator 2500 and the actuator 2700. For example, and with reference to FIG. 28B, the additional representative haptic-feedback mechanism would include the belt 2502, the first inflatable pocket 2504, and the second inflatable pocket 2506 positioned in the space between the components of the actuator 2700 shown in FIG. 28B.

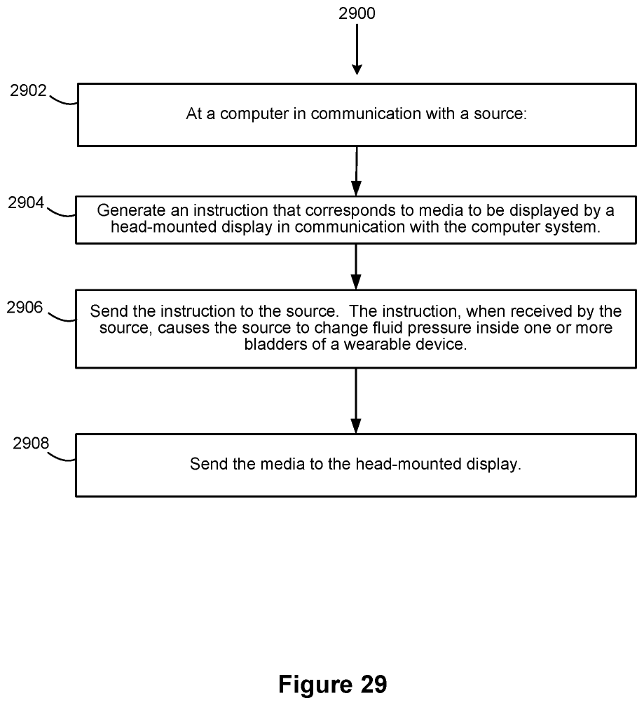

FIG. 29 is a flow diagram illustrating a method 2900 of managing creation of grounding and haptic forces in accordance with some embodiments. The steps of the method 2900 may be performed by a computer (e.g., computer system 2130, FIG. 21) (2902). FIG. 29 corresponds to instructions stored in a computer memory or computer readable storage medium (e.g., memory of the computer system 2130). For example, the operations of method 2900 are performed, at least in part, by a communication interface 2136 and an artificial-reality generation module (e.g., part of engine 2134, FIG. 21). It is noted that the method 2900 described below can be implemented with any of the haptic-feedback mechanisms discussed above.

In some embodiments, the method 2900 includes generating (2904) an instruction that corresponds to information to be displayed by a head-mounted display in communication the computer system (and/or corresponds to information received from one or more sensors 2124 of the wearable device 2120 and/or information received from one or more sensors 2114 of the head-mounted display 2110). Alternatively or in addition, in some embodiments, the computer system generates the instruction based on information received from the sensors on the wearable device. For example, the information received from the sensors may indicate that a user has donned (or doffed) the wearable device. In another example, the information received from the sensors may indicate that the user is making a fist (or some other recognizable body movement). Alternatively or in addition, in some embodiments, the computer system generates the instruction based on information received from the sensors on the head-mounted display. For example, cameras (or other sensors) on the head-mounted display may capture movements of the wearable device, and the computer system can use this information when generating the instruction.

The method 2900 further includes sending (2906) the instruction to a source (e.g., source 2210) in communication with the computer system (e.g., send the instruction in a communication signal from a communication interface). The instruction, when received by the source, causes the source to change a state of a haptic-feedback mechanism of the wearable device (i.e., change a pressure inside one or more bladders (or pockets) of the haptic-feedback mechanism). In doing so, a user/wearer of the wearable device will experience a stimulation that corresponds to the information gathered in step 2904. To illustrate, in the example above where the information received from the sensors indicates that the user has donned the wearable device, the user may experience a stimulation of a haptic-feedback mechanism incorporated in the wearable device tightening around one or more portions of the user's body (e.g., bladders 2204 in the housing 2202 tighten around the user's fingertip). The tightening in the case is a somewhat subtle force that secures the wearable device and the haptic-feedback mechanism to the user. In other examples, the tightening is less subtle, and is used in those situations where a substantial force is needed to secure the haptic-feedback mechanism to the user. This substantial force may be needed when an actuator (e.g., actuator 2500, or actuator 2700) is about to impart a haptic stimulation to the user, as the substantial force helps to couple/secure the haptic actuator to the user at a target location (i.e., so that forces generated by the haptic actuator are effectively transferred to the user's body).

In some embodiments, sending the instruction to the source includes (i) sending a first instruction to the source at a first time that, when received by the source, causes the source to pressurize one or more bladders of the haptic-feedback mechanism to a first pressure, and (ii) sending a second instruction to the source at a second time (after the first time) that, when received by the source, causes the source to pressurize the one or more bladders of the haptic-feedback mechanism to a second pressure that is greater than the first pressure. In such embodiments, the first instruction may be generated in response to receiving information from the sensors indicating that the user has donned the wearable device. In this case, the one or more bladders of the haptic-feedback mechanism, when pressurized to the first pressure, apply subtle force that secures the wearable device to the user's body. The second instruction, in contrast, may be generated when a substantial force is needed to secure an actuator to the user. In this case, the one or more bladders of the haptic-feedback mechanism, when pressurized to the second pressure, apply a substantial force to the user's body.

In some embodiments, sending the instruction to the source includes (i) sending a first instruction to the source at a first time that, when received by the source, causes the source to pressurize one or more bladders of the housing 2202 to a first pressure, and (ii) sending a second instruction to the source at a second time (after the first time) that, when received by the source, causes the source to pressurize one or more other bladders to a second pressure that may or may not be greater than the first pressure. Note that the one or more other bladders are part of an actuator (e.g., the actuator 2500 or the actuator 2700), and are configured to impart a haptic stimulation to the user, such as a shear-compression stimulation.

In some embodiments, the instruction specifies the change in the pressure to be made by the source. It is noted that in some situations, instead of the computer system sending the instruction to the source, the computer system sends the instruction to the wearable device. In response to receiving the instruction, the wearable device sends the instruction to the source. The source is discussed in further detail above with reference to FIG. 22.

After (or while, or before) sending the instruction, the method 2900 may include sending (2908) data to the head-mounted display for the information to be displayed by the head-mounted display. For example, the head-mounted display may receive visual data from the computer system, and may in turn display the visual data on its display(s). As an example, if the computer system receives information from the sensors 2124 of the wearable device 2120 that the user has closed his fingers around a position corresponding to a coffee mug in the virtual environment and raised his hand, a simulated hand in an artificial-reality application picks up the virtual coffee mug and lifts it to a corresponding height. Generating and sending visual data is discussed in further detail above with reference to FIG. 21.

Embodiments of this disclosure may include or be implemented in conjunction with various types of artificial-reality systems. Artificial reality may constitute a form of reality that has been altered by virtual objects for presentation to a user. Such artificial reality may include and/or represent virtual reality (VR), augmented reality (AR), mixed reality (MR), hybrid reality, or some combination and/or variation of one or more of the these. Artificial-reality content may include completely generated content or generated content combined with captured (e.g., real-world) content. The artificial-reality content may include video, audio, haptic feedback, or some combination thereof, any of which may be presented in a single channel or in multiple channels (such as stereo video that produces a three-dimensional effect to a viewer). Additionally, in some embodiments, artificial reality may also be associated with applications, products, accessories, services, or some combination thereof, which are used, for example, to create content in an artificial reality and/or are otherwise used in (e.g., to perform activities in) an artificial reality.

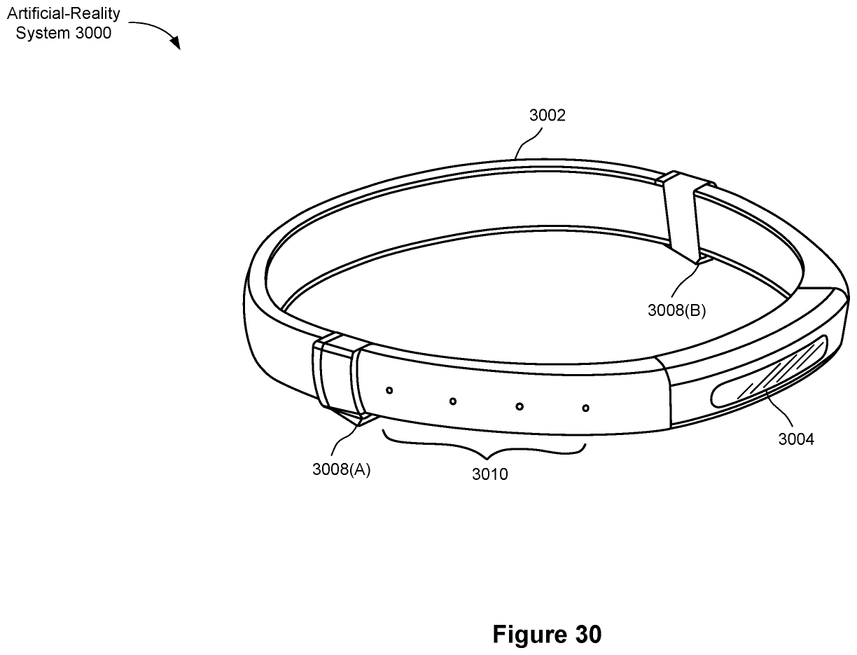

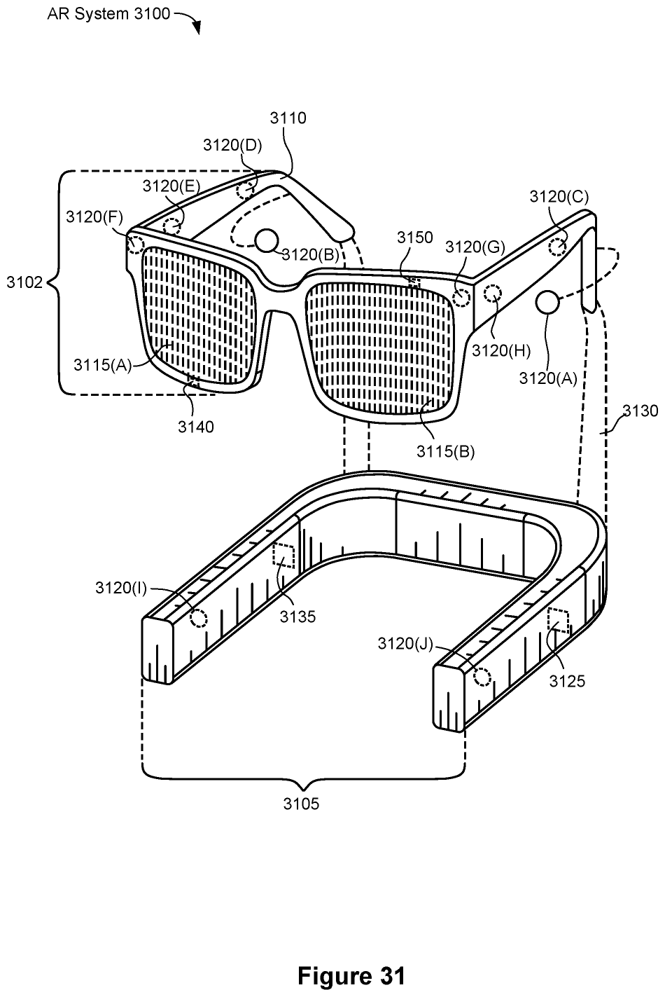

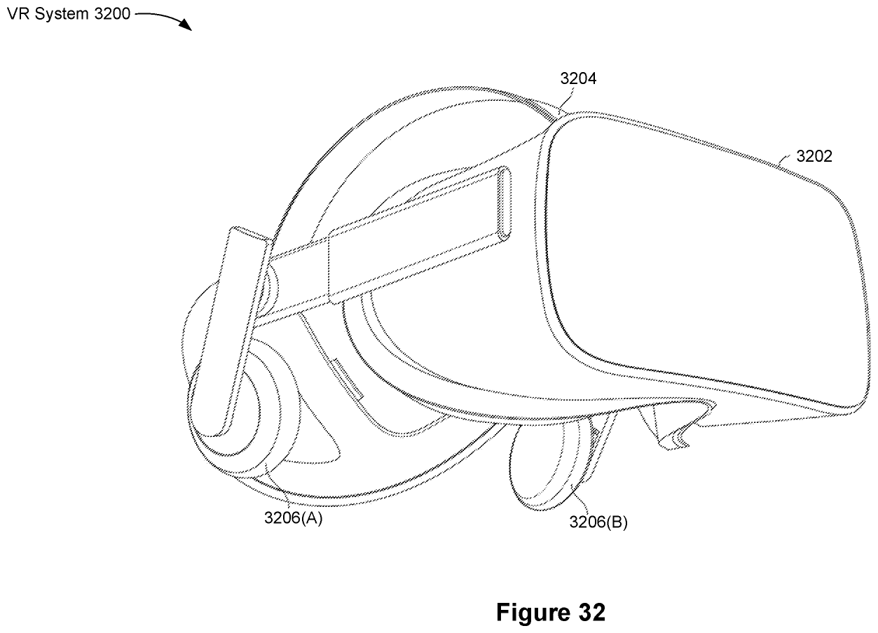

Artificial-reality systems may be implemented in a variety of different form factors and configurations. Some artificial-reality systems are designed to work without near-eye displays (NEDs), an example of which is the artificial-reality system 3000 in FIG. 30. Other artificial-reality systems include an NED, which provides visibility into the real world (e.g., the augmented-reality (AR) system 3100 in FIG. 31) or that visually immerses a user in an artificial reality (e.g., the virtual-reality (VR) system 3200 in FIG. 32). While some artificial-reality devices are self-contained systems, other artificial-reality devices communicate and/or coordinate with external devices to provide an artificial-reality experience to a user. Examples of such external devices include handheld controllers, mobile devices, desktop computers, devices worn by a user (e.g., wearable device 2120), devices worn by one or more other users, and/or any other suitable external system.

FIGS. 30-32 provide additional examples of the devices used in a system 2100. The artificial-reality system 3000 in FIG. 30 generally represents a wearable device dimensioned to fit about a body part of a user. The artificial-reality system 3000 may include the functionality of a wearable device, and may include functions not described above. As shown, the artificial-reality system 3000 includes a frame 3002 (e.g., a band or wearable structure) and a camera assembly 3004, which is coupled to the frame 3002 and configured to gather information about a local environment by observing the local environment (and may include a display 3004 that displays a user interface). In some embodiments, the artificial-reality system 3000 includes output transducers 3008(A) and 3008(B) and input transducers 3010. The output transducers 3008(A) and 3008(B) may provide audio feedback, haptic feedback, and/or content to a user, and the input audio transducers may capture audio (or other signals/waves) in a user's environment.

Thus, the artificial-reality system 3000 does not include a near-eye display (NED) positioned in front of a user's eyes. Artificial-reality systems without NEDs may take a variety of forms, such as head bands, hats, hair bands, belts, watches, wrist bands, ankle bands, rings, neckbands, necklaces, chest bands, eyewear frames, and/or any other suitable type or form of apparatus. While the artificial-reality system 3000 may not include an NED, the artificial-reality system 3000 may include other types of screens or visual feedback devices (e.g., a display screen integrated into a side of the frame 3002).

The embodiments discussed in this disclosure may also be implemented in artificial-reality systems that include one or more NEDs. For example, as shown in FIG. 31, the AR system 3100 may include an eyewear device 3102 with a frame 3110 configured to hold a left display device 3115(B) and a right display device 3115(A) in front of a user's eyes. The display devices 3115(A) and 3115(B) may act together or independently to present an image or series of images to a user. While the AR system 3100 includes two displays, embodiments of this disclosure may be implemented in AR systems with a single NED or more than two NEDs.

In some embodiments, the AR system 3100 includes one or more sensors, such as the sensors 3140 and 3150 (examples of sensors 2114, FIG. 21). The sensors 3140 and 3150 may generate measurement signals in response to motion of the AR system 3100 and may be located on substantially any portion of the frame 3110. Each sensor may be a position sensor, an inertial measurement unit (IMU), a depth camera assembly, or any combination thereof. The AR system 3100 may or may not include sensors or may include more than one sensor. In embodiments in which the sensors include an IMU, the IMU may generate calibration data based on measurement signals from the sensors. Examples of the sensors include, without limitation, accelerometers, gyroscopes, magnetometers, other suitable types of sensors that detect motion, sensors used for error correction of the IMU, or some combination thereof. Sensors are also discussed above with reference to FIG. 21.

The AR system 3100 may also include a microphone array with a plurality of acoustic sensors 3120(A)-3120(J), referred to collectively as the acoustic sensors 3120. The acoustic sensors 3120 may be transducers that detect air pressure variations induced by sound waves. Each acoustic sensor 3120 may be configured to detect sound and convert the detected sound into an electronic format (e.g., an analog or digital format). The microphone array in FIG. 31 may include, for example, ten acoustic sensors: 3120(A) and 3120(B), which may be designed to be placed inside a corresponding ear of the user, acoustic sensors 3120(C), 3120(D), 3120(E), 3120(F), 3120(G), and 3120(H), which may be positioned at various locations on the frame 3110, and/or acoustic sensors 3120(I) and 3120(J), which may be positioned on a corresponding neckband 3105. In some embodiments, the neckband 3105 is an example of a computer system.

The configuration of the acoustic sensors 3120 of the microphone array may vary. While the AR system 3100 is shown in FIG. 31 having ten acoustic sensors 3120, the number of acoustic sensors 3120 may be greater or less than ten. In some embodiments, using more acoustic sensors 3120 may increase the amount of audio information collected and/or the sensitivity and accuracy of the audio information. In contrast, using a lower number of acoustic sensors 3120 may decrease the computing power required by a controller 3125 to process the collected audio information. In addition, the position of each acoustic sensor 3120 of the microphone array may vary. For example, the position of an acoustic sensor 3120 may include a defined position on the user, a defined coordinate on the frame 3110, an orientation associated with each acoustic sensor, or some combination thereof.

The acoustic sensors 3120(A) and 3120(B) may be positioned on different parts of the user's ear, such as behind the pinna or within the auricle or fossa. In some embodiments, there are additional acoustic sensors on or surrounding the ear in addition to acoustic sensors 3120 inside the ear canal. Having an acoustic sensor positioned next to an ear canal of a user may enable the microphone array to collect information on how sounds arrive at the ear canal. By positioning at least two of the acoustic sensors 3120 on either side of a user's head (e.g., as binaural microphones), the AR device 3100 may simulate binaural hearing and capture a 3D stereo sound field around about a user's head. In some embodiments, the acoustic sensors 3120(A) and 3120(B) may be connected to the AR system 3100 via a wired connection, and in other embodiments, the acoustic sensors 3120(A) and 3120(B) may be connected to the AR system 3100 via a wireless connection (e.g., a Bluetooth connection). In still other embodiments, the acoustic sensors 3120(A) and 3120(B) may not be used at all in conjunction with the AR system 3100.

The acoustic sensors 3120 on the frame 3110 may be positioned along the length of the temples, across the bridge, above or below the display devices 3115(A) and 3115(B), or some combination thereof. The acoustic sensors 3120 may be oriented such that the microphone array is able to detect sounds in a wide range of directions surrounding the user wearing AR system 3100. In some embodiments, an optimization process may be performed during manufacturing of the AR system 3100 to determine relative positioning of each acoustic sensor 3120 in the microphone array.

The AR system 3100 may further include or be connected to an external device (e.g., a paired device), such as a neckband 3105. As shown, the neckband 3105 may be coupled to the eyewear device 3102 via one or more connectors 3130. The connectors 3130 may be wired or wireless connectors and may include electrical and/or non-electrical (e.g., structural) components. In some cases, the eyewear device 3102 and the neckband 3105 operate independently without any wired or wireless connection between them. While FIG. 31 illustrates the components of the eyewear device 3102 and the neckband 3105 in example locations on the eyewear device 3102 and the neckband 3105, the components may be located elsewhere and/or distributed differently on the eyewear device 3102 and/or on the neckband 3105. In some embodiments, the components of the eyewear device 3102 and the neckband 3105 may be located on one or more additional peripheral devices paired with the eyewear device 3102, the neckband 3105, or some combination thereof. Furthermore, the neckband 3105 generally represents any type or form of paired device. Thus, the following discussion of neckband 3105 may also apply to various other paired devices, such as smart watches, smart phones, wrist bands, other wearable devices, hand-held controllers, tablet computers, or laptop computers.

Pairing external devices, such as a neckband 3105, with AR eyewear devices may enable the eyewear devices to achieve the form factor of a pair of glasses while still providing sufficient battery and computation power for expanded capabilities. Some or all of the battery power, computational resources, and/or additional features of the AR system 3100 may be provided by a paired device or shared between a paired device and an eyewear device, thus reducing the weight, heat profile, and form factor of the eyewear device overall while still retaining desired functionality. For example, the neckband 3105 may allow components that would otherwise be included on an eyewear device to be included in the neckband 3105 because users may tolerate a heavier weight load on their shoulders than they would tolerate on their heads. The neckband 3105 may also have a larger surface area over which to diffuse and disperse heat to the ambient environment. Thus, the neckband 3105 may allow for greater battery and computation capacity than might otherwise have been possible on a stand-alone eyewear device. Because weight carried in the neckband 3105 may be less invasive to a user than weight carried in the eyewear device 3102, a user may tolerate wearing a lighter eyewear device and carrying or wearing the paired device for greater lengths of time than the user would tolerate wearing a heavy standalone eyewear device, thereby enabling an artificial-reality environment to be incorporated more fully into a user's day-to-day activities.

The neckband 3105 may be communicatively coupled with the eyewear device 3102 and/or to other devices (e.g., a wearable device). The other devices may provide certain functions (e.g., tracking, localizing, depth mapping, processing, storage, etc.) to the AR system 3100. In the embodiment of FIG. 31, the neckband 3105 includes two acoustic sensors 3120(I) and 3120(J), which are part of the microphone array (or potentially form their own microphone subarray). The neckband 3105 includes a controller 3125 and a power source 3135.

The acoustic sensors 3120(I) and 3120(J) of the neckband 3105 may be configured to detect sound and convert the detected sound into an electronic format (analog or digital). In the embodiment of FIG. 31, the acoustic sensors 3120(1) and 3120(J) are positioned on the neckband 3105, thereby increasing the distance between neckband acoustic sensors 3120(1) and 3120(J) and the other acoustic sensors 3120 positioned on the eyewear device 3102. In some cases, increasing the distance between the acoustic sensors 3120 of the microphone array improves the accuracy of beamforming performed via the microphone array. For example, if a sound is detected by the acoustic sensors 3120(C) and 3120(D) and the distance between acoustic sensors 3120(C) and 3120(D) is greater than, for example, the distance between the acoustic sensors 3120(D) and 3120(E), the determined source location of the detected sound may be more accurate than if the sound had been detected by the acoustic sensors 3120(D) and 3120(E).

The controller 3125 of the neckband 3105 may process information generated by the sensors on the neckband 3105 and/or the AR system 3100. For example, the controller 3125 may process information from the microphone array, which describes sounds detected by the microphone array. For each detected sound, the controller 3125 may perform a direction of arrival (DOA) estimation to estimate a direction from which the detected sound arrived at the microphone array. As the microphone array detects sounds, the controller 3125 may populate an audio data set with the information. In embodiments in which the AR system 3100 includes an IMU, the controller 3125 may compute all inertial and spatial calculations from the IMU located on the eyewear device 3102. The connector 3130 may convey information between the AR system 3100 and the neckband 3105 and between the AR system 3100 and the controller 3125. The information may be in the form of optical data, electrical data, wireless data, or any other transmittable data form. Moving the processing of information generated by the AR system 3100 to the neckband 3105 may reduce weight and heat in the eyewear device 3102, making it more comfortable to a user.

The power source 3135 in the neckband 3105 may provide power to the eyewear device 3102 and/or to the neckband 3105. The power source 3135 may include, without limitation, lithium-ion batteries, lithium-polymer batteries, primary lithium batteries, alkaline batteries, or any other form of power storage. In some cases, the power source 3135 may be a wired power source. Including the power source 3135 on the neckband 3105 instead of on the eyewear device 3102 may help better distribute the weight and heat generated by the power source 3135.

As noted, some artificial-reality systems may, instead of blending an artificial-reality with actual reality, substantially replace one or more of a user's sensory perceptions of the real world with a virtual experience. One example of this type of system is a head-worn display system, such as the VR system 3200 in FIG. 32, which mostly or completely covers a user's field of view. The VR system 3200 may include a front rigid body 3202 and a band 3004 shaped to fit around a user's head. In some embodiments, the VR system 3200 includes output audio transducers 3206(A) and 3206(B), as shown in FIG. 32. Furthermore, while not shown in FIG. 32, the front rigid body 3202 may include one or more electronic elements, including one or more electronic displays, one or more IMUs, one or more tracking emitters or detectors, and/or any other suitable device or system for creating an artificial-reality experience.

Artificial-reality systems may include a variety of types of visual feedback mechanisms. For example, display devices in the AR system 3100 and/or the VR system 3200 may include one or more liquid-crystal displays (LCDs), light emitting diode (LED) displays, organic LED (OLED) displays, and/or any other suitable type of display screen. Artificial-reality systems may include a single display screen for both eyes or may provide a display screen for each eye, which may allow for additional flexibility for varifocal adjustments or for correcting a user's refractive error. Some artificial-reality systems also include optical subsystems having one or more lenses (e.g., conventional concave or convex lenses, Fresnel lenses, or adjustable liquid lenses) through which a user may view a display screen. These systems and mechanisms are discussed in further detail above with reference to FIG. 21.

In addition to or instead of using display screens, some artificial-reality systems include one or more projection systems. For example, display devices in the AR system 3100 and/or the VR system 3200 may include micro-LED projectors that project light (e.g., using a waveguide) into display devices, such as clear combiner lenses that allow ambient light to pass through. The display devices may refract the projected light toward a user's pupil and may enable a user to simultaneously view both artificial-reality content and the real world. Artificial-reality systems may also be configured with any other suitable type or form of image projection system.

Artificial-reality systems may also include various types of computer vision components and subsystems. For example, the AR system 3000, the AR system 3100, and/or the VR system 3200 may include one or more optical sensors such as two-dimensional (2D) or three-dimensional (3D) cameras, time-of-flight depth sensors, single-beam or sweeping laser rangefinders, 3D LiDAR sensors, and/or any other suitable type or form of optical sensor. An artificial-reality system may process data from one or more of these sensors to identify a location of a user, to map the real world, to provide a user with context about real-world surroundings, and/or to perform a variety of other functions.

Artificial-reality systems may also include one or more input and/or output audio transducers. In the examples shown in FIGS. 30 and 32, the output audio transducers 3008(A), 3008(B), 3206(A), and 3206(B) may include voice coil speakers, ribbon speakers, electrostatic speakers, piezoelectric speakers, bone conduction transducers, cartilage conduction transducers, and/or any other suitable type or form of audio transducer. Similarly, the input audio transducers 3010 may include condenser microphones, dynamic microphones, ribbon microphones, and/or any other type or form of input transducer. In some embodiments, a single transducer may be used for both audio input and audio output.

The artificial reality systems shown in FIGS. 30-32 may include tactile (i.e., haptic) feedback systems, which may be incorporated into headwear, gloves, body suits, handheld controllers, environmental devices (e.g., chairs or floormats), and/or any other type of device or system, such as the wearable devices 2120 discussed herein. Additionally, in some embodiments, the haptic feedback systems may be incorporated with the artificial reality systems (e.g., systems 3000, 3100, and 3200 may include the wearable device 2120 shown in FIG. 21). Haptic feedback systems may provide various types of cutaneous feedback, including vibration, force, traction, shear, texture, and/or temperature. Haptic feedback systems may also provide various types of kinesthetic feedback, such as motion and compliance. Haptic feedback may be implemented using motors, piezoelectric actuators, fluidic systems, and/or a variety of other types of feedback mechanisms. Haptic feedback systems may be implemented independently of other artificial reality devices, within other artificial reality devices, and/or in conjunction with other artificial reality devices.

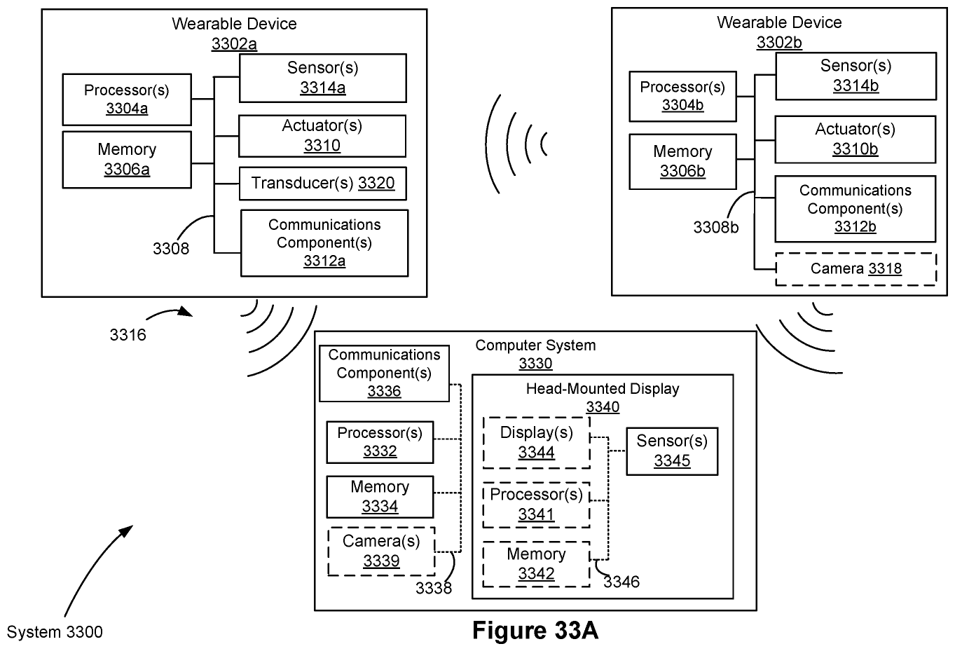

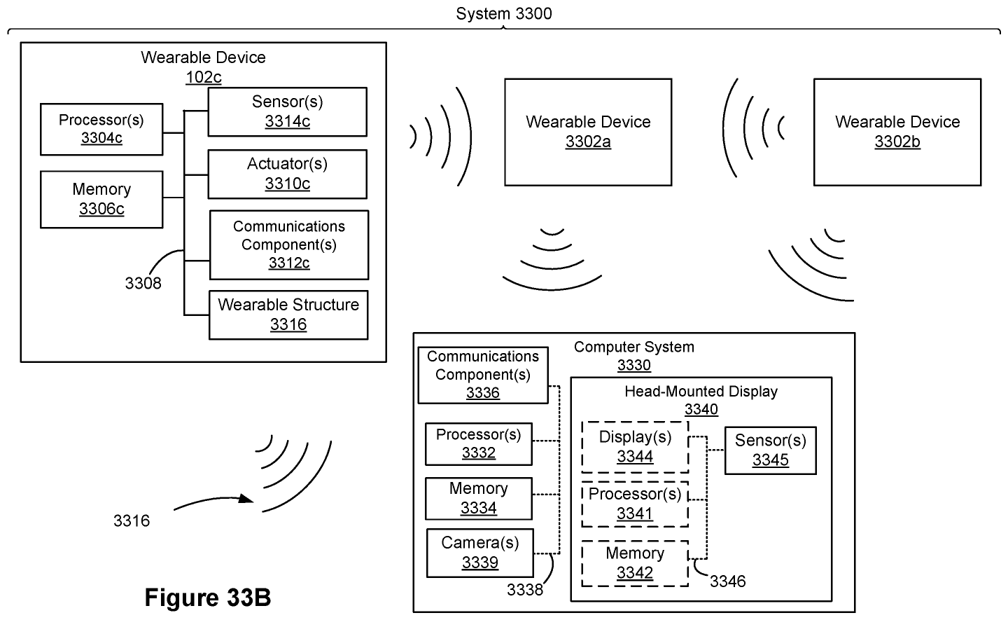

FIG. 33A is a block diagram illustrating a system 3300 in accordance with various embodiments. While some example features are illustrated, various other features have not been illustrated for the sake of brevity and so as not to obscure pertinent aspects of the example embodiments disclosed herein. To that end, as a non-limiting example, the system 3300 includes wearable devices 3302a. 3302b, which are used in conjunction with a computer system 3330 (e.g., a host system or a host computer).

An example wearable device 3302 includes, for example, one or more processors/cores 3304 (referred to henceforth as “processors”), a memory 3306, one or more actuators 3310, one or more communications components 3312, and/or one or more sensors 3314. In some embodiments, these components are interconnected by way of a communications bus 3308. References to these components of the wearable device 3302 cover embodiments in which one or more of these components (and combinations thereof) are included. In some embodiments, the one or more sensors 3314 and the one or more transducers are the same components. In some embodiments, the example wearable device 3302 includes one or more cameras 3318. In some embodiments (not shown), wearable device 3302 includes a wearable structure. In some embodiments the wearable device and the wearable structure are integrally formed. In some embodiments, the wearable device and the wearable structure are distinct structures, yet part of the system 3300.

In some embodiments, a single processor 3304 (e.g., processor 3304 of the wearable device 3302a) executes software modules for controlling multiple wearable devices 3302 (e.g., wearable devices 3302b . . . 3302n). In some embodiments, a single wearable device 3302 (e.g., wearable device 3302a) includes multiple processors 3304, such as one or more actuator processors (configured to, e.g., adjust a fit of a wearable structure), one or more communications component processors (configured to, e.g., control communications transmitted by communications component 3312 and/or receive communications by way of communications component 3312), one or more sensor processors (configured to, e.g., control operation of sensor 3314 and/or receive output from sensors 3314), and/or one or more transducer processors (configured to, e.g., control operation of transducers 3320).

In some embodiments, the one or more actuators 3310 are used to adjust a fit of the wearable structure on a user's appendage. In some embodiments, the one or more actuators 3310 are also used to provide haptic feedback to the user. For example, each actuator 3310 may apply vibration stimulations, pressure stimulations, shear stimulations, or some combination thereof to the user. In some embodiments, the one or more actuators 3310 are hydraulic, pneumatic, electric, and/or mechanical actuators.

In some embodiments, the one or more transducers 3320 are used to transmit (and receive) one or more signals 3316. In some other embodiments, the one or more sensors 3314 are used to transmit (and receive) one or more signals 3316. In some other embodiments, the one or more sensors 3314 and the one or more transducers 3320 are part of the same component that is used to transmit (and receive) one or more signals 3316. The signals 3316 may be electromagnetic waves, mechanical waves, electrical signals, or any wave/signal capable of being transmitted through a medium. As discussed herein, the “medium” is the wearer's skin, flesh, bone, blood vessels, or some combination thereof.

In addition to transmitting signals (e.g., electrical signals), the wearable device 3302 is also configured to receive (e.g., detect, sense) signals transmitted by itself or by another wearable device 3302. To illustrate, a first wearable device 3302a may transmit a plurality of signals through a medium, such as the wearer's appendage, and a second wearable device 3302b (attached to the same wearer) may receive at least some of the signals transmitted by the first wearable device 3302a through the medium. Furthermore, a wearable device 3302 receiving transmitted signals may use the received signals to determine whether the wearable device is in contact with a user's appendage (explained in more detail below).

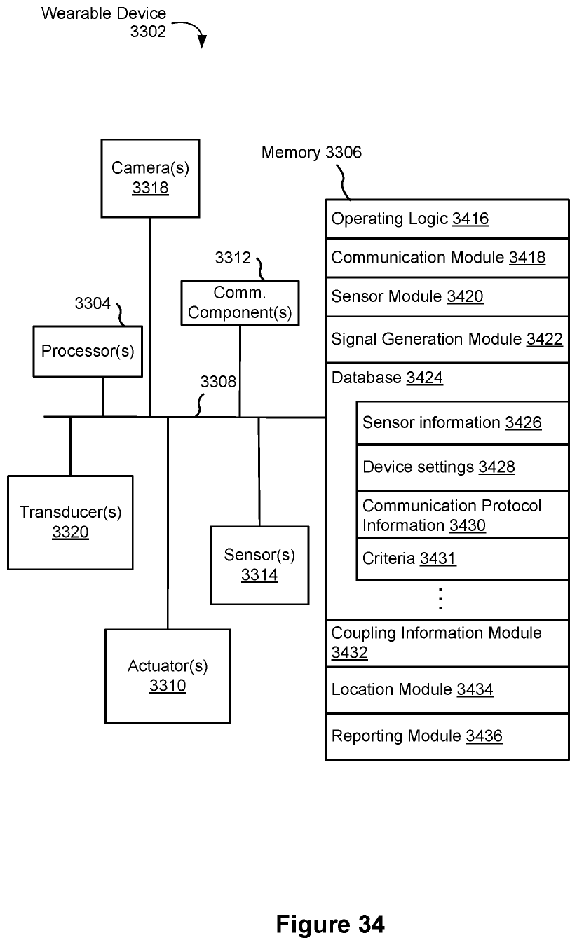

The computer system 3330 is a computing device that executes artificial-reality applications (e.g., virtual-reality applications, augmented-reality applications, etc.) to process input data from the sensors 3345 on the head-mounted display 3340 and the sensors 3314 on the wearable device 3302. The computer system 3330 provides output data to at least (i) the electronic display 3344 on the head-mounted display 3340 and (ii) the wearable device 3302 (e.g., processors 3304 of the haptic device 3302, FIG. 34).

An example computer system 3330, for example, includes one or more processors/cores 3332, memory 3334, one or more communications components 3336, and/or one or more cameras 3339 (optional). In some embodiments, these components are interconnected by way of a communications bus 3338. References to these components of the computer system 3330 cover embodiments in which one or more of these components (and combinations thereof) are included.

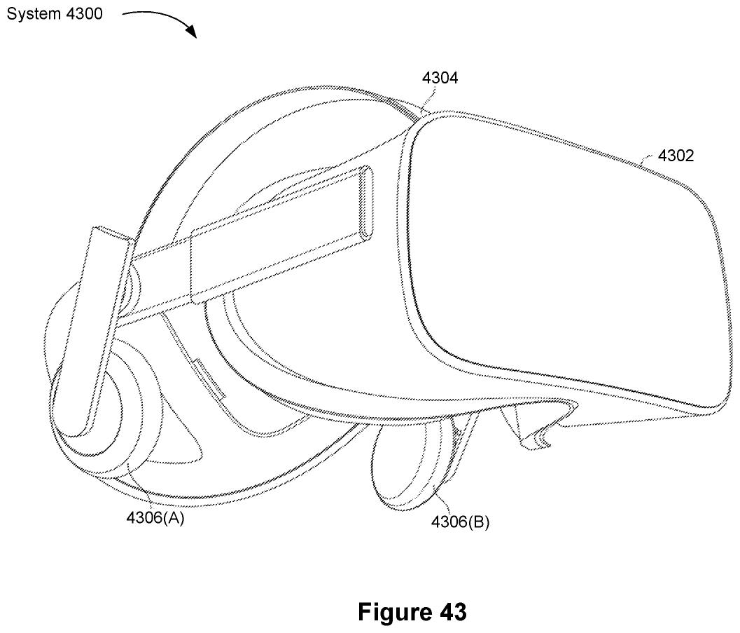

In some embodiments, the computer system 3330 is a standalone device that is coupled to a head-mounted display 3340. For example, the computer system 3330 has processor(s)/core(s) 3332 for controlling one or more functions of the computer system 3330 and the head-mounted display 3340 has processor(s)/core(s) 3341 for controlling one or more functions of the head-mounted display 3340. Alternatively, in some embodiments, the head-mounted display 3340 is a component of computer system 3330. For example, the processor(s) 3332 controls functions of the computer system 3330 and the head-mounted display 3340. In addition, in some embodiments, the head-mounted display 3340 includes the processor(s) 3341 that communicate with the processor(s) 3332 of the computer system 3330. In some embodiments, communications between the computer system 3330 and the head-mounted display 3340 occur via a wired (or wireless) connection between communications bus 3338 and communications bus 3346. In some embodiments, the computer system 3330 and the head-mounted display 3340 share a single communications bus. It is noted that in some instances the head-mounted display 3340 is separate from the computer system 3330 (as shown in FIG. 43).

The computer system 3330 may be any suitable computer device, such as a laptop computer, a tablet device, a netbook, a personal digital assistant, a mobile phone, a smart phone, an artificial-reality reality console or device (e.g., a virtual-reality device, an augmented-reality device, or the like), a gaming device, a computer server, or any other computing device. The computer system 3330 is sometimes called a host or a host system. In some embodiments, the computer system 3330 includes other user interface components such as a keyboard, a touch-screen display, a mouse, a track-pad, and/or any number of supplemental I/O devices to add functionality to computer system 3330.

In some embodiments, one or more optional cameras 3339 of the computer system 3330 are used to facilitate the artificial-reality experience. In some embodiments, the computer system 3330 provides images captured by the one or more cameras 3339 to the display 3344 of the head-mounted display 3340, and the display 3344 in turn displays the provided images. In some embodiments, the processors 3341 of the head-mounted display 3340 process the provided images. It is noted that in some embodiments, one or more of the cameras 3339 are part of the head-mounted display 3340.

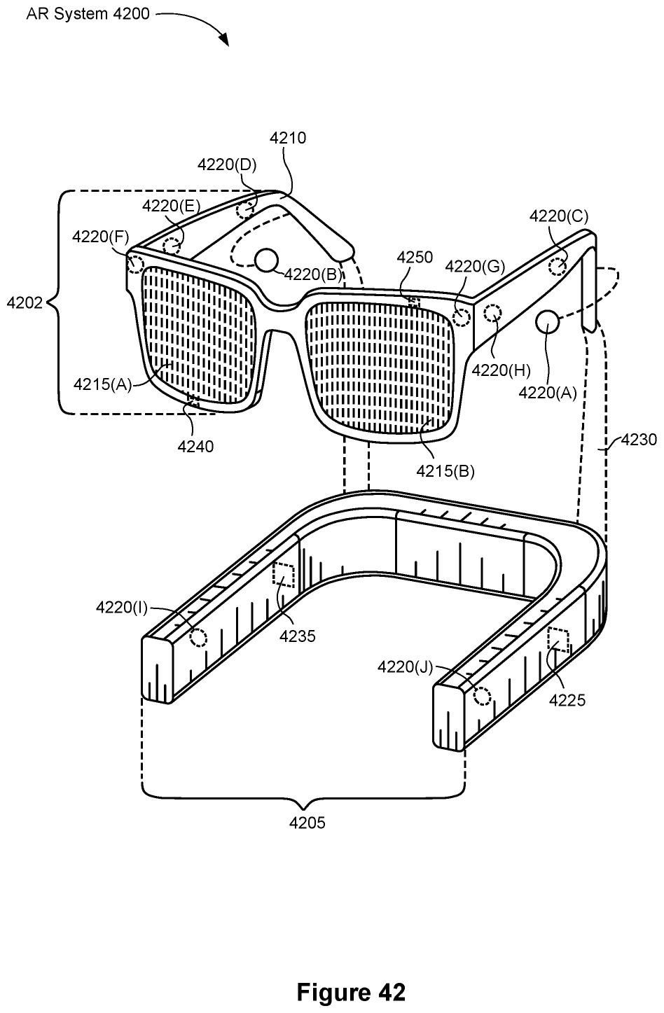

The head-mounted display 3340 presents media to a user. Examples of media presented by the head-mounted display 3340 include images, video, audio, or some combination thereof. In some embodiments, audio is presented via an external device (e.g., speakers and/or headphones) that receives audio information from the head-mounted display 3340, the computer system 3330, or both, and presents audio data based on the audio information. The displayed images may be in virtual reality, augmented reality, or mixed reality. An example head-mounted display 3340, for example, includes one or more processor(s)/core(s) 3341, a memory 3342, and/or one or more displays 3344. In some embodiments, these components are interconnected by way of a communications bus 3346. References to these components of the head-mounted display 3340 cover embodiments in which one or more of these components (and combinations thereof) are included. It is noted that in some embodiments, the head-mounted display 3340 includes one or more sensors 3345. Alternatively, in some embodiments, the one or more sensors 3345 are part of the computer system 3330. FIGS. 42 and 43 illustrate additional examples (e.g., AR system 4200 and VR system 4300) of the head-mounted display 3340.

The electronic display 3344 displays images to the user in accordance with data received from the computer system 3330. In various embodiments, the electronic display 3344 may comprise a single electronic display or multiple electronic displays (e.g., one display for each eye of a user).

The sensors 3345 include one or more hardware devices that detect spatial and motion information about the head-mounted display 3340. Spatial and motion information can include information about the position, orientation, velocity, rotation, and acceleration of the head-mounted display 3340. For example, the sensors 3345 may include one or more inertial measurement units (IMUs) that detect rotation of the user's head while the user is wearing the head-mounted display 3340. This rotation information can then be used (e.g., by the computer system 3330) to adjust the images displayed on the electronic display 3344. In some embodiments, each IMU includes one or more gyroscopes, accelerometers, and/or magnetometers to collect the spatial and motion information. In some embodiments, the sensors 3345 include one or more cameras positioned on the head-mounted display 3340.

In some embodiments, the one or more transducers 3320 of the wearable device 3302 may include one or more transducers configured to generate and/or receive signals. Integrated circuits (not shown) of the wearable device 3302, such as a controller circuit and/or signal generator, may control the behavior of the transducers 3320. The transmit electrode and/or the receive electrode may be part of the one or more transducers 3320 of the wearable device 3302. Alternatively, the transmit electrode and/or the receive electrode may be part of the one or more sensors 3314 of the wearable device 3302, or the transmit electrode may be part of a transducer 3320 while the receive electrode may be part of a sensor 3314 (or vice versa).

The communications component 3312 of the wearable device 3302 may include a communications component antenna for communicating with the computer system 3330. Moreover, the communications component 3336 may include a complementary communications component antenna that communicates with the communications component 3312. The respective communication components are discussed in further detail below with reference to FIG. 34.

In some embodiments, the data contained within the communication signals alerts the computer system 3330 that the wearable device 3302 is ready for use. As will be described in more detail below, the computer system 3330 may send instructions to the wearable device 3302, and in response to receiving the instructions, the wearable device instructs a transmit and receive electrode to provide coupling information between the receive electrode and the user's appendage

In some embodiments, the sensors 3314 include one or more of the transmit electrode and the receive electrode for obtaining coupling information. Additional non-limiting examples of the sensors 3314 (and the sensors 3345) include, e.g., infrared, pyroelectric, ultrasonic, microphone, laser, optical, Doppler, gyro, accelerometer, resonant LC sensors, capacitive sensors, acoustic sensors, and/or inductive sensors. In some embodiments, the sensors 3314 (and the sensors 3345) are configured to gather additional data about the user (e.g., an impedance of the user's body). Examples of sensor data output by these sensors include: body temperature data, infrared range-finder data, motion data, activity recognition data, silhouette detection and recognition data, gesture data, heart rate data, and other wearable device data (e.g., biometric readings and output, accelerometer data).

FIG. 33B is a block diagram illustrating an embodiment of the system 3300, in accordance with various embodiments. The system 3300 includes wearable devices 3302a, 3302b, and 3302c which are used in conjunction with a computer system 3330 (e.g., a host system or a host computer). Wearable device 3302c may be an additional device worn by the user to be used in conjunction with wearable devices 3302a and 3302b. For example, the wearable device 3302c may be a ring that is used in conjunction with a wearable structure to utilize data measurements obtained by sensor 3314c to adjust a fit of the wearable structure. In another example, the wearable device 3302a and wearable device 3302c may be distinct wristbands to be worn on each wrist of the user. In some embodiments, the wearable device 3302c may include all or some of the features embodied in the wearable devices 3302a, 3302b.

FIG. 34 is a block diagram illustrating a representative wearable device 3302 in accordance with some embodiments. In some embodiments, the wearable device 3302 includes one or more processing units 3304 (e.g., CPUs, microprocessors, and the like), one or more communication components 3312, memory 3306, one or more sensors 3314, one or more actuators 3310, one or more transducers 3320, one or more cameras 3318, and one or more communication buses 3308 for interconnecting these components (sometimes called a chipset). In some embodiments (not shown), the wearable device 3302 includes one or more output devices such as one or more indicator lights, sound cards, speakers, displays for displaying textual information and error codes, etc. Note that one or more of the components shown in FIG. 34 could be optional, and also that one or more of the components can be combined.

The communication component(s) 3312 enable communication between the wearable device 3302 and one or more communication networks. In some embodiments, the communication component(s) 3312 include, e.g., hardware capable of data communications using any of a variety of wireless protocols (e.g., IEEE 4002.15.4. Wi-Fi, ZigBee, 6LoWPAN, Thread, Z-Wave, Bluetooth Smart, ISA100.11a, WirelessHART, MiWi, etc.), wired protocols (e.g., Ethernet, HomePlug, etc.), and/or any other suitable communication protocol, including communication protocols not yet developed as of the filing date of this document.

The memory 3306 includes high-speed random access memory, such as DRAM, SRAM, DDR SRAM, or other random access solid state memory devices; and, optionally, includes non-volatile memory, such as one or more magnetic disk storage devices, one or more optical disk storage devices, one or more flash memory devices, or one or more other non-volatile solid state storage devices. The memory 3306, or alternatively the non-volatile memory within memory 3306, includes a non-transitory computer-readable storage medium. In some embodiments, the memory 3306, or the non-transitory computer-readable storage medium of the memory 3306, stores the following programs, modules, and data structures, or a subset or superset thereof:
operating logic 3416 including procedures for handling various basic system services and for performing hardware dependent tasks;
communication module 3418 for coupling to and/or communicating with remote devices (e.g., computer system 3330, other wearable devices, etc.) in conjunction with communication component(s) 3312;
signal generating module 3422 for generating and transmitting (e.g., in conjunction with sensor(s) 3314, transducer(s) 3320, and/or actuator(s) 3310) signals;
sensor module 3420 for obtaining and processing sensor data (e.g., in conjunction with sensor(s) 3314, transducer(s) 3320, and/or actuator(s) 3310) to, for example, determine an existence of an air gap between a sensor and a user's appendage. In another example, sensor module 3420 obtains and processes sensor data to determine a contact pressure between a sensor and a user's appendage. In some embodiments, the sensor data is generated from, at least in part, the signals generated by the signal generating module 3422;
database 3424, including but not limited to:
   sensor information 3426 (e.g., coupling information) for storing and managing data received, detected, and/or transmitted by one or more sensors 3314 (or, potentially the one or more actuators 3310 and/or the one or more transducers 3320);
   device settings 3428 for storing operational settings for the wearable device 3302 and/or one or more remote devices (e.g., selected characteristics/parameters values for the signals);
   communication protocol information 3430 for storing and managing protocol information for one or more protocols (e.g., custom or standard wireless protocols, such as ZigBee, Z-Wave, etc., and/or custom or standard wired protocols, such as Ethernet); and
   coupling criteria 3431 for evaluating the sensor information 3426;
coupling information module 3432 for determining whether the sensor information 3426 (i.e., coupling information) satisfy one or more of the coupling criteria 3431;
location information module 3434 for determining locations of coupling instances between a sensor 3314 and a user appendage; and
reporting module 3436 for reporting coupling deficiencies (or lack thereof) for further processing, such as adjusting a fit of a wearable structure on a user's appendage.

In some embodiments (not shown), the wearable device 3302 includes a unique identifier stored in database 3424. In some embodiments, the wearable device 3302 sends the unique identifier to the host system 3330 to identify itself to the host system 3330. This is particularly useful when multiple wearable devices are being concurrently used.

Each of the above-identified elements (e.g., modules stored in memory 3306 of the wearable device 3302) is optionally stored in one or more of the previously mentioned memory devices, and corresponds to a set of instructions for performing the function(s) described above. The above identified modules or programs (e.g., sets of instructions) need not be implemented as separate software programs, procedures, or modules, and thus various subsets of these modules are optionally combined or otherwise rearranged in various embodiments. In some embodiments, the memory 3306, optionally, stores a subset of the modules and data structures identified above. Furthermore, the memory 3306, optionally, stores additional modules and data structures not described above.

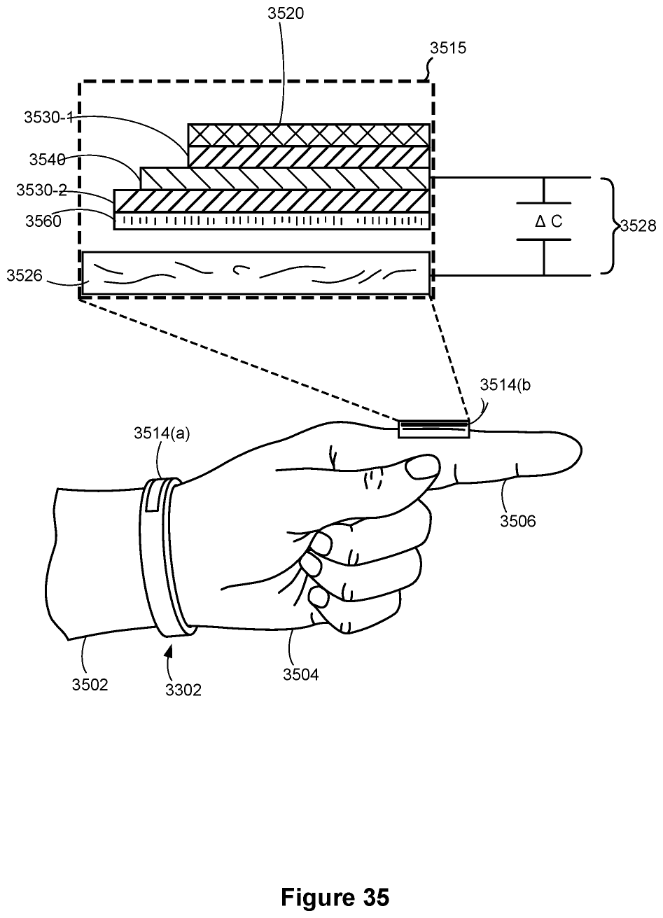

FIG. 35 illustrates a representative wearable device 3302 on a user's appendage 3502 in accordance with some embodiments. FIG. 35 includes the user's hand 3504, his or her wrist 3502, the representative wearable device 3302 on the user's wrist 3502, a sensor 3514(a) integrally formed with the wearable device 3302, a user's finger 3506, and a sensor 3514(b) atop the user's finger 3506. Such an arrangement is merely one possible arrangement, and one skilled in the art will appreciate that the discussion herein is not limited to the arrangement shown in FIG. 35. Additionally, the sensors in FIG. 35 are shown oversized for ease of illustration.

The sensor 3514(a) and the sensor 3514(b) may collectively form a sensor system. Moreover, the user's body (e.g., his or her skin) may also be part of the sensor 3514(a). In some embodiments, the sensor 3514(a) and the sensor 3514(b) are examples of the sensor(s) 3314. In some other embodiments, the sensor 3514(a) and the sensor 3514(b) are examples of the transducer(s) 3320. In some other embodiments, the sensor 3514(a) is an example of a transducer 3320, while the sensor 3514(b) is an example of a sensor 3314, or vice versa. For ease of illustration, the sensor 3514(b) is enlarged in FIG. 35 in view 3515.

In the illustrated embodiment, the sensor 3514(a) is embedded in the wearable device 3302 and the sensor 3514(b) is worn separately (e.g., embedded in a separate wearable device and/or structure, or on its own). The sensor 3514(a) and the sensor 3514(b) work in tandem to produce a reading indicating a proximity of the sensor 3514(b) to the user. In some embodiments, the sensor 3514 can detect a proximity to the user via galvanic and/or capacitive methods. In some embodiments, the sensor 3514(a) and the sensor 3514(b) both possess receive and transmit capabilities. In some other embodiments, the sensor 3514(a) is the designated transmit sensor, while the sensor 3514(b) is the designated receive sensor (or vice versa). The designated transmit sensor (e.g., 3514(a)) can be connected to the user's skin through galvanic or capacitive coupling. In some embodiments, if the transmit sensor is connected to the skin via capacitive coupling, the capacitive coupling is greater than 10 times the capacitive coupling of the receive sensor. This can be achieved by ensuring the area of the transmit sensor is greater than 10 times the size of the receive sensor.

In some embodiments, the wearable device 3302 includes a wearable structure (not shown) that may be a flexible mechanical substrate such as a plastic (e.g., polyethylene or polypropylene), rubber, nylon, synthetic, polymer, etc. In some embodiments, the wearable structure is configured to be worn around at least a portion of a user's wrist 3502 (e.g., a bracelet, a glove) or finger 3506 as a ring (and various other body parts and various other suitable structures) (not shown).

As shown in an enlarged view 3515, the sensor 3514(b) includes several layers including a top shield layer 3520 (e.g., ground) to shield against unwanted electric fields. The sensor 3514(b) further includes insulation layers 3530-1 and 3530-2, an electrode 3540, and a textile substrate 3560. The sensor 3514(b) (or the sensor system as a whole), shown above the user's finger 3506, is configured to detect an air gap between itself and the finger. In some embodiments, the sensor 3514(b) (or the sensor system as a whole) is configured to detect a change in capacitance in active sensing region 3528. Stated differently, the sensor 3514(b) (or the sensor system as a whole) is configured to detect a proximity of the sensor 3514(b) to the user's skin 3526. In some embodiments, the sensor 3514(b) is configured to detect a contact pressure between the sensor and the user's skin. As mentioned above, the user's skin 3526 can act as a transmit conductor component of the sensor 3514(a). This is possible because a person's skin is electrically conductive, which allows electrical signals originating from the sensor 3514(a) to pass and travel through the skin. Additionally, the transmit sensor can be connected to the user's skin through galvanic methods.

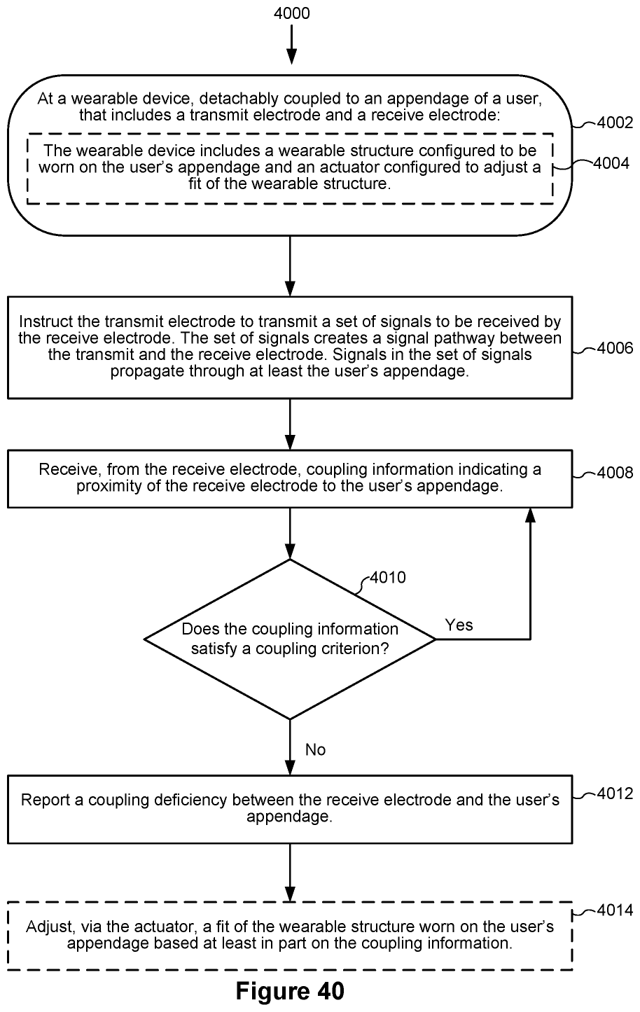

In some embodiments, a baseline capacitance value is measured when the sensor 3514(b) is in direct physical contact with user's skin 3526. Subsequent measurements of capacitance values taken by the sensor 3514(b) may be used to determine a proximity of the sensor 3514(b) to the skin based, at least in part, on a difference between the measured capacitance values and the baseline capacitance value. In some embodiments, a measurement of capacitance meets a coupling criterion (discussed in more detail at FIG. 40) when a difference between the measurement of capacitance and the baseline capacitance value is less than some threshold value or percentage.

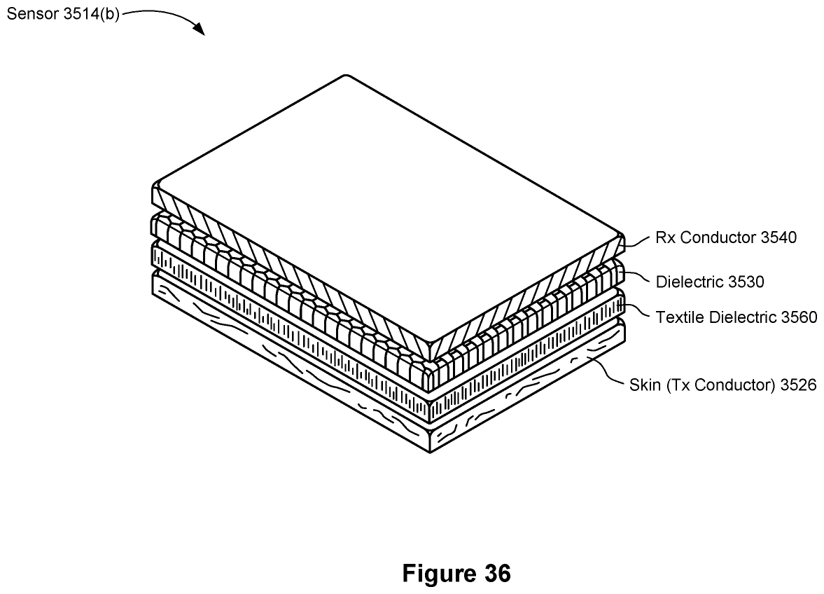

FIG. 36 shows an example oblique view of the sensor 3514(b) in accordance with some embodiments. The sensor 3514(b) may be either a receive electrode, transmit electrode, or both (as mentioned above). In some embodiments, the sensor 3514(b) includes a conductor 3540 as the receive conductor. Additionally, the sensor 3514(b) may include one or more layers of dielectric material 3560 and 3530 (e.g., silicone 3530, FIG. 35), as shown in FIG. 36. The sensor 3514(b) may also include a textile dielectric 3560 configured to contact a user's skin and add comfort to the system. Note that while the textile material 3560 is in direct with the skin 3526, the textile material 3560 is polarized to allow electric charges through the material 3560.

In some embodiments, the skin 3526 is a transmit conductor and layers 3530, 3560 pass electrical charge from the skin 3526 to the conductor 3540. More specifically, the sensor 3514(a) (FIG. 35) uses the user's skin 3526 as a transmit electrode, which allows the receive electrode of the sensor 3514(b) to be sensitive to air gaps in the interface between the user's skin 325 and the sensor 3514(b). In some embodiments, the response of a capacitive sensor, such of the sensor 3514(b), can be determined by the following expression:

$$C = {ɛ}_{0} {ɛ}_{r} \frac{A}{d}$$

where the capacitance value C is determined by using ε₀, the permittivity of free space, εᵣ, the dielectric constant, A the surface area of the electrode, and d the distance between the two electrodes (e.g., 3540 and 3526). By sensing when d increases, C decreases, the sensor system (i.e., the sensor 3514(a) and the sensor 3514(b)) is thus able to detect the existence of an air gap between the two electrodes 3540 and the skin 3526.

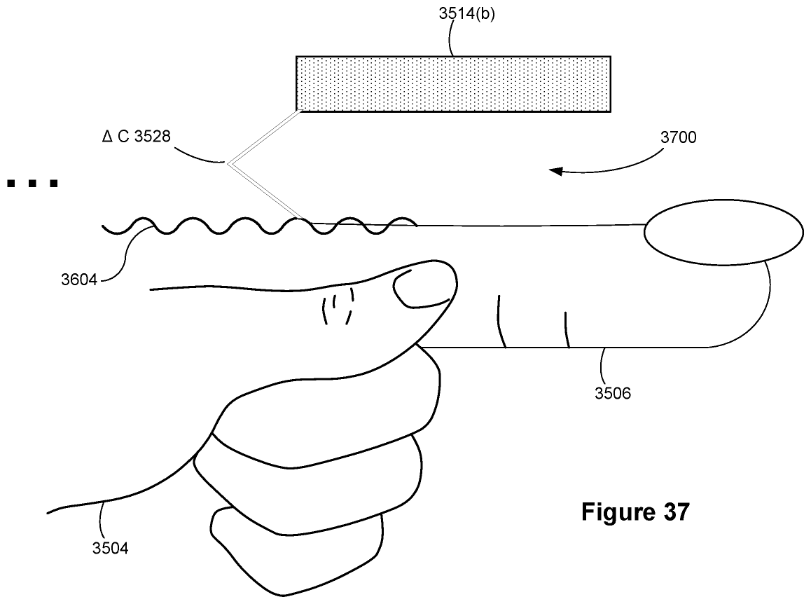

FIG. 37 shows an active sensing region 3528 between the sensor 3514(b) and a user's finger 3506, which is part of the sensor 3514(a). More specifically, the active sensing region 3528 is a region between a receive electrode 3540 and a transmit electrode 3526, and from this region, capacitance values can be measured/determined. FIG. 37 also shows a signal 3604 that is sent from a transmit electrode (e.g., sensor 3514(a), FIG. 35), transmitted through the skin on the user's finger 3506, to be received by the receive electrode (e.g., sensor 3514(a)).

In some embodiments, a transmit electrode transmits a low voltage signal, such as a 3.3V, 16 kHz signal (note that various of voltage levels and signals can be used as well), through the user's skin. In such embodiments, the sensor 3514(b) receives the signal and reports the received signal for processing (e.g., to a device communicatively coupled with the sensor 3514(b)). The processing may occur at a separate device (e.g., computer system 3330) to determine whether the expected signal was received at the receive electrode. Importantly, signal distortions may indicate an air gap 3700 between the receive electrode and the user. In some embodiments, the sensor 3514(b) is configured to quantify a depth, magnitude of the air gap 3700 and report the depth/magnitude of the air gap 3700. In some embodiments, the sensor 3514(b) is configured to quantify a contact pressure between the sensor and the user's skin and/or appendage and to report the contact pressure.

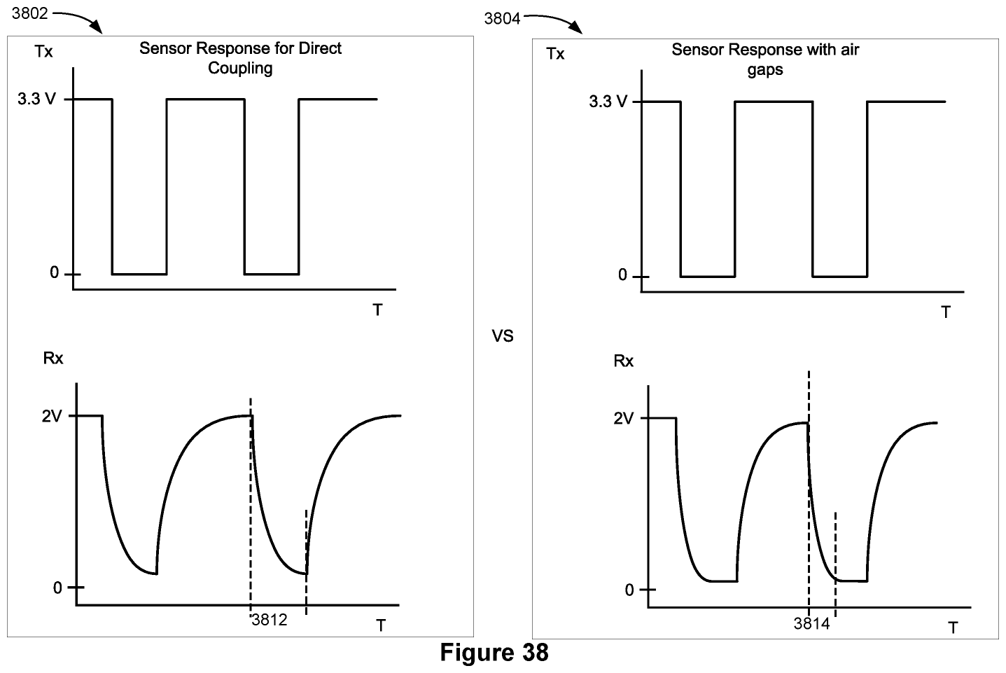

FIG. 38 shows example waveform diagrams at the transmit and receive electrodes in accordance with some embodiments. In particular, an example sensor response for direct coupling is shown in diagram 3802 and an example sensor response with air gaps is shown in diagram 3804. In each instance, a 3.3V square wave is transmitted from the transmit electrode and a signal response is received at the receive electrode. The received signal is lower in voltage at 2V and shows a typical capacitance charge/discharge graph. It is noted that the voltages in FIG. 38 are exemplary and may be any other suitable voltage levels. The time between the crest and the valley (e.g., discharge rate 3812, 3814) indicates a capacitance level. The voltage across the capacitor (e.g., capacitance sensed by receive electrode) can be shown as a function of time during the discharge period as:

$${V}_{c} = {V}_{s} * {e}^{\frac{- t}{RC}}$$

where V_{c} is the voltage across the capacitor, Vₛ is the supply voltage, t is time, and RC is the time constant. RC can be defined as:

τ≡R*C

where R is resistance in Ω and C is capacitance in Farads.

By using a combination of the equations above, the capacitance value between the user and the electrode can be determined. This capacitance value is then used to determine whether there is an air gap between the user and the electrode, and if so, how large. Capacitance values and discharge rates are directly proportionate based on the distance between the receive and the transmit (e.g., positive and negative terminals of a traditional capacitor) electrodes. Thus, FIG. 38 shows a longer discharge rate in the diagram 3802 when there is direct coupling (high capacitance) and a smaller discharge time (3814) in the diagram 3804 when there is an air gap (low capacitance) due to the physical characteristics of a capacitor.

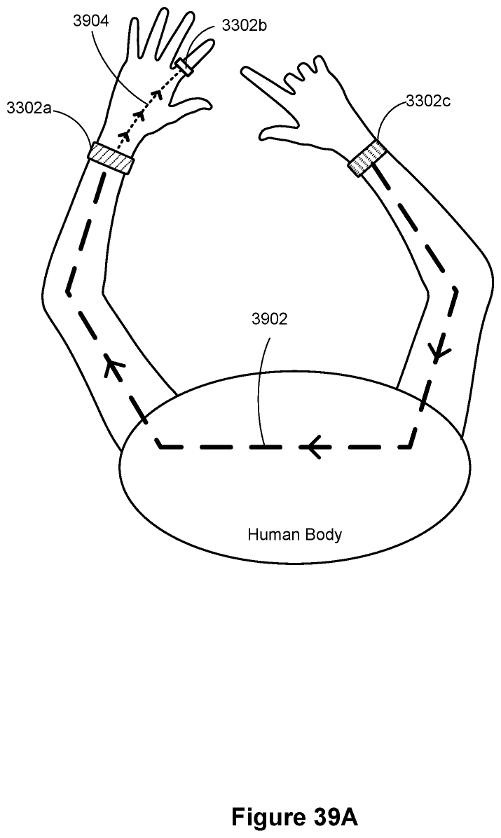

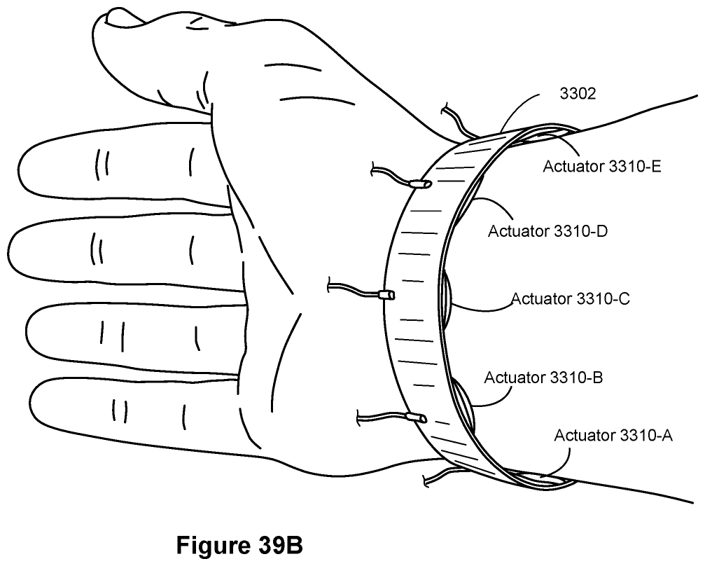

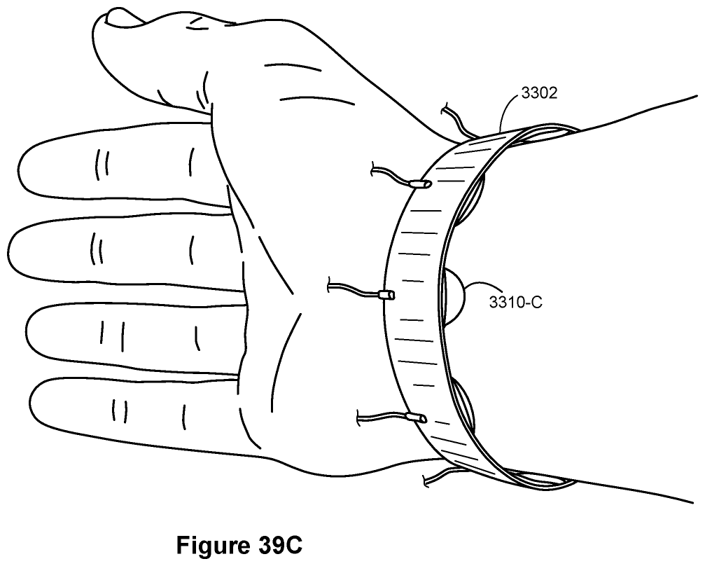

FIG. 39A shows example signal pathways through the skin of a user in accordance with some embodiments. Wearable devices 3302a, 3302b, and 3302c may be working in conjunction to provide coupling-quality information. The wearable device 3302a may be in communication with both 3302b and 3302c to request, provide, and communicate coupling-quality information. For example, the wearable device 3302a transmits a signal 3904 to the wearable device 3302b to determine a coupling quality of the wearable device 3302b on the user's finger and also receives a signal 3902 indicating coupling-quality information from the wearable device 3302c.

In some embodiments, the signal pathways 3902, 3904 are reversed (e.g., signals travel from left to right). In some embodiments, each of the wearable devices 3302 is configured to adjust a fit of a wearable structure (not shown) via actuators (e.g., actuators 3310) or by other suitable mechanisms. In some embodiments, each of the wearable devices 3302 is configured to transmit coupling-quality information to a controller (e.g., computing system 3330) for processing.

FIGS. 39B and 39C show an example wearable device 3302 that includes a plurality of actuators 3302-A-3302-E. In particular, FIG. 39B shows the wearable device 3302 before a fit of its wearable structure is adjusted, e.g., according to information collected by the sensor system discussed above, while FIG. 35C shows the wearable device 3302 after the fit of its wearable structure is adjusted (e.g., actuator 3310-C is actuated and pushes against the user's skin, thereby adjusting the fit of the wearable structure). It should be noted that the wearable device 3302 would include the receive electrode in FIG. 39B, as the adjusting is taking place at the wearable device 3302. In some other embodiments, other structures that are not a wristband include one or more actuators 3310, and those other structures undergo adjustment according to information collected by the sensor system discussed above.

FIG. 40 is a flow diagram illustrating a method 4000 of sensing coupling quality with a user's body in accordance with some embodiments. The steps of the method 4000 may be performed by a wearable device (e.g., a wearable device 3302a, FIGS. 33A-33B) and a computer system (e.g., computer system 3330. FIGS. 33A-33B). FIG. 40 corresponds to instructions stored in a computer memory or computer readable storage medium (e.g., memory 3306 of the wearable device 3302). For example, the operations of the method 4000 are performed, at least in part, by a communication module (e.g., communication module 3418, FIG. 34), a signal generation module (e.g., signal generation module 3422, FIG. 34), coupling information modules (e.g., coupling information module 3432, location information 3434), and/or reporting information modules (e.g., reporting module 3436 FIG. 34).

As discussed above, the wearable device (e.g., wearable device 3302) is detachably coupled to an appendage of a user (e.g., wrist 3502, FIG. 35), and includes (4002) a transmit electrode and a receive electrode. For example, and with reference to FIG. 35, the wearable device 3302 includes the sensor 3514(a), which includes a transmit electrode, and the sensor 3514(b), which includes a receive electrode. In some embodiments, the wearable device includes (4004) a wearable structure (e.g., a glove, wristband, etc.) configured to be worn on the user's appendage and an actuator (e.g., actuator 3310, FIG. 33A) configured to adjust a fit of the wearable structure. For example, with reference to FIG. 39B, the wearable device 3302 includes a wristband (i.e., a wearable structure) that include multiple actuators 3310 coupled to an inner surface of the wristband.

In some embodiments, the transmit electrode is located on the user's appendage at a first location and the receive electrode is located on the user's appendage at a second location distinct from the first location of the transmit electrode. For example, in FIG. 35, the transmit electrode is located on the user's wrist while the receive electrode is located on the user's finger. In some other embodiments, the transmit electrode and the receiver electrode are location near each other on the user's appendage. For example, in FIG. 39B, the wearable device 3302 may include a transmit electrode integrated with the wearable structure and may also include a receive electrode integrated with the wearable structure. In some instances, the two electrodes may be adjacent to each other on the wearable structure, while in other instances, the two electrodes may be on opposite sides of the wearable structure. In either instances, the two electrodes operate in the same manner as described herein with reference to FIGS. 35-38.

In some embodiments, the transmit electrode structure includes, from the top layer down, a shield layer, an electrode (e.g., conductive metal), an insulation layer (e.g., silicone), and a textile fabric as the bottom layer in contact with the user's appendage. In some embodiments, the receive electrode includes the same materials as the transmit electrode in the same layering order as the transmit electrode. In some other embodiments, the receive electrode includes materials that differ from the materials of the transmit electrode. Structures of the transmit electrode and the receive electrode are discussed in further detail above with reference to FIGS. 35 and 36.

In some embodiments, the transmit electrode includes an electrode and skin of the user's appendage, and the electrode is physically coupled to the skin of the user's appendage. The transmit electrode may be an example of the sensor 3514(a). Furthermore, in some embodiments, the receive electrode may be an example of the sensor 3514(b).

The method 4000 includes instructing (4006) the transmit electrode to transmit a set of signals to be received by the receive electrode. The set of signals creates a signal pathway between the transmit and the receive electrode and at least some signals in the set of signals are received by the receive electrode. To illustrate, with reference to FIG. 37, the transmit electrode may generate a set of signals, such as the signal 3604, which may travel from the transmit electrode, using the user's skin as a transport medium, to the receive electrode (e.g., sensor 3514(b)).

The method further comprises receiving (4008) from the receive electrode, coupling information (e.g., coupling information 3432. FIG. 34) indicating a proximity of the receive electrode to the user's appendage. Put another way, the receive electrode generates a coupling metric (e.g., capacitance measurement 3528, FIG. 37) that represents an air gap, if any, between the receive electrode (or another component attached to the receive electrode) and the user's skin. An example air gap 3700 is shown and described above with reference to FIG. 37. Notably, the coupling information may be generated based, at least in part, on the signals in the set of signals received by the receive electrode. In some embodiments, the coupling metric is a contact pressure measured between the receive electrode and the user's skin.

The method 4000 further includes determining (4010) whether the coupling information satisfies a coupling criterion. In some embodiments, the coupling criterion is a capacitance measurement that corresponds to a known level of capacitance associated with an optimal fit of the wearable device (or, more specifically, its wearable structure). Alternatively or in addition, in some embodiments, the coupling criterion is a capacitance measurement that is within some predefined range/value/percentage of a baseline capacitance (e.g., the baseline capacitance value discussed above with reference to FIG. 35). For example, the capacitance measurement of the coupling criterion may be within, say, 10% (or some other percentage) of a baseline capacitance. In such embodiments, the baseline capacitance may be a known capacitance where an air gap between the receive electrode and the user's body/skin is at a desirable level.

The method 4000 further includes, in accordance with a determination that the received coupling information satisfies the coupling criterion (4010—Yes), continuing to receive coupling information at step 4008. In other words, the coupling information indicates that the receive electrode is sufficiently close to the user's appendage, such that a fit adjustment (or some other adjustment) is not necessary. As one example of another adjustment, an artificial-reality system may include different sized wearable devices (e.g., large-sized haptic gloves, medium-sized haptic gloves, etc.). Accordingly, in the present circumstance, the received coupling information is indicating that a first-sized wearable device selected by the user fit well, and, thus, no size adjustment is needed.

In contrast, the method 4000 may further include, in accordance with a determination that the received coupling information does not satisfy the coupling criterion (4010—No), reporting (4012) a coupling deficiency between the receive electrode and the user's appendage. The coupling deficiency indicates that the receive electrode is not sufficiently close to the user's appendage. Such a situation may arise when, for example, the wearable device is transferred from a first user to a second user, whereby the second user has, e.g., a larger wrist than the first user. A coupling deficiency may also arise during game play when the user changes a posture of the first appendage (e.g., transitions from an open hand to making a fist). A coupling deficiency may also arise when the artificial-reality system may include different sized wearable devices, as explained above. The coupling deficiency may arise from various other circumstances, and the provided examples are merely used to give context to the coupling deficiency.

As explained above, the coupling criterion may correspond to baseline coupling information. In such embodiments, and as one example, the baseline coupling information may include a measured capacitance of direct contact between the user's appendage and the receive electrode. This baseline coupling information can then be used to determine whether the coupling information from the receive electrode satisfies the coupling criterion, i.e., indicates an existence of an air gap between the receive electrode and the user's appendage. In some embodiments, the coupling information includes information indicating a capacitance level relative to the baseline coupling information. In view of this information, and as explained below with reference to step 4014, a controller may instruct an actuator to move or adjust a fit of the wearable structure in one or more directions in order to reduce and/or eliminate the air gap.

In some embodiments, the method 4000 further includes adjusting (4014), via the actuator, a fit of the wearable structure worn on the user's appendage based at least in part on the coupling information. In some embodiments, adjusting the fit causes a position of the transmit and/or receive electrode to change. In some embodiments, the method further includes repeating the instructing, receiving, determining, reporting, and adjusting steps of 4002-4014 until the coupling criterion is satisfied.

Embodiments of the instant disclosure may include or be implemented in conjunction with various types of artificial reality systems. Artificial reality may constitute a form of reality that has been altered by virtual objects for presentation to a user. Such artificial reality may include and/or represent VR, AR, MR, hybrid reality, or some combination and/or variation of one or more of the same. Artificial reality content may include completely generated content or generated content combined with captured (e.g., real-world) content. The artificial reality content may include video, audio, haptic feedback, or some combination thereof, any of which may be presented in a single channel or in multiple channels (such as stereo video that produces a three-dimensional effect to a viewer). Additionally, in some embodiments, artificial reality may also be associated with applications, products, accessories, services, or some combination thereof, that are used to, e.g., create content in an artificial reality and/or are otherwise used in (e.g., to perform activities in) an artificial reality.

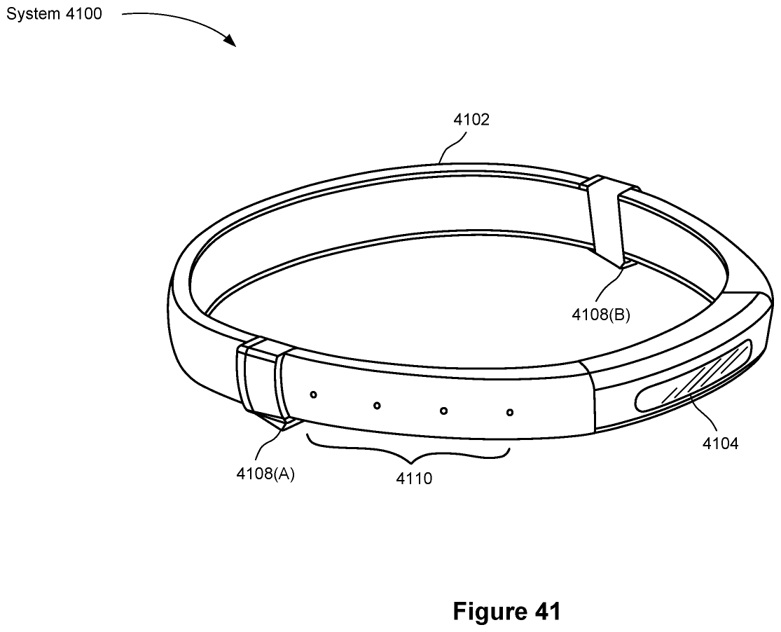

Artificial reality systems may be implemented in a variety of different form factors and configurations. Some artificial reality systems may be designed to work without near-eye displays (NEDs), an example of which is AR system 4100 in FIG. 41. Other artificial reality systems may include an NED that also provides visibility into the real world (e.g., AR system 42000 in FIG. 42) or that visually immerses a user in an artificial reality (e.g., VR system 4300 in FIG. 43). While some artificial reality devices may be self-contained systems, other artificial reality devices may communicate and/or coordinate with external devices to provide an artificial reality experience to a user. Examples of such external devices include handheld controllers, mobile devices, desktop computers, devices worn by a user (e.g., wearable device 3302a, wearable device 3302b, . . . wearable device 3302n), devices worn by one or more other users, and/or any other suitable external system.

FIGS. 41-43 provide additional examples of the devices used in the system 3300. AR system 4100 in FIG. 41 generally represents a wearable device dimensioned to fit about a body part (e.g., a wrist) of a user. The AR system 4100 may include the functionality of the wearable device 3302, and may include additional functions. As shown, the AR system 4100 includes a frame 4102 (e.g., band) and a camera assembly 4104 that is coupled to frame 4102 and configured to gather information about a local environment by observing the local environment. The AR system 4100 may also include one or more transducers (e.g., transducers 3320, FIG. 33A). In one example, the AR system 4100 includes output transducers 4108(A) and 4108(B) and input transducers 4110. Output transducers 4108(A) and 4108(B) may provide audio feedback, haptic feedback, and/or content to a user, and input audio transducers may capture audio (or other signals/waves) in a user's environment. In some embodiments, the camera assembly 4104 includes one or more projectors that allows the AR system 4100 to project images (e.g., if the AR system 4100 is worn on the user's wrist, then the camera assembly 4104 can project images onto the user's wrist and forearm).

Thus, the AR system 4100 does not include a near-eye display (NED) positioned in front of a user's eyes. AR systems without NEDs may take a variety of forms, such as head bands, hats, hair bands, belts, watches, wrist bands, ankle bands, rings, neckbands, necklaces, chest bands, eyewear frames, and/or any other suitable type or form of apparatus. While the AR system 4100 may not include an NED, the AR system 4100 may include other types of screens or visual feedback devices (e.g., a display screen integrated into a side of frame 4102).

The embodiments discussed in this disclosure may also be implemented in AR systems that include one or more NEDs. For example, as shown in FIG. 42, the AR system 4200 may include an eyewear device 4202 with a frame 4210 configured to hold a left display device 4215(A) and a right display device 4215(B) in front of a user's eyes. Display devices 4215(A) and 4215(B) may act together or independently to present an image or series of images to a user. While the AR system 4200 includes two displays, embodiments of this disclosure may be implemented in AR systems with a single NED or more than two NEDs.

In some embodiments, the AR system 4200 may include one or more sensors, such as sensor 4240. Sensor 4240 may generate measurement signals in response to motion of AR system 4200 and may be located on substantially any portion of frame 4210. Sensor 4240 may include a position sensor, an inertial measurement unit (IMU), a depth camera assembly, or any combination thereof. In some embodiments, the AR system 4200 may or may not include sensor 4240 or may include more than one sensor. In embodiments in which sensor 4240 includes an IMU, the IMU may generate calibration data based on measurement signals from sensor 4240. Examples of sensor 4240 may include, without limitation, accelerometers, gyroscopes, magnetometers, other suitable types of sensors that detect motion, sensors used for error correction of the IMU, or some combination thereof. Sensors are also discussed above with reference to FIG. 33A (e.g., sensors 3345 of the head-mounted display 3340).

The AR system 4200 may also include a microphone array with a plurality of acoustic sensors 4220(A)-4220(J), referred to collectively as acoustic sensors 4220. Acoustic sensors 4220 may be transducers that detect air pressure variations induced by sound waves. Each acoustic sensor 4220 may be configured to detect sound and convert the detected sound into an electronic format (e.g., an analog or digital format). The microphone array in FIG. 42 may include, for example, ten acoustic sensors: 4220(A) and 4220(B), which may be designed to be placed inside a corresponding ear of the user, acoustic sensors 4220(C), 4220(D), 4220(E), 4220(F), 4220(G), and 4220(H), which may be positioned at various locations on frame 4210, and/or acoustic sensors 4220(I) and 4220(J), which may be positioned on a corresponding neckband 4205. In some embodiments, the neckband 4205 is an example of the computer system 3330.

The configuration of acoustic sensors 4220 of the microphone array may vary. While the AR system 4200 is shown in FIG. 42 as having ten acoustic sensors 4220, the number of acoustic sensors 4220 may be greater or less than ten. In some embodiments, using higher numbers of acoustic sensors 4220 may increase the amount of audio information collected and/or the sensitivity and accuracy of the audio information. In contrast, using a lower number of acoustic sensors 4220 may decrease the computing power required by a controller 4250 to process the collected audio information. In addition, the position of each acoustic sensor 4220 of the microphone array may vary. For example, the position of an acoustic sensor 4220 may include a defined position on the user, a defined coordinate on the frame 4210, an orientation associated with each acoustic sensor, or some combination thereof.

Acoustic sensors 4220(A) and 4220(B) may be positioned on different parts of the user's ear, such as behind the pinna or within the auricle or fossa. Or, there may be additional acoustic sensors on or surrounding the ear in addition to acoustic sensors 4220 inside the ear canal. Having an acoustic sensor positioned next to an ear canal of a user may enable the microphone array to collect information on how sounds arrive at the ear canal. By positioning at least two of acoustic sensors 4220 on either side of a user's head (e.g., as binaural microphones), the AR device 4200 may simulate binaural hearing and capture a 3D stereo sound field around a user's head. In some embodiments, the acoustic sensors 4220(A) and 4220(B) may be connected to the AR system 4200 via a wired connection, and in other embodiments, the acoustic sensors 4220(A) and 4220(B) may be connected to the AR system 4200 via a wireless connection (e.g., a Bluetooth connection). In still other embodiments, acoustic sensors 4220(A) and 4220(B) may not be used at all in conjunction with the AR system 4200.

Acoustic sensors 4220 on frame 4210 may be positioned along the length of the temples, across the bridge, above or below display devices 4215(A) and 4215(B), or some combination thereof. Acoustic sensors 4220 may be oriented such that the microphone array is able to detect sounds in a wide range of directions surrounding the user wearing AR system 4200. In some embodiments, an optimization process may be performed during manufacturing of AR system 4200 to determine relative positioning of each acoustic sensor 4220 in the microphone array.

The AR system 4200 may further include or be connected to an external device (e.g., a paired device), such as neckband 4205. As shown, neckband 4205 may be coupled to eyewear device 4202 via one or more connectors 4230. Connectors 4230 may be wired or wireless connectors and may include electrical and/or non-electrical (e.g., structural) components. In some cases, eyewear device 4202 and neckband 4205 may operate independently without any wired or wireless connection between them. While FIG. 42 illustrates the components of eyewear device 4202 and neckband 4205 in example locations on eyewear device 4202 and neckband 4205, the components may be located elsewhere and/or distributed differently on eyewear device 4202 and/or neckband 4205. In some embodiments, the components of eyewear device 4202 and neckband 4205 may be located on one or more additional peripheral devices paired with eyewear device 4202, neckband 4205, or some combination thereof. Furthermore, neckband 4205 generally represents any type or form of paired device. Thus, the following discussion of neckband 4205 may also apply to various other paired devices, such as smart watches, smart phones, wrist bands, other wearable devices, hand-held controllers, tablet computers, laptop computers, etc.

Pairing external devices, such as neckband 4205, with AR eyewear devices may enable the eyewear devices to achieve the form factor of a pair of glasses while still providing sufficient battery and computation power for expanded capabilities. Some or all of the battery power, computational resources, and/or additional features of the AR system 4200 may be provided by a paired device or shared between a paired device and an eyewear device, thus reducing the weight, heat profile, and form factor of the eyewear device overall while still retaining desired functionality. For example, neckband 4205 may allow components that would otherwise be included on an eyewear device to be included in neckband 4205 since users may tolerate a heavier weight load on their shoulders than they would tolerate on their heads. Neckband 4205 may also have a larger surface area over which to diffuse and disperse heat to the ambient environment. Thus, neckband 4205 may allow for greater battery and computation capacity than might otherwise have been possible on a stand-alone eyewear device. Since weight carried in neckband 4205 may be less invasive to a user than weight carried in eyewear device 4202, a user may tolerate wearing a lighter eyewear device and carrying or wearing the paired device for greater lengths of time than the user would tolerate wearing a heavy standalone eyewear device, thereby enabling an artificial reality environment to be incorporated more fully into a user's day-to-day activities.

Neckband 4205 may be communicatively coupled with eyewear device 4202 and/or to other devices. The other devices may provide certain functions (e.g., tracking, localizing, depth mapping, processing, storage, etc.) to the AR system 4200. In the embodiment of FIG. 42, neckband 4205 may include two acoustic sensors (e.g., 4220(I) and 4220(J)) that are part of the microphone array (or potentially form their own microphone subarray). Neckband 4205 may also include a controller 4225 and a power source 4235.

Acoustic sensors 4220(I) and 4220(J) of neckband 4205 may be configured to detect sound and convert the detected sound into an electronic format (analog or digital). In the embodiment of FIG. 42, acoustic sensors 4220(1) and 4220(J) may be positioned on neckband 4205, thereby increasing the distance between neckband acoustic sensors 4220(1) and 4220(J) and other acoustic sensors 4220 positioned on eyewear device 4202. In some cases, increasing the distance between acoustic sensors 4220 of the microphone array may improve the accuracy of beamforming performed via the microphone array. For example, if a sound is detected by acoustic sensors 4220(C) and 4220(D) and the distance between acoustic sensors 4220(C) and 4220(D) is greater than, e.g., the distance between acoustic sensors 4220(D) and 4220(E), the determined source location of the detected sound may be more accurate than if the sound had been detected by acoustic sensors 4220(D) and 4220(E).

Controller 4225 of neckband 4205 may process information generated by the sensors on neckband 4205 and/or AR system 4200. For example, controller 4225 may process information from the microphone array that describes sounds detected by the microphone array. For each detected sound, controller 4225 may perform a direction of arrival (DOA) estimation to estimate a direction from which the detected sound arrived at the microphone array. As the microphone array detects sounds, controller 4225 may populate an audio data set with the information. In embodiments in which AR system 4200 includes an IMU, controller 4225 may compute all inertial and spatial calculations from the IMU located on eyewear device 4202. Connector 4230 may convey information between AR system 4200 and neckband 4205 and between AR system 4200 and controller 4225. The information may be in the form of optical data, electrical data, wireless data, or any other transmittable data form. Moving the processing of information generated by AR system 4200 to neckband 4205 may reduce weight and heat in eyewear device 4202, making it more comfortable to a user.

Power source 4235 in neckband 4205 may provide power to eyewear device 4202 and/or to neckband 4205. Power source 4235 may include, without limitation, lithium-ion batteries, lithium-polymer batteries, primary lithium batteries, alkaline batteries, or any other form of power storage. In some cases, power source 4235 may be a wired power source. Including power source 4235 on neckband 4205 instead of on eyewear device 4202 may help better distribute the weight and heat generated by power source 4235.

As noted, some artificial reality systems may, instead of blending an artificial reality with actual reality, substantially replace one or more of a user's sensory perceptions of the real world with a virtual experience. One example of this type of system is a head-worn display system, such as VR system 4300 in FIG. 43, that mostly or completely covers a user's field of view. VR system 4300 may include a front rigid body 4302 and a band 4304 shaped to fit around a user's head. VR system 4300 may also include output audio transducers 4306(A) and 4306(B). Furthermore, while not shown in FIG. 43, front rigid body 4302 may include one or more electronic elements, including one or more electronic displays, one or more IMUs, one or more tracking emitters or detectors, and/or any other suitable device or system for creating an artificial reality experience. Although not shown, the VR system 4300 may include the computer system 3330.

Artificial reality systems may include a variety of types of visual feedback mechanisms. For example, display devices in AR system 4200 and/or VR system 4300 may include one or more liquid-crystal displays (LCDs), light emitting diode (LED) displays, organic LED (OLED) displays, and/or any other suitable type of display screen. Artificial reality systems may include a single display screen for both eyes or may provide a display screen for each eye, which may allow for additional flexibility for varifocal adjustments or for correcting a user's refractive error. Some artificial reality systems may also include optical subsystems having one or more lenses (e.g., conventional concave or convex lenses, Fresnel lenses, adjustable liquid lenses, etc.) through which a user may view a display screen.

In addition to or instead of using display screens, some artificial reality systems may include one or more projection systems. For example, display devices in AR system 4200 and/or VR system 4300 may include micro-LED projectors that project light (using, e.g., a waveguide) into display devices, such as clear combiner lenses that allow ambient light to pass through. The display devices may refract the projected light toward a user's pupil and may enable a user to simultaneously view both artificial reality content and the real world. Artificial reality systems may also be configured with any other suitable type or form of image projection system.

Artificial reality systems may also include various types of computer vision components and subsystems. For example, AR system 4100, AR system 4200, and/or VR system 4300 may include one or more optical sensors such as two-dimensional (2D) or three-dimensional (3D) cameras, time-of-flight depth sensors, single-beam or sweeping laser rangefinders, 3D LiDAR sensors, and/or any other suitable type or form of optical sensor. An artificial reality system may process data from one or more of these sensors to identify a location of a user, to map the real world, to provide a user with context about real-world surroundings, and/or to perform a variety of other functions.

Artificial reality systems may also include one or more input and/or output audio transducers. In the examples shown in FIGS. 41 and 11, output audio transducers 4108(A), 4108(B), 4306(A), and 4306(B) may include voice coil speakers, ribbon speakers, electrostatic speakers, piezoelectric speakers, bone conduction transducers, cartilage conduction transducers, and/or any other suitable type or form of audio transducer. Similarly, input audio transducers 4110 may include condenser microphones, dynamic microphones, ribbon microphones, and/or any other type or form of input transducer. In some embodiments, a single transducer may be used for both audio input and audio output.

The artificial reality systems shown in FIGS. 41-43 may include tactile (i.e., haptic) feedback systems, which may be incorporated into headwear, gloves, body suits, handheld controllers, environmental devices (e.g., chairs, floor mats, etc.), and/or any other type of device or system, such as the wearable devices 3302 discussed herein. Additionally, in some embodiments, the haptic feedback systems may be incorporated with the artificial reality systems (e.g., the AR system 4100 may include the wearable device 3302 (FIG. 33). Haptic feedback systems may provide various types of cutaneous feedback, including vibration, force, traction, texture, and/or temperature. Haptic feedback systems may also provide various types of kinesthetic feedback, such as motion and compliance. Haptic feedback may be implemented using motors, piezoelectric actuators, fluidic systems, and/or a variety of other types of feedback mechanisms. Haptic feedback systems may be implemented independent of other artificial reality devices, within other artificial reality devices, and/or in conjunction with other artificial reality devices.

By providing haptic sensations, audible content, and/or visual content, artificial reality systems may create an entire virtual experience or enhance a user's real-world experience in a variety of contexts and environments. For instance, artificial reality systems may assist or extend a user's perception, memory, or cognition within a particular environment. Some systems may enhance a user's interactions with other people in the real world or may enable more immersive interactions with other people in a virtual world. Artificial reality systems may also be used for educational purposes (e.g., for teaching or training in schools, hospitals, government organizations, military organizations, business enterprises, etc.), entertainment purposes (e.g., for playing video games, listening to music, watching video content, etc.), and/or for accessibility purposes (e.g., as hearing aids, vision aids, etc.). The embodiments disclosed herein may enable or enhance a user's artificial reality experience in one or more of these contexts and environments and/or in other contexts and environments.

Some AR systems may map a user's environment using techniques referred to as “simultaneous location and mapping” (SLAM). SLAM mapping and location identifying techniques may involve a variety of hardware and software tools that can create or update a map of an environment while simultaneously keeping track of a device's or a user's location and/or orientation within the mapped environment. SLAM may use many different types of sensors to create a map and determine a device's or a user's position within the map.

SLAM techniques may, for example, implement optical sensors to determine a device's or a user's location, position, or orientation. Radios including WiFi, Bluetooth, global positioning system (GPS), cellular or other communication devices may also be used to determine a user's location relative to a radio transceiver or group of transceivers (e.g., a WiFi router or group of GPS satellites). Acoustic sensors such as microphone arrays or 2D or 3D sonar sensors may also be used to determine a user's location within an environment. AR and VR devices (such as systems 4100, 4200, and 4300) may incorporate any or all of these types of sensors to perform SLAM operations such as creating and continually updating maps of a device's or a user's current environment. In at least some of the embodiments described herein, SLAM data generated by these sensors may be referred to as “environmental data” and may indicate a device's or a user's current environment. This data may be stored in a local or remote data store (e.g., a cloud data store) and may be provided to a user's AR/VR device on demand.

When the user is wearing an AR headset or VR headset in a given environment, the user may be interacting with other users or other electronic devices that serve as audio sources. In some cases, it may be desirable to determine where the audio sources are located relative to the user and then present the audio sources to the user as if they were coming from the location of the audio source. The process of determining where the audio sources are located relative to the user may be referred to herein as “localization,” and the process of rendering playback of the audio source signal to appear as if it is coming from a specific direction may be referred to herein as “spatialization.”

Localizing an audio source may be performed in a variety of different ways. In some cases, an AR or VR headset may initiate a DOA analysis to determine the location of a sound source. The DOA analysis may include analyzing the intensity, spectra, and/or arrival time of each sound at the AR/VR device to determine the direction from which the sound originated. In some cases, the DOA analysis may include any suitable algorithm for analyzing the surrounding acoustic environment in which the artificial reality device is located.

For example, the DOA analysis may be designed to receive input signals from a microphone and apply digital signal processing algorithms to the input signals to estimate the direction of arrival. These algorithms may include, for example, delay and sum algorithms where the input signal is sampled, and the resulting weighted and delayed versions of the sampled signal are averaged together to determine a direction of arrival. A least mean squared (LMS) algorithm may also be implemented to create an adaptive filter. This adaptive filter may then be used to identify differences in signal intensity, for example, or differences in time of arrival. These differences may then be used to estimate the direction of arrival. In another embodiment, the DOA may be determined by converting the input signals into the frequency domain and selecting specific bins within the time-frequency (TF) domain to process. Each selected TF bin may be processed to determine whether that bin includes a portion of the audio spectrum with a direct-path audio signal. Those bins having a portion of the direct-path signal may then be analyzed to identify the angle at which a microphone array received the direct-path audio signal. The determined angle may then be used to identify the direction of arrival for the received input signal. Other algorithms not listed above may also be used alone or in combination with the above algorithms to determine DOA.

In some embodiments, different users may perceive the source of a sound as coming from slightly different locations. This may be the result of each user having a unique head-related transfer function (HRTF), which may be dictated by a user's anatomy including ear canal length and the positioning of the ear drum. The artificial reality device may provide an alignment and orientation guide, which the user may follow to customize the sound signal presented to the user based on their unique HRTF. In some embodiments, an AR or VR device may implement one or more microphones to listen to sounds within the user's environment. The AR or VR device may use a variety of different array transfer functions (ATFs) (e.g., any of the DOA algorithms identified above) to estimate the direction of arrival for the sounds. Once the direction of arrival has been determined, the artificial reality device may play back sounds to the user according to the user's unique HRTF. Accordingly, the DOA estimation generated using an ATF may be used to determine the direction from which the sounds are to be played from. The playback sounds may be further refined based on how that specific user hears sounds according to the HRTF.

In addition to or as an alternative to performing a DOA estimation, an artificial reality device may perform localization based on information received from other types of sensors. These sensors may include cameras, infrared radiation (IR) sensors, heat sensors, motion sensors, global positioning system (GPS) receivers, or in some cases, sensor that detect a user's eye movements. For example, an artificial reality device may include an eye tracker or gaze detector that determines where a user is looking. Often, a user's eyes will look at the source of a sound, if only briefly. Such clues provided by the user's eyes may further aid in determining the location of a sound source. Other sensors such as cameras, heat sensors, and IR sensors may also indicate the location of a user, the location of an electronic device, or the location of another sound source. Any or all of the above methods may be used individually or in combination to determine the location of a sound source and may further be used to update the location of a sound source over time.

Some embodiments may implement the determined DOA to generate a more customized output audio signal for the user. For instance, an acoustic transfer function may characterize or define how a sound is received from a given location. More specifically, an acoustic transfer function may define the relationship between parameters of a sound at its source location and the parameters by which the sound signal is detected (e.g., detected by a microphone array or detected by a user's ear). An artificial reality device may include one or more acoustic sensors that detect sounds within range of the device. A controller of the artificial reality device may estimate a DOA for the detected sounds (using, e.g., any of the methods identified above) and, based on the parameters of the detected sounds, may generate an acoustic transfer function that is specific to the location of the device. This customized acoustic transfer function may thus be used to generate a spatialized output audio signal where the sound is perceived as coming from a specific location.

Indeed, once the location of the sound source or sources is known, the artificial reality device may re-render (i.e., spatialize) the sound signals to sound as if coming from the direction of that sound source. The artificial reality device may apply filters or other digital signal processing that alter the intensity, spectra, or arrival time of the sound signal. The digital signal processing may be applied in such a way that the sound signal is perceived as originating from the determined location. The artificial reality device may amplify or subdue certain frequencies or change the time that the signal arrives at each ear. In some cases, the artificial reality device may create an acoustic transfer function that is specific to the location of the device and the detected direction of arrival of the sound signal. In some embodiments, the artificial reality device may re-render the source signal in a stereo device or multi-speaker device (e.g., a surround sound device). In such cases, separate and distinct audio signals may be sent to each speaker. Each of these audio signals may be altered according to a user's HRTF and according to measurements of the user's location and the location of the sound source to sound as if they are coming from the determined location of the sound source. Accordingly, in this manner, the artificial reality device (or speakers associated with the device) may re-render an audio signal to sound as if originating from a specific location.

### INVENTION SUMMARIES

An apparatus for creating haptic stimulations is provided. The apparatus includes an inflatable bladder and a support structure attached to a portion of the inflatable bladder. The inflatable bladder is fluidically coupled to a pressure-changing device that is configured to control a fluid pressure of the inflatable bladder. The support structure includes a predefined pattern of cuts, and is configured to expand (or otherwise deform) in one or more directions according to a design of the predefined pattern of cuts and in relation with a fluid pressure inside the inflatable bladder. When the inflatable bladder receives the fluid from the source, the inflatable bladder expands, which causes the support structure to expand in the one or more directions and also to reinforce the inflatable bladder in the one or more directions. A wearable device and a system for creating haptic simulations are also disclosed.

A haptic device for providing haptic stimulations is provided. The haptic device includes: (A) a housing that (i) supports a flexible membrane, and (ii) defines a plurality of channels configured to receive a fluid from a source, (B) an end-effector magnet, coupled to the flexible membrane, configured to impart one or more haptic stimulations to a portion of a user's body, and (C) a plurality of secondary magnets, housed by the housing, configured to move the end-effector magnet through magnetic force, wherein a distance separating the end-effector magnet from the plurality of secondary magnets is varied according to a fluid pressure in one or more of the plurality of channels.

An apparatus for fixing a wearable structure to a user is provided. The apparatus includes a housing having a first structure configured to be positioned on a distal phalange of a user's finger, and a second structure configured to be positioned at a joint connecting the distal phalange and an intermediate phalange of the user's finger. The haptic device also includes a first bladder (i) positioned on an inner surface of the first structure and (ii) fluidically coupled to a fluid source. The haptic device also includes a second bladder (i) positioned on an inner surface of the second structure and (ii) fluidically coupled to the fluid source. The apparatus may also apply haptic stimulations to the user. For example, the apparatus may also include an actuator coupled to the housing and positioned in an open space defined by the housing between the first and second structures.

In some embodiments, a wearable device is detachably coupleable to a user's appendage (e.g., an arm). The wearable device instructs a transmit electrode to transmit a set of signals to be received by the receive electrode, whereby (i) the set of signals creates a signal pathway between the transmit and the receive electrode, and (ii) at least some signals in the set of signals are received by the receive electrode. The wearable device also receives, from a receive electrode, coupling information indicating a proximity of the receive electrode to the user's appendage. The coupling information is generated based, at least in part, on the signals in the set of signals received by the receive electrode. Also, in accordance with a determination that the coupling information does not satisfy a coupling criterion, the wearable device reports a coupling deficiency between the receive electrode and the user's appendage.

Although some of various drawings illustrate a number of logical stages in a particular order, stages which are not order dependent may be reordered and other stages may be combined or broken out. While some reordering or other groupings are specifically mentioned, others will be obvious to those of ordinary skill in the art, so the ordering and groupings presented herein are not an exhaustive list of alternatives. Moreover, it should be recognized that the stages could be implemented in hardware, firmware, software or any combination thereof.

The foregoing description, for purpose of explanation, has been described with reference to specific embodiments. However, the illustrative discussions above are not intended to be exhaustive or to limit the scope of the claims to the precise forms disclosed. Many modifications and variations are possible in view of the above teachings. The embodiments were chosen in order to best explain the principles underlying the claims and their practical applications, to thereby enable others skilled in the art to best use the embodiments with various modifications as are suited to the particular uses contemplated.

What is claimed is:

1. An apparatus for creating haptic stimulations, comprising: an inflatable bladder fluidically coupled to a pressure-changing device, the pressure-changing device being configured to control a fluid pressure of the inflatable bladder; and
a support structure, attached to a portion of the inflatable bladder, that includes a predefined pattern of cuts, the support structure being configured to deform in one or more directions according to (i) a design of the predefined pattern of cuts and (ii) in relation with a fluid pressure inside the inflatable bladder,
wherein:
when the inflatable bladder receives fluid via the pressure-changing device, the inflatable bladder expands, which causes the support structure to (i) deform in the one or more directions and also (ii) reinforce the inflatable bladder in the one or more directions.

2. The apparatus of claim 1, wherein:
the support structure is configured to be planar when the fluid pressure inside the inflatable bladder is below a threshold pressure; and
the support structure is configured to form a three-dimensional shape when the fluid pressure inside the inflatable bladder is at or above the threshold pressure.

3. The apparatus of claim 1, wherein the one or more directions include at least one out-of-plane direction.

4. The apparatus of claim 1, wherein the support structure undergoes strain hardening in the one or more directions when the pressure-changing device increases the fluid pressure inside the inflatable bladder to or above a threshold pressure.

5. The apparatus of claim 1, wherein the support structure is configured to:
(i) have a first strain in the one or more directions when the inflatable bladder has a first fluid pressure; and
(ii) have a second strain, greater than the first strain, in the one or more directions when the inflatable bladder has a second fluid pressure that is greater than the first fluid pressure.

6. The apparatus of claim 1, wherein the support structure is further configured to impart an amount of force onto the inflatable bladder, whereby the amount of force is related to the fluid pressure inside the inflatable bladder.

7. The apparatus of claim 1, wherein the predefined pattern of cuts of the support structure imparts anisotropic properties onto the support structure.

8. The apparatus of claim 1, wherein the support structure is configured to:
(i) have a first three-dimensional shape when the inflatable bladder has a first fluid pressure; and
(ii) have a second three-dimensional shape, distinct from the first three-dimensional shape, when the inflatable bladder has a second fluid pressure that is smaller than the first fluid pressure.

9. The apparatus of claim 8, wherein the support structure is further configured to:
impart a first amount of force onto the inflatable bladder when the support structure has the first three-dimensional shape; and
impart a second amount of force, greater than the first amount of force, onto the inflatable bladder when the support structure has the second three-dimensional shape.

10. The apparatus of claim 1, wherein the predefined pattern of cuts includes any of: orthogonal cuts or triangular cuts.

11. The apparatus of claim 1, wherein cuts of the predefined pattern of cuts are no greater than 5 millimeters in size.

12. The apparatus of claim 1, wherein: the support structure includes a material that has a larger tensile strength than a material of the inflatable bladder; and
the predefined pattern of cuts is defined by the material of the support structure.

13. The apparatus of claim 1, wherein: the support structure includes a thin film; and
the predefined pattern of cuts is defined by the thin film.

14. The apparatus of claim 1, wherein:
the pressure-changing device is in communication with a computing device; and
the pressure-changing device is configured to change the fluid pressure of the inflatable bladder in response to receiving one or more signals from the computing device.

15. The apparatus of claim 14, wherein:
the computing device is in communication with a head-mounted display that presents content to a wearer of the head-mounted display, the head-mounted display including an electronic display; and
the one or more signals correspond to content displayed on the electronic display.

16. A wearable device for creating haptic stimulations, comprising:
a garment configured to be worn on a portion of a wearer's body; and
a haptic assembly attached to the garment, the haptic assembly comprising:
an inflatable bladder fluidically coupled to a pressure-changing device, the pressure-changing device being configured to control a fluid pressure of the inflatable bladder;
a support structure, attached to a portion of the inflatable bladder, that includes a predefined pattern of cuts, the support structure being configured to deform in one or more directions according to (i) a design of the predefined pattern of cuts and (ii) in relation to a fluid pressure inside the inflatable bladder,
wherein when the inflatable bladder receives fluid via the pressure-changing device, the inflatable bladder expands, thereby:
(i) providing a haptic stimulation to a wearer of the garment; and
(ii) causing the support structure to (a) deform in the one or more directions and (b) reinforce the inflatable bladder in the one or more directions.

17. A system for creating haptic stimulations, comprising:
a computing device;
a pressure-changing device in communication with the computing device;
a garment configured to be worn on a portion of a wearer's body; and
a haptic assembly comprising:
an inflatable bladder fluidically coupled to a pressure-changing device, the pressure-changing device being configured to control a fluid of the inflatable bladder;
a support structure, attached to a portion of the inflatable bladder, that includes a predefined pattern of cuts, the support structure being configured to deform in one or more directions according to (i) a design of the predefined pattern of cuts and (ii) in relation with a fluid pressure inside the inflatable bladder, wherein when the inflatable bladder receives fluid via the pressure-changing device, the inflatable bladder expands, thereby:
(i) providing a haptic stimulation to a wearer of the garment; and
(ii) causing the support structure to (a) expand in the one or more directions and also (b) reinforce the inflatable bladder in the one or more directions.

18. The system of claim 17, further comprising:
a head-mounted display in communication the computing device, wherein the computing device is configured to:
generate an instruction that corresponds to visual data to be displayed by the head-mounted display;
send the instruction to the pressure-changing device, wherein the instruction, when received by the pressure-changing device, causes the pressure-changing device to change the fluid pressure inside the inflatable bladder; and
send the visual data to the head-mounted display.
